(19) United States
(12) Patent Application Publication
(10) Pub. No.: US 2005/0051437 A1
(43) Pub. Date: Mar. 10, 2005

(54) Plating apparatus and plating method

(76) Inventors: Keiichi Kurashina, Tokyo (JP); Mizuki Nagai, Tokyo (JP); Satoru Yamamoto, Tokyo (JP); Hiroyuki Kanda, Tokyo (JP); Koji Mishima, Tokyo (JP); Tsutomu Nakada, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/932,126

(22) Filed: Sep. 2, 2004

(30) Foreign Application Priority Data
Sep. 4, 2003 (JP) 2003-313307
Sep. 10, 2003 (JP) 2003-319055
Oct. 31, 2003 (JP) 2003-373391
Dec. 1, 2003 (JP) 2003-402006

(51) Int. Cl. B05D 5/12; C25D 5/00

(52) U.S. Cl. 205/143; 204/212

(57) ABSTRACT

A plating apparatus is used for filling a fine interconnect pattern formed in the substrate with metal to form interconnects. The plating apparatus includes a substrate holder for holding a substrate, a cathode portion including a sealing member for contacting a peripheral portion of a surface, to be plated, of the substrate held by said substrate holder to seal said peripheral portion water-tightly, and a cathode for contacting the substrate to supply current to the substrate, an anode vertically movably disposed so as to face the surface, to be plated, of the substrate, and a porous member disposed between said anode and the surface, to be plated, of the substrate, said porous member being made of a water-retentive material, wherein said porous member has at least a hydrophilic substrate-facing surface which faces the surface, to be plated, of the substrate.

### BACKGROUND OF THE INVENTION

1. Field of the Invention

The present invention relates to a plating apparatus and a plating method, and more particularly to a plating apparatus and a plating method used for filling a fine interconnect pattern formed in a substrate, such as a semiconductor substrate, with metal (interconnect material) such as copper so as to form interconnects.

2. Description of the Related Art

Recently, as a circuit forming method, the so-called “damascene process”, which comprises forming fine recesses for interconnects, such as trenches or via holes in a circuit form, in a semiconductor substrate, embedding the fine recesses with copper (interconnect material) by copper plating, and removing a copper layer (plated film) at portions other than the fine recesses by CMP means or the like, has been employed. In this damascene process, from the viewpoint of reducing loads on subsequent CMP, it is desirable that a copper plated film be deposited selectively in trenches or via holes in a circuit form, and that the amount of copper plated film deposited on portions other than the trenches or via holes be small. In order to achieve such an object, there have heretofore been proposed various ideas regarding a plating solution, such as composition in a bath of a plating solution or a brightener used in a plating solution.

A plating apparatus having the following configuration has been known as this type of plating apparatus used for plating to form fine interconnects having high aspect ratios. A substrate is held in such a state that a surface (surface to be plated) of the substrate faces upward (in a face-up manner). A cathode is brought into contact with a peripheral portion of the substrate so that the surface of the substrate serves as a cathode. An anode is disposed above the substrate. While a space between the substrate and the anode is filled with a plating solution, a plating voltage is applied between the substrate (cathode) and the anode to plate a surface (surface to be plated) of a substrate (for example, see Japanese laid-open patent publication No. 2002-506489).

In a plating apparatus in which a substrate is held and plated in single wafer processing while a surface of the substrate faces upward, a distribution of a plating current can be made more uniform over an entire surface of the substrate to improve uniformity of a plated film over the surface of the substrate. Generally, the substrate is transferred and subjected to various processes in such a state that a surface of the substrate faces upward. Accordingly, it is not necessary to turn the substrate at the time of plating.

Meanwhile, in order to deposit a copper plated film selectively in trenches in a circuit form or the like, there has been known a method of bringing a porous member (plating solution impregnated material) into contact with a substrate such as a semiconductor wafer, and plating the substrate while relatively moving the porous member in a contact direction. As a porous member in this method, there have generally been used PVA, porous Teflon (registered trademark), polypropylene knitted like a textile or skimmed like a paper, and unformed materials such as gelated silicon oxide or agar (for example, see Japanese laid-open patent publication No. 2000-232078).

Some plating apparatus use a porous member (plating solution impregnated material) impregnated with a plating solution therein. In such a plating apparatus, the porous member is made of a hydrophobic material. Therefore, the plating solution is less liable to infiltrate through the porous member, and it is tedious and time-consuming to handle the plating solution when it is to penetrate into the porous member. Even if the porous member has fully been impregnated with the plating solution, when the porous member is immersed in the plating solution in the plating tank or when the plating solution is poured between the porous member and the substrate, air bubbles tend to be entrapped into the porous member. Once entrapped in the porous member, the air bubbles are attracted to the hydrophobic surface and cannot easily be removed from the porous member. Furthermore, additives and a surfactant added to the plating solution are apt to be attracted to the surface of the hydrophobic material, making it difficult to control the composition of the plating solution.

In the prior art, when plating is performed, the amount of plated material is different in regions of the surface of the substrate depending on the shape of the interconnect pattern under the influence of distribution of current density or the influence of additives, and hence it is difficult to form a plated film having a uniform thickness over the entire surface of the substrate. For example, a plated film deposited on an interconnect section having a dense fine interconnect pattern is thicker than a plated film deposited on other portions, and a phenomenon called an overplating phenomenon generally occurs. On the other hand, the amount of plated material deposited on an interconnect section having a wide interconnect pattern is generally smaller than that on other portions. As a result, in a case where an interconnect pattern is filled entirely with interconnect material such as copper by plating, the thickness of a plated film differs depending on the locations, causing irregularities of the surface of the plated film. When plating is performed according to such method, more amount of plated material than necessary is deposited, and hence raw material cost increases and a longer period of plating time is required. Further, loads on a polishing process, such as CMP or the like, after plating increase, and in the next generation in which a low-k material is used as an interlevel dielectric layer, a polishing apparatus will require a considerably high performance.

In order to solve the above problems, there have been proposed various ideas or attempts regarding a plating solution such as composition in a bath of the plating solution or a brightener used in a plating solution, and improvement of current condition. These ideas or attempts can achieve the object to a certain extent but have a limitation such as a plated film of poor quality.

If the substrate is plated to increase the flatness of the surface of the plated film by bringing the porous member into contact with the surface to be plated of the substrate or rubbing the surface to be plated of the substrate with the porous member, then particles are produced when the porous member is brought into contact with the surface to be plated of the substrate or the surface to be plated of the substrate is rubbed with the porous member, tending to introduce impurities into the plated film.

The conventional plating apparatus is designed to plate the entire surface (surface to be plated) of the substrate uniformly under the same conditions. Therefore, it has generally been difficult for the conventional plating apparatus to plate the substrate under different conditions for each of subdivided areas of the surface of the substrate, e.g., each of interconnect patterns. Furthermore, a contact for connection to an electrode is provided on the peripheral area of an electrically conductive layer, such as a seed layer or the like, previously formed on a substrate to be plated, and a cathode potential is applied to the electrically conductive layer through the contact during plating. Consequently, the sheet resistance of the electrically conductive layer varies depending on the distance from the contact on the electrically conductive layer that is connected to the electrode, resulting in potential differences within the surface of the substrate which tend to adversely affect the in-plane uniformity of a plated film that is formed on the surface of the electrically conductive layer. This problem appears to aggravate itself as the area of substrates to be plated increases.

### SUMMARY OF THE INVENTION

The present invention has been made in view of the above situation in the related art. It is therefore a first object of the present invention to provide a plating apparatus having a porous member (plating solution impregnated member), the plating apparatus being capable of handling a plating solution relatively easily and controlling the composition of the plating solution relatively easily.

It is a second object of the present invention to provide a plating apparatus and a plating method which are able to easily form an acceptable plated film that has flatter surface and is free of impurities, without being adversely affected by variations of interconnect pattern shapes.

It is a third object of the present invention to provide a plating apparatus and a plating method which are able to easily form acceptable plated film that has flatter surface and is of good film quality, without being adversely affected by variations of interconnect pattern shapes, and also to manage a plating solution with ease by separating a deteriorated plating solution and a fresh plating solution from each other.

It is a fourth object of the present invention to provide a plating apparatus and a plating method which are able to plate different areas of a substrate under different conditions in a specifically controlled fashion, and also to produce an acceptable plated film of good in-plane uniformity on the substrate while minimizing the effect of the sheet resistance of the surface of the substrate.

In order to achieve the above objects, the present invention provides a plating apparatus comprising: a substrate holder for holding a substrate; a cathode portion including a sealing member for contacting a peripheral portion of a surface, to be plated, of the substrate held by the substrate holder to seal the peripheral portion water-tightly, and a cathode for contacting the substrate to supply current to the substrate; an anode vertically movably disposed so as to face the surface, to be plated, of the substrate; and a porous member disposed between the anode and the surface, to be plated, of the substrate, the porous member being made of a water-retentive material; wherein the porous member has at least a hydrophilic substrate-facing surface which faces the surface, to be plated, of the substrate.

By thus making at least a substrate-facing surface of the porous member which faces the substrate a hydrophilic surface, not only a plating solution finds it easy to penetrate into the porous member, but also air bubbles are less likely to be entrapped into the porous member or, even if entrapped in the porous member, air bubbles are likely to be removed from the porous member when the plating solution is brought into contact with the porous member. Consequently, it is easy to handle the plating solution. If the substrate-facing surface of the porous member is hydrophobic, then since additives contained in the plating solution are highly apt to be attracted to the surface of the hydrophobic material. Therefore, the porous member tends to attract a large amount of additive, and the amount of attracted additive is liable to change largely with time, making it difficult to control the composition of the plating solution. These problems can be solved by making the substrate-facing surface of the porous member hydrophobic.

In view of handling the plating solution, it is more effective and hence desirable for the porous member to be hydrophilic also in its inside. However, at least the hydrophilic substrate-facing surface is sufficiently effective to allow the plating solution to penetrate easily into the porous member, and equally effective to prevent air bubbles from being entrapped into the porous member and also to control the composition of the plating solution. These advantages also apply to other embodiments to be described below.

The porous member is preferably made of a hydrophilic material.

By thus making the porous member itself of a hydrophilic material, the substrate-facing surface of the porous member may be turned into a hydrophilic surface.

The substrate-facing surface of the porous member is modified by a plasma process, for example.

When modified by the plasma process, the substrate-facing surface of the porous member may be made hydrophilic. The plasma process is also referred to as a plasma contact process, which includes a glow discharge process and a corona discharge process.

The plasma process, the glow discharge process, the corona discharge process, an ultraviolet ray application process, and an ozone process, to be described below, are free of the danger of metal contamination because they require no catalyst. The hydrophilic treatment process may be performed on the material or the produced formed from the material, and the base material may be either hydrophobic or hydrophilic. These alternatives also apply in the description which follows.

The glow discharge process is a type of the plasma contact process and generates a plasma due to a glow discharge. For example, a surface of a porous member of Teflon (registered trademark) can be made hydrophilic by being subjected to a glow discharge under the pressure of 0.1 mm Hg for 10 seconds.

The corona discharge process is also a type of the plasma contact process and generates a plasma due to a corona discharge.

The substrate-facing surface of the porous member may be modified by an ultraviolet ray application process.

For example, a surface of a porous member of PET can be made hydrophilic by being exposed to ultraviolet rays having a maximum intensity at the wavelength of 2537 Å for 20 minutes.

Alternatively, the substrate-facing surface of the porous member may be made hydrophilic by being modified by an ozone process.

The substrate-facing surface of the porous member may be given hydrophilic functional groups.

Hydrophilic functional groups may comprise —OH, ═O, —COH, —SO₃H, or the like. The substrate-facing surface may be given hydrophilic functional groups by any desired processes including a chemical reaction, a plasma process, an ozone process, etc. For example, a surface of a porous member of polyethylene may be turned into a hydrophilic surface by being treated for 2 minutes with a mixed solution of sulfuric acid and chromic acid (K₃Cr₂O₇:H₂O:H₂SO₄=4.4:88.5:7.1 (weight ratios)) at a temperature of 70° C., or a surface of a porous member of Teflon (registered trademark) may be turned into a hydrophilic surface by being treated with Na-naphthalene.

The hydrophilic functional groups should preferably be functional groups which are converted into a material contained in the composition of the plating solution when the hydrophilic functional groups are dissolved.

Thus, even when the hydrophilic functional groups assigned to the substrate-facing surface of the porous member are dissolved, they will not serve an impurity in the plating solution.

The substrate-facing surface of the porous member may be cross-linked or coated with a hydrophilic material.

The substrate-facing surface may be cross-linked with a hydrophilic material by any desired processes including a graft polymerization process, a plasma polymerization process, etc.

The hydrophilic material should preferably be a material contained in the composition of the plating solution.

Even if the hydrophilic material which has been cross-linked or coated on the substrate-facing surface of the porous member is peeled off, it will not serve as an impurity in the plating solution.

The substrate-facing surface of the porous member may be cross-linked or coated with a surfactant.

The substrate-facing surface of the porous member may be cross-linked or coated with a surfactant by any desired processes including a graft polymerization process, a plasma polymerization process, etc.

The surfactant should preferably comprise a surfactant contained in the composition of a plating solution.

Even if the surfactant which has been cross-linked or coated on the substrate-facing surface of the porous member is peeled off, it will not serve as an impurity in the plating solution. Furthermore, using the surfactant allows the effect of the additive (surfactant) to be borne by the substrate-facing surface of the porous member, so that the effect can be limited to an area that faces the surface, to be plated, of the substrate.

The present invention also provides another plating apparatus comprising: a substrate holder for holding a substrate; a cathode portion including a sealing member for contacting a peripheral portion of a surface, to be plated, of the substrate held by the substrate holder to seal the peripheral portion water-tightly, and a cathode for contacting the substrate to supply current to the substrate; an anode vertically movably disposed so as to face the surface, to be plated, of the substrate; a porous member disposed between the anode and the surface, to be plated, of the substrate, the porous member being made of a water-retentive material; a porous member positioning mechanism for positioning the porous member in a predetermined position which is closely spaced a predetermined distance from the surface, to be plated, of the substrate held by the substrate holder; and a driving mechanism for making a relative motion between the porous member and the substrate.

By thus positioning the porous member at a position close to and spaced a certain distance from the surface to be plated of the substrate that is held by the substrate holder and moving the porous member and the substrate relatively to each other, e.g., rotating or vibrating the porous member and the substrate relatively to each other, the state of the surface to be plated is changed, suppressing the plating rate on the surface of a field area of the surface to be plated (an upper portion of the interconnect pattern). The change in the state of the surface to be plated is selectively given to the surface of the field area of the surface to be plated, rather than to an inner portion of the interconnect pattern such as a trench or the like, by the positioning of the porous member close to the surface to be plated. Consequently, there is developed a plating rate difference between the inner portion of the interconnect pattern such as a trench or the like and the surface of the field area (the upper portion of the interconnect pattern). The plating rate difference causes the height of the plated layer in the inner portion of the interconnect pattern such as a trench or the like to catch up the height of the plated layer on the surface of the field area, forming a flatter plated film on the surface of the substrate. According to this plating process, since no special current conditions and no additives are required, and the surface to be plated of the substrate is plated out of contact with the porous member, a plated film of good film quality can be formed on the substrate without producing particles.

When the porous member is positioned in the predetermined position, the distance between the porous member and the surface to be plated of the substrate held by the substrate holder should preferably be 1.5 mm or less and more preferably be about 1.0 mm.

The relative motion may be vibration, for example.

By vertically vibrating at least one of the porous member and the substrate held by the substrate holder, the porous member and the substrate may be moved relatively to each other by vibration.

The relative motion may be a rotary motion.

By rotating at least one of the porous member and the substrate held by the substrate holder, the porous member and the substrate may be moved relatively to each other by rotation.

The relative motion may be a scroll motion.

By scrolling at least one of the porous member and the substrate held by the substrate holder, i.e., revolving it without rotating it about its own axis (by way of translatory rotation), the porous member and the substrate may be moved relatively to each other by a scroll motion.

The relative motion may be a rotary motion of the porous member and the substrate about their respective axes that are spaced from each other.

For example, by displacing the center of the porous member and the center of the substrate held by the substrate holder from each other and rotating them about their own axes, the porous member and the substrate may be moved relatively to each other.

The relative motion may be a linear motion.

The relative motion, which comprises a linear motion, may be performed by fixing one of the porous members and the substrate held by the substrate holder and moving the other linearly, or moving them linearly in mutually opposite directions.

The present invention also provides a plating method comprising: interposing a porous member made of a water-retentive material between a substrate and an anode; filling a space between a surface, to be plated, of the substrate and the anode with a plating solution; positioning the porous member in a predetermined position which is closely spaced a predetermined distance from the surface, to be plated, of the substrate; and supplying a current between the surface, to be plated, of the substrate and the anode to plate the surface, to be plated of, the substrate while making a relative motion between the porous member and the substrate.

The present invention also provides another plating method comprising: interposing a porous member made of a water-retentive material between a substrate and an anode; filling a space between a surface, to be plated, of the substrate and the anode with a plating solution; positioning the porous member in a predetermined position which is closely spaced a predetermined distance from the surface, to be plated, of the substrate; making a relative motion between the porous member and the substrate and then keeping the porous member and the substrate still; and supplying a current between the surface, to be plated, of the substrate and the anode to plate the surface, to be plated, of the substrate while keeping the porous member and the substrate still.

Preferably, the current is supplied between the surface, to be plated, of the substrate and the anode within 2 seconds after the porous member and the substrate are made the relative motion with respect to each other and then kept still.

By thus supplying the current between the surface, to be plated, of the substrate and the anode within 2 seconds after the porous member and the substrate are made relative motion with respect to each other and then kept still, the ratio of the plating rate in the interconnect pattern such as a trench to the plating rate at the surface of the field area (the ratio of the plating rate in the interconnect pattern such as a trench/the plating rate at the surface of the field area) can be 2 or more, for example.

The present invention also provides still another plating apparatus comprising: a substrate holder for holding a substrate; a cathode portion including a sealing member for contacting a peripheral portion of a surface, to be plated, of the substrate held by the substrate holder to seal the peripheral portion water-tightly, and a cathode for contacting the substrate to supply current to the substrate; an anode disposed so as to face the surface, to be plated, of the substrate; a water-retentive ion-exchange membrane disposed between the anode and the surface, to be plated, of the substrate; a pressing/holding mechanism for either pressing the ion-exchange membrane against the surface, to be plated, of the substrate held by the substrate holder under a given force or holding the ion-exchange membrane in a position close to the surface, to be plated, of the substrate held by the substrate holder; and a driving mechanism for making a relative motion between the ion-exchange membrane and the substrate.

When the ion-exchange membrane and the substrate are relatively moved while the ion-exchange membrane and the surface, to be plated, of the substrate held by the substrate holder are being kept in contact with or close to each other, and thereafter the substrate is plated, the growth of the plated film on the upper portion of the interconnect pattern (the surface of the field area) is suppressed to lower the plating rate. Thus, the plating rate at the upper portion of the interconnect pattern is made lower than the plating rate in the interconnect pattern, making it possible to cause the height of the plated layer in the interconnect pattern to catch up the height of the plated layer in the upper portion of the interconnect pattern regardless of variations of the shape of the interconnect pattern, forming a flatter plated film on the surface of the substrate. Since no special current conditions and no additives are required, and the surface of the plated film is not scraped off, a plated film of good film quality can be formed on the substrate.

The ion-exchange membrane disposed between the anode and the substrate is effective to separate the deteriorated plating solution on the anode side and the fresh plating solution supplied on the substrate side from each other, and hence prevent the fresh plating solution that is supplied to the substrate and used to plate the substrate while in contact with the substrate from being mixed with the deteriorated plating solution. When the ion-exchange membrane comprises a membrane which does not pass important substances, such as metal ions and additives in the composition of the plating solution, and passes only hydrogen ions and hydroxide ions, for example, that are present in both the deteriorated plating solution and the fresh plating solution, the ion-exchange membrane can pass electricity therethrough while separating the deteriorated plating solution and the fresh plating solution from each other. Furthermore, when the ion-exchange membrane comprises a membrane which not only prevents a plated film from being precipitated in a region where the ion-exchange membrane is brought into contact with the surface, to be plated, of the substrate, but also does not pass metal ions therethrough, the supply of metal ions to the upper portion of the interconnect pattern is fully stopped for depositing a flatter plated film.

The ion-exchange membrane may comprise one or a combination of a cation-exchange membrane, an anion-exchange membrane, and an amphoteric exchange membrane.

Preferably, the ion-exchange membrane comprises a hydrogen ion selective exchange membrane or a one-valence anion selective exchange membrane.

The ion-exchange membrane may comprise a hydrogen ion selective exchange (permeation) membrane which passes only hydrogen ions (H⁺), or a one-valence anion selective exchange (permeation) membrane which passes only one-valance anions such as hydroxide ions (OH⁻), for example. The ion-exchange membrane thus arranged can pass electricity therethrough while separating the deteriorated plating solution and the fresh plating solution from each other.

The ion-exchange membrane may comprise a hydrogen-ion-incapable exchange membrane.

In a preferred aspect of the present invention, the driving mechanism is adapted to make a relative motion between the ion-exchange membrane and the substrate while the ion-exchange membrane and the surface, to be plated, of the substrate are brought into contact with each other.

When the porous member and the substrate are thus relatively moved while the porous member and the surface, to be plated, of the substrate held by the substrate holder are brought into contact with each other, and thereafter the substrate is plated, the growth of the plated film on the upper portion of the interconnect pattern is suppressed to lower the plating rate. The plating rate at the upper portion of the interconnect pattern is made lower than the plating rate in the interconnect pattern to form a flatter plated film on the surface of the substrate.

The relative motion may be vibration, a rotary motion, a scroll motion, a rotary motion of the porous member and the substrate about their respective axes that are spaced from each other, or a linear motion.

The ion-exchange membrane and the substrate may be moved relatively to each other by one or a combination of various movements performed by rotating at least one of the porous member and the substrate held by the substrate holder, scrolling at least one of the porous member and the substrate held by the substrate holder, i.e., revolving it without rotating it about its own axis (by way of translatory rotation), displacing the center of the porous member and the center of the substrate held by the substrate holder from each other and rotating them about their own axes, or fixing one of the porous member and the substrate held by the substrate holder and moving the other linearly, or moving them linearly in mutually opposite directions.

The relative motion may be vibration so that contact and non-contact between the ion-exchange membrane and the surface, to be plated, of the substrate are repeated.

The ion-exchange membrane and the substrate held by the substrate holder are moved relatively to each other such that contact and non-contact between the ion-exchange membrane and the surface, to be plated, of the substrate are repeated, after which the substrate is plated. In this manner, the growth of the plated film on the upper portion of the interconnect pattern is suppressed to lower the plating rate, and the plating rate at the upper portion of the interconnect pattern is made lower than the plating rate in the interconnect pattern to form a flatter plated film on the surface of the substrate.

The present invention also provides still another plating method comprising: interposing a water-retentive ion-exchange membrane between a substrate and an anode; filling a space between the substrate and the anode with a plating solution; making a relative motion between the ion-exchange membrane and the substrate while keeping the ion-exchange membrane and the substrate in contact with each other or close to each other; and supplying a current between the substrate and the anode to plate the substrate.

The current should preferably start to be supplied between the substrate and the anode to plate the substrate within two seconds after the relative motion.

By thus passing the current between the substrate and the anode within 2 seconds after the ion-exchange membrane and the substrate are caused to make relative motion with respect to each other while they are brought into contact with or close to each other, the ratio of the plating rate in the interconnect pattern to the plating rate on the upper portion of the interconnect pattern (the ratio of the plating rate in the interconnect pattern/the plating rate on the upper portion of the interconnect pattern) can be 2 or more, for example.

Preferably, the ion-exchange membrane and the substrate are caused to make relative motion with respect to each other while the ion-exchange membrane and the surface, to be plated, of the substrate are brought into contact with each other.

The present invention also provides a plating apparatus comprising: a substrate holder for holding a substrate; a cathode portion including a sealing member for contacting a peripheral portion of a surface, to be plated, of the substrate held by the substrate holder to seal the peripheral portion water-tightly, and a cathode for contacting the substrate to supply current to the substrate; an anode disposed so as to face the surface, to be plated, of the substrate; a porous member disposed between the anode and the surface, to be plated, of the substrate and having a planar shape smaller than the surface, to be plated, of the substrate, the porous member being made of a water-retentive material; an electrode head having the anode and the porous member respectively in upper and lower portions thereof; and a driving mechanism for making a relative motion between the porous member and the substrate.

Since the planar shape of the porous member is smaller than the surface, to be plated, of the substrate and a region of the substrate which is confronted by the porous member is plated, different regions of the substrate can be plated under different conditions. The entire surface of the substrate is not plated altogether, but the regions of the substrate are individually plated to minimize the effect of the sheet resistance of the surface of the substrate for producing a plated film of good in-plane uniformity. The plated film is also of good quality because no special current conditions and no additives are required.

In a preferred aspect of the present invention, the plating apparatus further comprises a pressing mechanism for pressing the porous member against the surface, to be plated, of the substrate held by the substrate holder under a given pressure.

With this arrangement, the porous member and the substrate can be made a relative motion by the driving mechanism while the porous member being pressed against the surface, to be plated, of the substrate held by the substrate holder under a given pressure.

The porous member has a circular planar shape, a sectorial planar shape, or a rectangular planar shape, for example.

Alternatively, the porous member may have a planar shape which is identical to the planar shape of a die formed in a division on the substrate.

With this structure, a die formed in a division on the substrate may individually be plated to produce a plated film of good in-plane uniformity and film quality on the die.

The porous member may have a rod shape.

In a preferred aspect of the present invention, the anode has a planar shape corresponding to the planar shape of the porous member.

When the anode and the porous member, which are of the corresponding shapes, are vertically aligned with each other without sticking out during plating, the substrate can be plated only in the region thereof which is confronted by the porous member.

In a preferred aspect of the present invention, the electrode head has a shape corresponding to the planar shape of the porous member.

This makes it possible to make compact of the electrode head which has the anode and the porous member in its upper and lower positions.

Preferably, the plating apparatus provides with a plurality of the electrode heads.

This makes it possible to simultaneously plate the regions of the substrate held by the substrate holder individually by a plurality of the electrode heads.

The present invention also provides still another plating method comprising: interposing a porous member made of a water-retentive material between a surface, to be plated, of a substrate and an anode, the porous member having a planar shape smaller than the planar shape of the surface to be plated; filling a space between the substrate and the anode with a plating solution; allowing the porous member and the surface, to be plated, of the substrate to be in contact with each other or close to each other; and supplying a current between the substrate and the anode to plate the substrate.

### BRIEF DESCRIPTION OF THE DRAWINGS

FIG. 1A through 1D are diagrams illustrating, in sequence of steps, an example for forming copper interconnects by plating process;

FIG. 2 is an overall plan view of a substrate processing apparatus provided with a plating apparatus according to the present invention;

FIG. 3 is a plan view of the plating apparatus shown in FIG. 2;

FIG. 4 is an enlarged sectional view of the substrate holder and the cathode portion of the plating apparatus shown in FIG. 2;

FIG. 5 is a front view of the pre-coating/recovering arm of the plating apparatus shown in FIG. 2;

FIG. 6 is a plan view of the substrate holder of the plating apparatus shown in FIG. 2;

FIG. 7 is a cross-sectional view taken along line B-B of FIG. 6;

FIG. 8 is a cross-sectional view taken along line C-C of FIG. 6;

FIG. 9 is a plan view of the cathode portion of the plating apparatus shown in FIG. 2;

FIG. 10 is an enlarged sectional view taken along line D-D of FIG. 9;

FIG. 11 is a plan view of the electrode arm section of the plating apparatus shown in FIG. 2;

FIG. 12 is a schematic sectional view illustrating the electrode head and the substrate holder of the plating apparatus shown in FIG. 2 upon electroplating;

FIG. 13 is a schematic view illustrating an enlarged substrate-facing surface of a porous member;

FIG. 14 is a view, corresponding to FIG. 13, showing another porous member;

FIG. 15 is a view, corresponding to FIG. 13, showing still another porous member;

FIG. 16 is a plan view of a substrate processing apparatus provided with a plating apparatus according to another embodiment of the present invention;

FIG. 17 is a schematic view showing an essential part of the plating apparatus shown in FIG. 16;

FIG. 18 is a schematic view showing another embodiment of a driving mechanism for making a relative motion between the porous member (lower pad) and the substrate held by the substrate holder;

FIG. 19 is a schematic view showing still another embodiment of a driving mechanism for making a relative motion between the porous member (lower pad) and the substrate held by the substrate holder;

FIG. 20 is a schematic view showing still another embodiment of a driving mechanism for making a relative motion between the porous member (lower pad) and the substrate held by the substrate holder;

FIG. 21 is a schematic view showing still another embodiment of a driving mechanism for making a relative motion between the porous member (lower pad) and the substrate held by the substrate holder;

FIG. 22 is a systematic diagram showing an example of a plating solution management system;

FIG. 23 is a front cross-sectional view showing an example of a cleaning and drying apparatus shown in FIG. 16;

FIG. 24 is a plan view showing an example of the cleaning and drying apparatus shown in FIG. 23;

FIG. 25 is a schematic view showing an example of a bevel etching and backside cleaning apparatus shown in FIG. 16;

FIG. 26 is a front cross-sectional view showing an example of a heating treatment apparatus shown in FIG. 16;

FIG. 27 is a plan cross-sectional view showing an example of the heating treatment apparatus shown in FIG. 26;

FIG. 28 is a front view of a pretreatment apparatus shown in FIG. 16 at the time of substrate transfer;

FIG. 29 is a front view of the pretreatment apparatus shown in FIG. 16 at the time of chemical treatment;

FIG. 30 is a front view of the pretreatment apparatus shown in FIG. 16 at the time of rinsing;

FIG. 31 is a cross-sectional view showing a processing head of the pretreatment apparatus shown in FIG. 16 at the time of substrate transfer;

FIG. 32 is an enlarged view of A portion of FIG. 31 in the pretreatment apparatus shown in FIG. 16;

FIG. 33 is a view corresponding to FIG. 32 at the time of substrate fixing;

FIG. 34 is a systematic diagram of the pretreatment apparatus shown in FIG. 16;

FIG. 35 is a cross-sectional view showing a substrate head of an electroless plating apparatus shown in FIG. 16 at the time of substrate transfer;

FIG. 36 is an enlarged view of B portion of FIG. 35;

FIG. 37 is a view corresponding to FIG. 36 showing the substrate head at the time of substrate fixing;

FIG. 38 is a view corresponding to FIG. 36 showing the substrate head at the time of plating process;

FIG. 39 is a front view with partially cross-section showing a plating tank of the electroless plating apparatus shown in FIG. 16 when the plating tank is closed with a plating tank cover;

FIG. 40 is a cross-sectional view of a cleaning tank of the electroless plating apparatus shown in FIG. 16;

FIG. 41 is a systematic diagram of the electroless plating apparatus shown in FIG. 16;

FIG. 42 is a schematic view showing an example of a polishing apparatus shown in FIG. 16;

FIG. 43 is a schematic front view of neighborhood of a reversing machine in a film thickness measuring instrument shown in FIG. 16;

FIG. 44 is a plan view of a reversing arm section of the film thickness measuring instrument shown in FIG. 43;

FIG. 45 is a flow chart in a substrate processing apparatus shown in FIG. 16;

FIG. 46 is a schematic view showing an essential part of a plating apparatus according to still another embodiment of the present invention;

FIG. 47 is a graph showing the relationship between the time from the stoppage of the relative motion of the ion-exchange membrane and the substrate until the start of the plating process, and the ratio of the plating rate in the interconnect pattern to the plating rate at the upper portion of the interconnect pattern (plating rate in the interconnect pattern/plating rate at the upper portion of the interconnect pattern).

FIG. 48 is a schematic view showing another embodiment of a driving mechanism for making a relative motion between the ion-exchange membrane and the substrate held by the substrate holder;

FIG. 49 is a schematic view showing still another embodiment of a driving mechanism for making a relative motion between the ion-exchange membrane and the substrate held by the substrate holder;

FIG. 50 is a schematic view showing still another embodiment of a driving mechanism for making a relative motion between the ion-exchange membrane and the substrate held by the substrate holder;

FIG. 51 is a schematic view showing a driving mechanism for making a relative motion between an ion-exchange membrane and the substrate held by the substrate holder of a plating apparatus according to another embodiment of the present invention;

FIG. 52 is a schematic view showing an essential part of a plating apparatus according to still another embodiment of the present invention;

FIG. 53 is a schematic view showing an essential part of a plating apparatus according to still another embodiment of the present invention;

FIG. 54A is a plan view of a porous member of the plating apparatus shown in FIG. 53;

FIG. 54B is a front cross-sectional view of the porous member shown in FIG. 54A;

FIG. 55 is a schematic view showing another embodiment of a driving mechanism for making a relative motion between the porous member and the substrate held by the substrate holder;

FIG. 56 is a schematic view showing still another embodiment of a driving mechanism for making a relative motion between the porous member and the substrate held by the substrate holder;

FIG. 57 is a schematic view showing still another embodiment of a driving mechanism for making a relative motion between the porous member and the substrate held by the substrate holder;

FIG. 58 is a schematic view showing still another embodiment of a driving mechanism for making a relative motion between the porous member and the substrate held by the substrate holder;

FIG. 59A is a plan view of another porous member for use in the plating apparatus;

FIG. 59B is a vertical cross-sectional view of the porous member shown in FIG. 59A;

FIG. 60A is a plan view of still another porous member for use in the plating apparatus; and

FIG. 60B is a vertical cross-sectional view of the porous member shown in FIG. 60A.

### DETAILED DESCRIPTION OF THE PREFERRED EMBODIMENTS

Preferred embodiments of the present invention will be described below with reference to the drawings. The following embodiments show examples in which copper as an interconnect material is embedded in fine recesses for interconnects formed in a surface of a substrate such as a semiconductor wafer by plating so as to form interconnects composed of a copper layer. However, it should be noted that other kinds of interconnect materials may be used instead of copper.

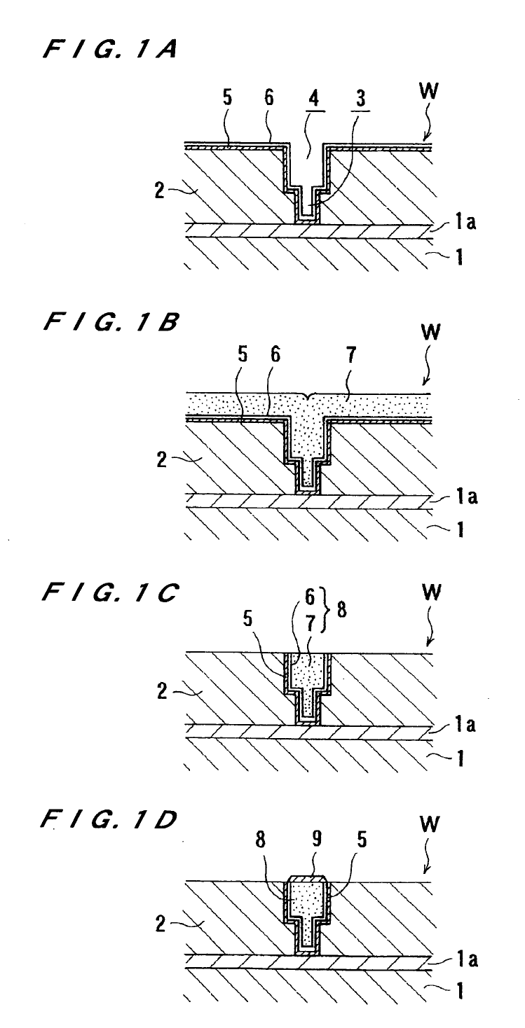

FIGS. 1A through 1D illustrate an example of forming copper interconnects in a semiconductor device. As shown in FIG. 1A, an insulating film 2, such as an oxide film of SiO₂ or a film of low-k material, is deposited on a conductive layer 1a formed on a semiconductor base 1 having formed semiconductor devices. Via holes 3 and trenches 4 are formed in the insulating film 2 by performing a lithography/etching technique so as to provide fine recesses for interconnects. Thereafter, a barrier layer 5 of TaN or the like is formed on the insulating film 2, and a seed layer 6 as a feeding layer for electroplating is formed on the barrier layer 5 by sputtering or the like.

Then, as shown in FIG. 1B, copper plating is performed on a surface of a substrate W to fill the via holes 3 and the trenches 4 with copper and, at the same time, deposit a copper layer 7 on the insulating film 2. Thereafter, the barrier layer 5, the seed layer 6 and the copper layer 7 on the insulating film 2 are removed by chemical mechanical polishing (CMP) or the like so as to leave copper filled in the via holes 3 and the trenches 4, and have a surface of the insulating film 2 lie substantially on the same plane as this copper. Interconnects (copper interconnects) 8 composed of the seed layer 6 and the copper layer 7 are thus formed in the insulating film 2 as shown in FIG. 1C.

Then, if necessary, electroless plating is performed on a surface of the substrate W to selectively form a protective film 9 of a Co alloy, an Ni alloy, or the like on surfaces of the interconnects 8, thereby covering and protecting the exposed surfaces of the interconnects 8 with the protective film 9, as shown in FIG. 1D.

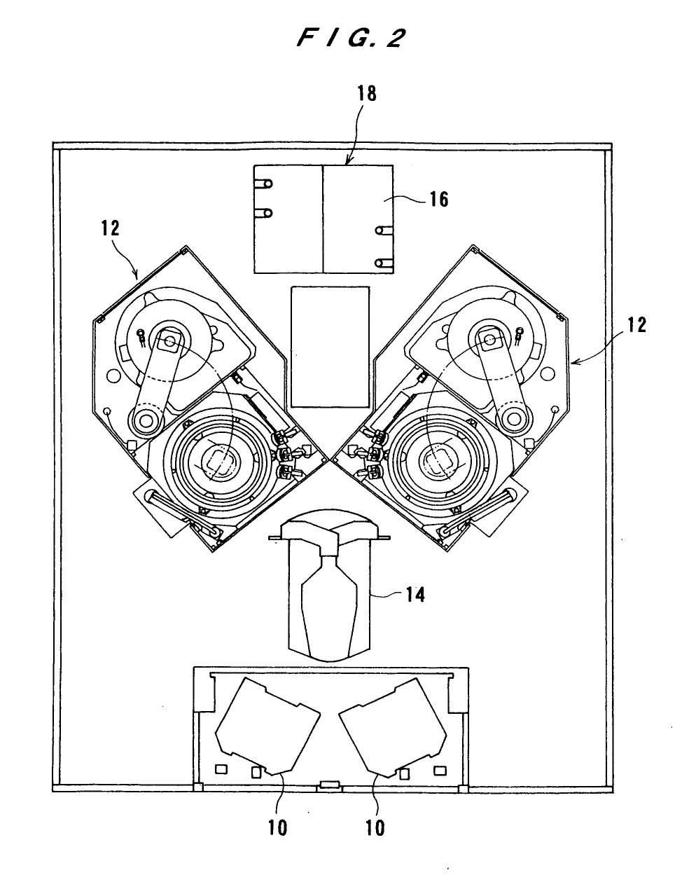

FIG. 2 is a plan view showing a substrate processing apparatus incorporating a plating apparatus according to the present invention. As shown in FIG. 2, this substrate processing apparatus has a rectangular facility which houses therein two loading/unloading units 10 for housing a plurality of substrates W therein, two plating apparatuses 12 for performing plating process and processing incidental thereto, a transfer robot 14 for transferring substrates W between the loading/unloading units 10 and the plating apparatuses 12, and plating solution supply equipment 18 having a plating solution tank 16.

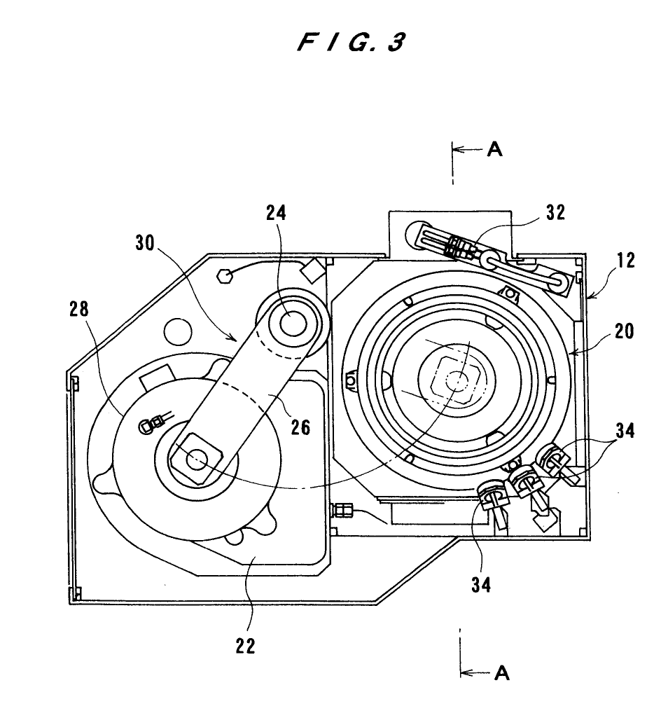

The plating apparatus 12, as shown in FIG. 3, is provided with a substrate processing section 20 for performing plating process and processing incidental thereto, and a plating solution tray 22 for storing a plating solution is disposed adjacent to the substrate processing section 20. There is also provided an electrode arm portion 30 having an electrode head 28 which is held at the front end of a swing arm 26 swingable about a rotating shaft 24 and which is swung between the substrate processing section 20 and the plating solution tray 22. Furthermore, a pre-coating/recovering arm 32, and fixed nozzles 34 for ejecting pure water or a chemical liquid such as ion water, and also a gas or the like toward a substrate are disposed laterally of the substrate processing section 20. In this embodiment, three of the fixed nozzles 34 are disposed, and one of them is used for supplying pure water.

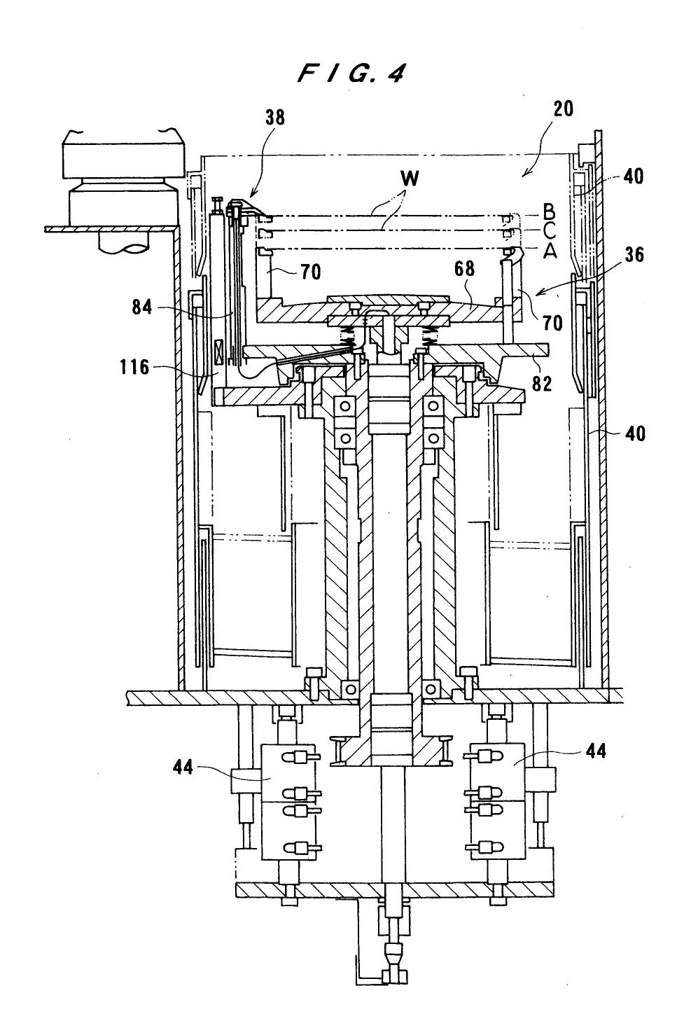

The substrate processing section 20, as shown in FIG. 4, has a substrate holder 36 for holding a substrate W with its surface (surface to be plated) facing upward, and a cathode portion 38 located above the substrate holder 36 so as to surround a peripheral portion of the substrate holder 36. Further, a substantially cylindrical bottomed splash prevention cup 40 surrounding the periphery of the substrate holder 36 for preventing scatter of various chemical liquids used during processing is provided so as to be vertically movable by an air cylinder (not shown).

The substrate holder 36 is adapted to be raised and lowered by the air cylinder 44 to and from a lower substrate transfer position A, an upper plating position B, and a pretreatment/cleaning position C that is intermediate positions A and B. The substrate holder 36 is also adapted to rotate at an arbitrary acceleration and an arbitrary velocity, integrally with the cathode portion 38 by a rotating motor and a belt (not shown). Substrate carry-in and carry-out openings (not shown) are provided in confrontation with substrate transfer position A in a side panel of the plating apparatus 12 facing the transfer robot 14. When the substrate holder 36 is raised to plating position B, a sealing member 90 and cathodes 88 (to be described below) of the cathode portion 38 are brought into contact with the peripheral portion of the substrate W held by the substrate holder 36. On the other hand, the splash prevention cup 40 has an upper end located below the substrate carry-in and carry-out openings, and when the splash prevention cup 40 ascends, the upper end of the cup 40 reaches a position above the cathode portion 38 closing the substrate carry-in and carry-out openings, as shown by imaginary lines in FIG. 4.

The plating solution tray 22 serves to wet a porous member (plating solution impregnated material) 110 and an anode 98 (to be described later on) of the electrode arm portion 30 with a plating solution, when plating has not been performed. The plating solution tray 22 is set at a size in which the porous member 110 can be accommodated, and the plating solution tray 22 has a plating solution supply port and a plating solution drainage port (not shown). A photo-sensor is attached to the plating solution tray 22, and can detect brimming with the plating solution in the plating solution tray 22, i.e., overflow, and drainage.

The electrode arm portion 30 is vertically movable by a vertical movement motor 132, which is a servomotor, and a ball screw 134, and swingable between the plating solution tray 22 and the substrate processing section 20 by a swing motor, as described bellow. A pneumatic actuator may be used instead of the motor.

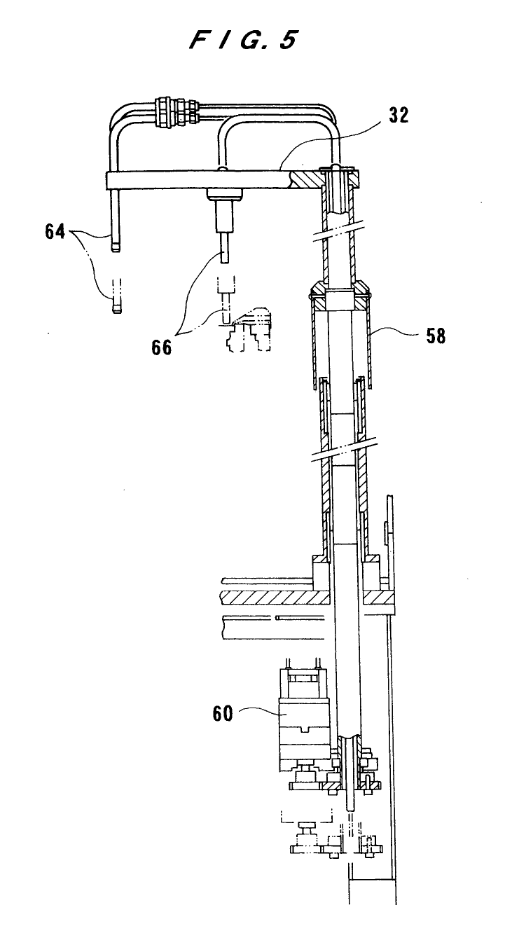

As shown in FIG. 5, the pre-coating/recovering arm 32 is coupled to an upper end of a vertical support shaft 58. The pre-coating/recovering arm 32 is swingable by a rotary actuator 60 and is also vertically moveable by an air cylinder (not shown). The pre-coating/recovering arm 32 supports a pre-coating nozzle 64 for discharging a pre-coating liquid, on its free end side, and a plating solution recovering nozzle 66 for recovering the plating solution, on a portion closer to its proximal end. The pre-coating nozzle 64 is connected to a syringe that is actuatable by an air cylinder, for example, for intermittently discharging a pre-coating liquid from the pre-coating nozzle 64. The plating solution recovering nozzle 66 is connected to a cylinder pump or an aspirator, for example, to draw the plating solution on the substrate from the plating solution recovering nozzle 66.

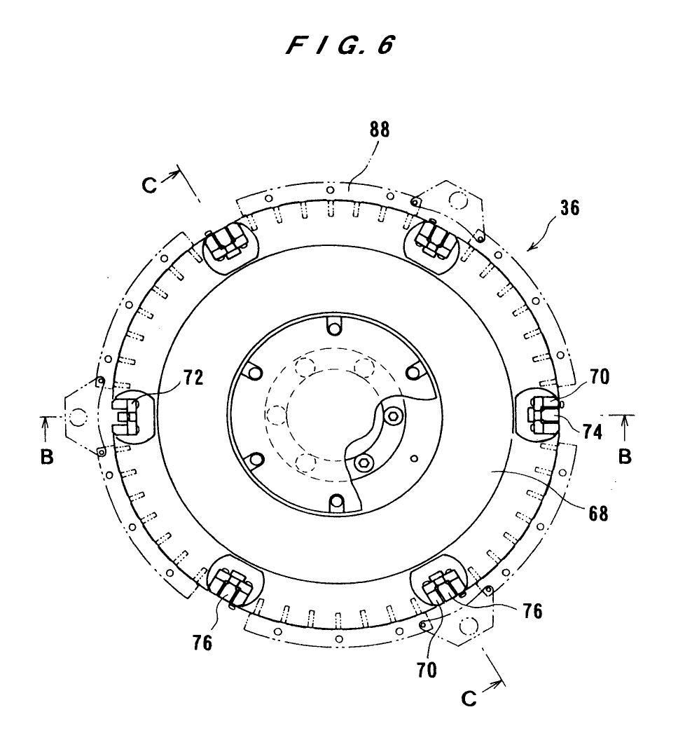

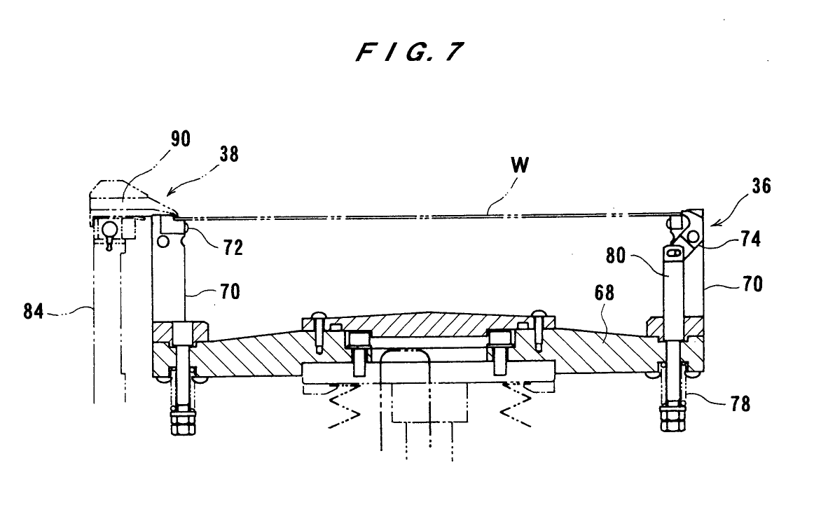

As shown in FIGS. 6 through 8, the substrate holder 36 has a disk-shaped substrate stage 68 and six vertical support arms 70 disposed at spaced intervals on the circumferential edge of the substrate stage 68 for holding a substrate W in a horizontal plane on respective upper surfaces of the support arms 70. A positioning plate 72 is mounted on an upper end one of the support arms 70 for positioning the substrate by contacting the end face of the substrate. A pressing finger 74 is rotatably mounted on an upper end of the support arm 70, which is positioned opposite to the support arm 70 having the positioning plate 72, for abutting against an end face of the substrate W and pressing the substrate W to the positioning plate 72 when rotated. Chucking fingers 76 are rotatably mounted on upper ends of the remaining four support arms 70 for pressing the substrate W downwardly and gripping the circumferential edge of the substrate W.

The pressing finger 74 and the chucking fingers 76 have respective lower ends coupled to upper ends of pressing pins 80 that are normally urged to move downwardly by coil springs 78. When the pressing pins 80 are moved downwardly, the pressing finger 74 and the chucking fingers 76 are rotated radially inwardly into a closed position. A support plate 82 is disposed below the substrate stage 68 for engaging lower ends of the opening pins 80 and pushing them upwardly.

When the substrate holder 36 is located in substrate transfer position A shown in FIG. 4, the pressing pins 80 are engaged and pushed upwardly by the support plate 82, so that the pressing finger 74 and the chucking fingers 76 rotate outwardly and open. When the substrate stage 68 is elevated, the opening pins 80 are lowered under the resiliency of the coil springs 78, so that the pressing finger 74 and the chucking fingers 76 rotate inwardly and close.

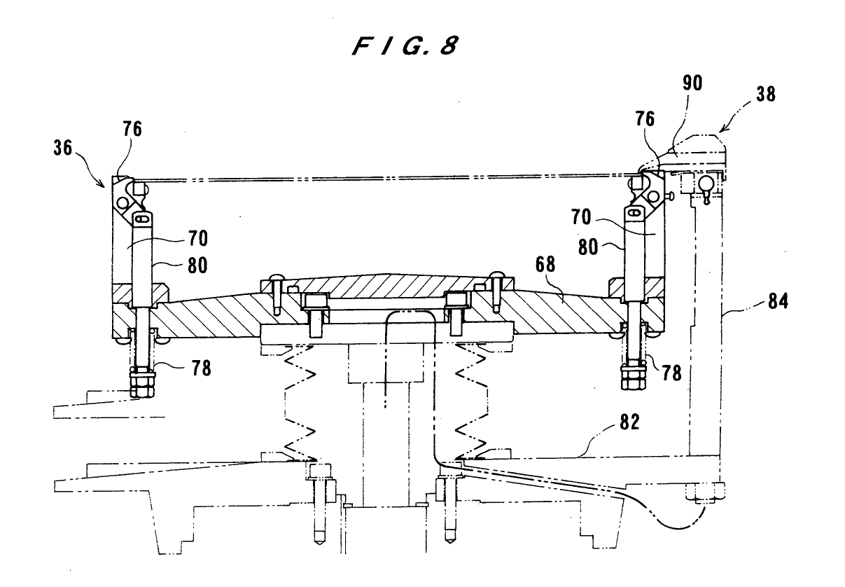

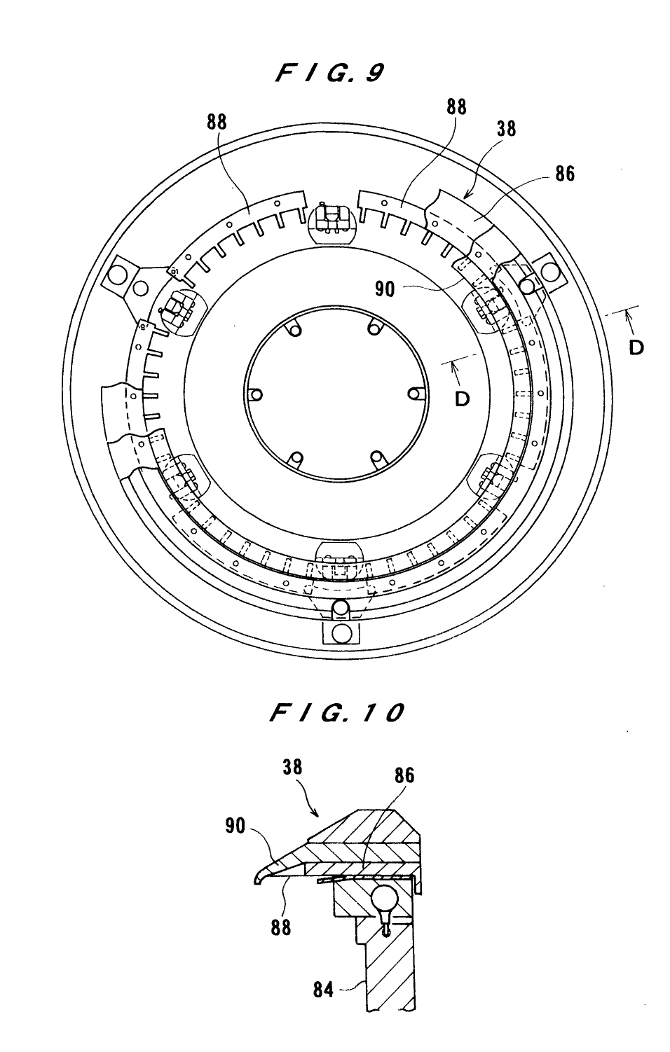

As shown in FIGS. 9 and 10, the cathode portion 38 comprises an annular frame 86 fixed to upper ends of vertical support columns 84 mounted on the peripheral edge of the support plate 82 (see FIG. 8), a plurality of, six in this embodiment, cathodes 88 attached to a lower surface of the annular frame 86 and projecting inwardly, and an annular sealing member 90 mounted on an upper surface of the annular frame 86 in covering relation to upper surfaces of the cathodes 88. The sealing member 90 is adapted to have an inner peripheral edge portion inclined inwardly downwardly and progressively thin-walled, and to have an inner peripheral end suspending downwardly.

When the substrate holder 36 has ascended to plating position B, as shown FIG. 4, the cathodes 88 are pressed against the peripheral portion of the substrate W held by the substrate holder 36 for thereby allowing electric current to pass through the substrate W. At the same time, an inner peripheral end portion of the sealing member 90 is brought into contact with an upper surface of the peripheral portion of the substrate W under pressure to seal its contact portion in a watertight manner. As a result, the plating solution supplied onto the upper surface (surface to be plated) of the substrate W is prevented from seeping from the end portion of the substrate W, and the plating solution is prevented from contaminating the cathodes 88.

In the present embodiment, the cathode portion 38 is vertically immovable, but rotatable in a body with the substrate holder 36. However, the cathode portion 38 may be arranged such that it is vertically movable and the sealing member 90 is pressed against the surface, to be plated, of the substrate W when the cathode portion 38 is lowered.

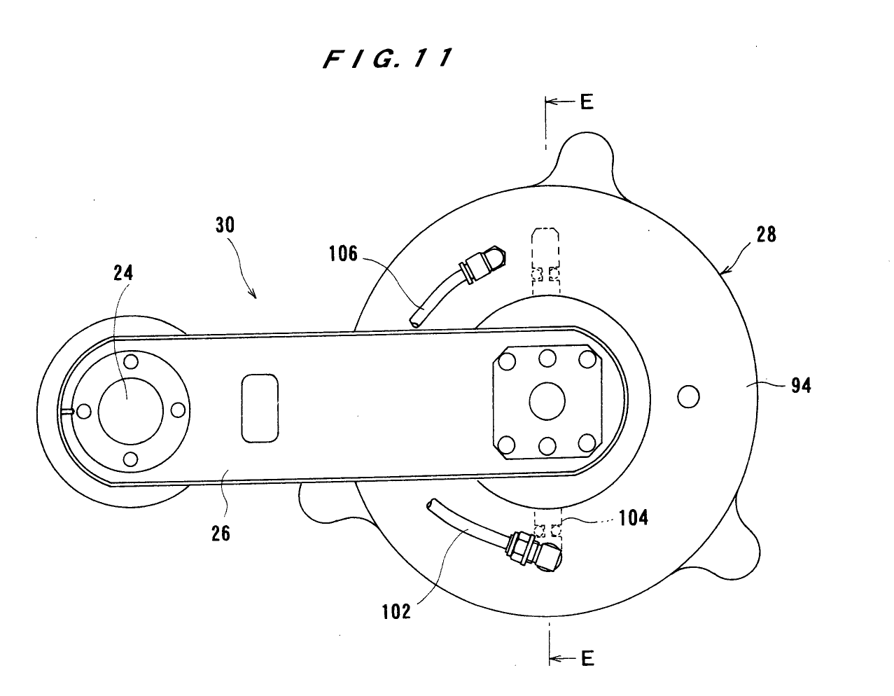

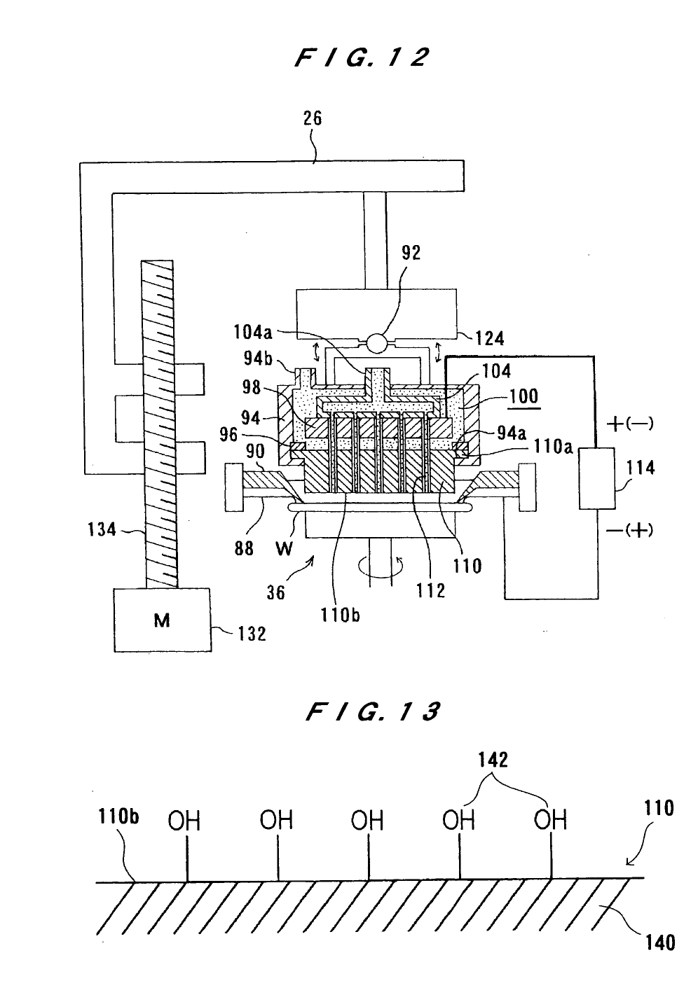

As shown in FIGS. 11 and 12 the electrode head 28 of the electrode arm section 30 includes a electrode holder 94 which is coupled via a ball bearing 92 to the free end of the swing arm 26, and a porous member (plating solution impregnated material) 110 which is disposed such that it closes the bottom opening of the electrode holder 94. The electrode holder 94 has at its lower end an inwardly-projecting portion 94a, while the porous member 110 has at its top a flange portion 110a. The flange portion 110a is engaged with the inwardly-projecting portion 94a and a spacer 96 is interposed therebetween. The porous member 110 is thus held with the electrode holder 94, while a hollow plating solution chamber 100 is defined in the electrode holder 94.

The porous member 110 is made of a hydrophilic material or has at least a hydrophilic substrate-facing surface 110b that faces the surface to be plated of the substrate W. Specifically, if the base material of the porous member 110 is a hydrophobic material, then at least the substrate-facing surface 110b is (1) modified into a hydrophilic surface, or (2) given hydrophilic functional groups to turn itself into a hydrophilic surface, or (3) cross-linked or coated with a hydrophilic material or a surfactant to turn itself into a hydrophilic surface. Even if the base material of the porous member 110 is a hydrophilic material, at least the substrate-facing surface 110b may be treated by one of the above hydrophilic treatments to enhance hydrophilic of the substrate-facing surface of the porous member that faces the surface to be plated of the substrate.

The porous member 110 is composed of, for example, porous ceramics such as alumina, SiC, mullite, zirconia, titania or cordierite, or a hard porous material such as a sintered compact of polypropylene or polyethylene, or a composite material comprising these materials. The porous member 11 may be composed of a woven fabric or a non-woven fabric. In case of the alumina-based ceramics, for example, the ceramics with a pore diameter of 30 to 200 μm is used. In case of the SiC, SiC with a pore diameter of not more than 30 μm, a porosity of 20 to 95%, and a thickness of about 1 to 20 mm, preferably 5 to 20 mm, more preferably 8 to 15 mm, is used. The porous ceramic plate per se is an insulator, but the porous member 110 is constituted to have lower electric conductivity than that of the plating solution by causing the plating solution to enter its interior complicatedly and follow a considerably long path in the thickness direction.

The porous member 110, which has the high resistance, is disposed in the plating solution chamber 100. Hence, the influence of the resistance of the seed layer 6 (see FIG. 1A) becomes a negligible degree. Consequently, the difference in current density over the surface of the substrate due to electrical resistance on the surface of the substrate W becomes small, and the uniformity of the plated film over the surface of the substrate improves.

According to this embodiment, as shown in FIG. 13, the porous member 110 has a base material 140 comprising a hydrophobic material such as a sintered polyethylene material or the like and having a substrate-facing surface 110b that faces the surface to be plated of the substrate, which is given hydrophilic functional groups 142 comprising hydroxyl groups (—OH) to make itself hydrophilic. Hydrophilic functional groups 142 may alternatively comprise ═O, —COH, —SO₃H, or the like. The substrate-facing surface 110b may be given hydrophilic functional groups by any desired processes including a chemical reaction, a plasma process, an ozone process, etc. For example, a surface of a porous member of polyethylene may be turned into a hydrophilic surface by being treated for 2 minutes with a mixed solution of sulfuric acid and chromic acid (K₃Cr₂O₇:H₂O:H₂SO₄=4.4:85.5:7.1 (weight ratios)) at a temperature of 70° C., or a surface of a porous member of Teflon (registered trademark) may be turned into a hydrophilic surface by being treated with Na-naphthalene.

The hydrophilic functional groups should preferably be functional groups which are converted into a material contained in the composition of the plating solution when the hydrophilic functional groups are dissolved. Therefore, even when the hydrophilic functional groups assigned to the substrate-facing surface of the porous member are dissolved, they will not serve as an impurity in the plating solution.

By thus turning at least the substrate-facing surface 110b of the porous member 100, which faces the surface to be plated of the substrate, into a hydrophilic surface, not only the plating solution finds it easy to penetrate into the porous member 110, but also air bubbles are less likely to be entrapped into the porous member 110 or, even if entrapped in the porous member 110, air bubbles are likely to be removed from the porous member 110 when the plating solution is brought into contact with the porous member 110. Consequently, it is easy to handle the plating solution. If the substrate-facing surface of the porous member is hydrophobic, then additives contained in the plating solution are highly apt to be attracted to the surface of the hydrophobic material. Therefore, the porous member tends to attract a large amount of additive, and the amount of attracted additive is liable to change largely with time, making it difficult to control the composition of the plating solution. These problems can be solved by making the substrate-facing surface of the porous member hydrophobic.

In view of handling the plating solution, it is more effective and hence desirable for the porous member to be hydrophilic also in its inside. However, at least the hydrophilic substrate-facing surface is sufficiently effective to allow the plating solution to penetrate easily into the porous member, and equally effective to prevent air bubbles from being entrapped into the porous member and also to control the composition of the plating solution. These advantages also apply to other embodiments to be described below.

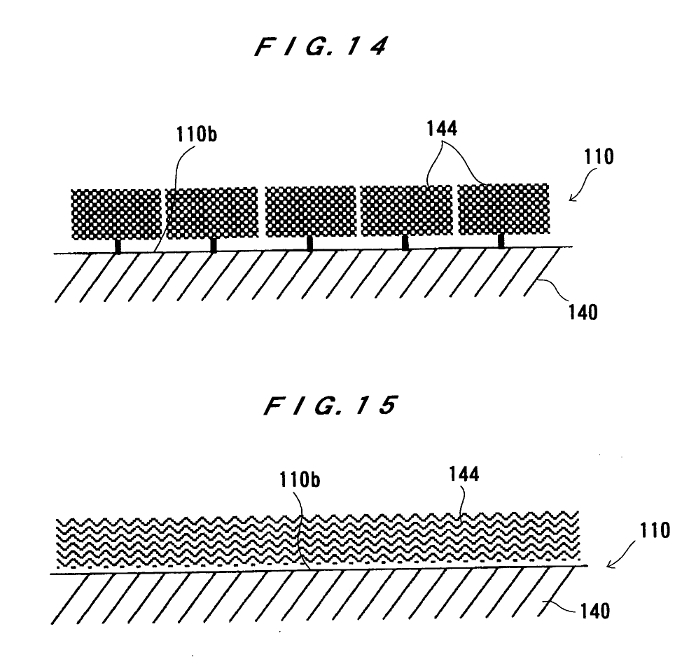

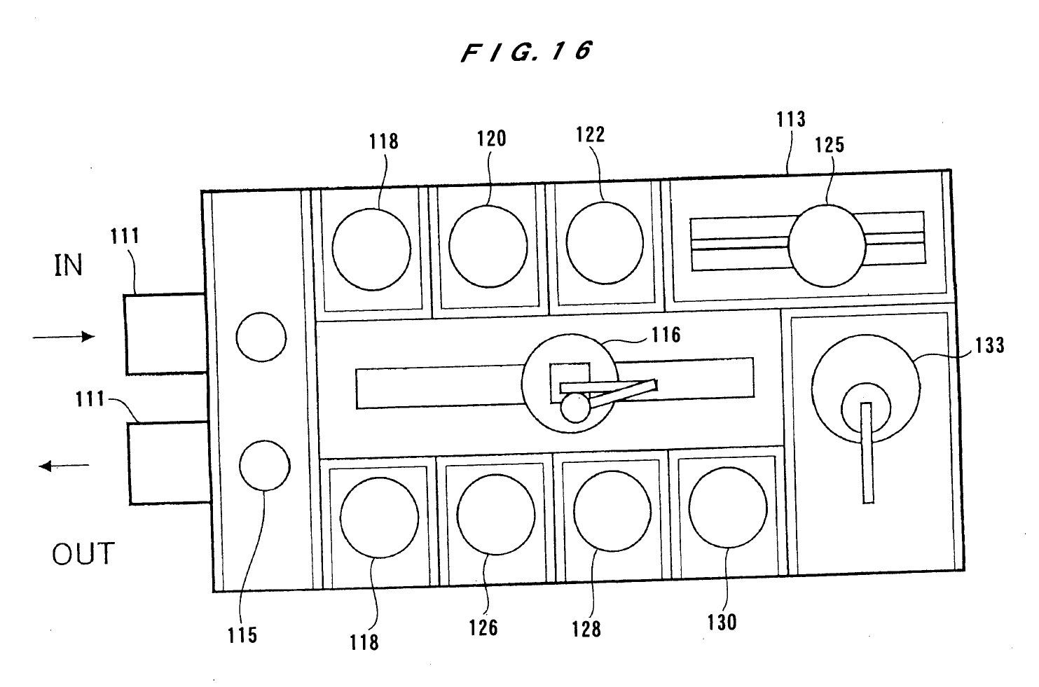

In this embodiment, the substrate-facing surface 110b of the porous member 110 is given hydrophilic functional groups 142 comprising hydroxyl groups (—OH) to make itself hydrophilic. However, as shown in FIG. 14, the surface of the base material 140 comprising a hydrophobic material of Teflon (registered trademark) or the like, for example, may be cross-linked with a hydrophilic material or surfactant 144 to turn the substrate-facing surface 110b of the porous member 110 into a hydrophilic surface. Alternatively, as shown in FIG. 15, the surface of the base material 140 comprising a hydrophobic material of Teflon (registered trademark) or the like, for example, may be coated with a hydrophilic material or surfactant 144 to turn the substrate-facing surface 110b of the porous member 110 into a hydrophilic surface.

The surface of the base material may be cross-linked with a hydrophilic material by any desired processes including a graft polymerization process, a plasma polymerization process, etc. The hydrophilic material or surfactant 144 should preferably be a material or surfactant contained in the composition of the plating solution. Therefore, even if the hydrophilic material or surfactant 144 which has been cross-linked or coated on the substrate-facing surface 110b of the porous member 110 is peeled off, it will not serve as an impurity in the plating solution. Particularly, using a surfactant contained in the composition of the plating solution allows the effect of the additive (surfactant) to be borne by the substrate-facing surface 110b of the porous member 110, so that the effect can be limited to an area that faces the surface to be plated of the substrate.

The substrate-facing surface 110b of the porous member 110 may be modified by a plasma process. The plasma process is also referred to as a plasma contact process, which includes a glow discharge process and a corona discharge process.

The glow discharge process is a type of the plasma contact process and generates a plasma due to a glow discharge. For example, a surface of a porous member of Teflon (registered trademark) can be made hydrophilic by being subjected to a glow discharge under the pressure of 0.1 mm Hg for 10 seconds. The corona discharge process is also a type of the plasma contact process and generates a plasma due to a corona discharge.

The substrate-facing surface 110b of the porous member 110 may be made hydrophilic by being modified by an ultraviolet ray application process. For example, a surface of a porous member of PET can be made hydrophilic by being exposed to ultraviolet rays having a maximum intensity at the wavelength of 2537 Å for 20 minutes. Alternatively, substrate-facing surface 110b of the porous member 110 may be made hydrophilic by being modified by an ozone process.

The plasma process, the glow discharge process, the corona discharge process, the ultraviolet ray application process, and the ozone process are free of the danger of metal contamination because they require no catalyst. The hydrophilic treatment may be performed on the material or the produced formed from the material, and the base material may be either hydrophobic or hydrophilic.

In the plating solution chamber 100, there is disposed an anode 98 held in abutment against a lower surface of a plating solution introduction pipe 104 disposed above the anode 98. The plating solution introduction pipe 104 has a plating solution introduction port 104a connected to a plating solution supply pipe 102 which extends from the plating solution supply equipment 18 (see FIG. 2). A plating solution discharge port 94b provided in an upper plate of the electrode holder 94 is connected to a plating solution discharge pipe 106 so as to communicate with the plating solution chamber 100.

A manifold structure is employed for the plating solution introduction pipe 104 so that the plating solution can be supplied uniformly onto the surface to be plated of the substrate. In particular, a large number of narrow tubes 112, communicating with the plating solution introduction pipe 104, are connected to the pipe 104 at predetermined positions along the long direction of the pipe 104. Further, small holes are provided in the anode 98 and the porous member 110 at positions corresponding to the narrow tubes 112. The narrow tubes 112 extend downwardly in the small holes and reach the lower surface or its vicinity of the porous member 110.

Thus, the plating solution, introduced from the plating solution supply pipe 102 into the plating solution introduction pipe 104, passes through the narrow tubes 112 and reaches the bottom of the porous member 110, and pass through the porous member 110 and fills the plating solution chamber 100, whereby the anode 98 is immersed in the plating solution. The plating solution is discharged from the plating solution discharge pipe 106 by application of suction to the plating solution discharge pipe 106.

In order to suppress slime formation, the anode 98 is made of copper (phosphorus-containing copper) containing 0.03 to 0.05% of phosphorus. It is also possible to use an insoluble material for the anode 98.

The cathodes 88 are electrically connected to a cathode of a plating power source 114, and the anode 98 is electrically connected to an anode of the plating power source 114. The plating power source 114 can change the direction of current flow alternatively.

The ball bearing 92 is coupled to the pivot arm 26 via a support member 124. The pivot arm 26 is vertically movable by a vertical movement motor 132, which is a servomotor, and a ball screw 134. It is also possible to use a pneumatic actuator to constitute a vertical movement mechanism.

When carrying out plating, the substrate holder 36 is positioned at plating position B (see FIG. 4). The electrode head 28 is lowered until the distance between the substrate W held by the substrate holder 36 and the porous member 110 becomes e.g. about 0.1 to 3 mm. A plating solution is supplied from the plating solution supply pipe 102 to the upper surface (surface to be plated) of the substrate W while impregnating the porous member 110 with the plating solution and filling the plating solution chamber 100 with the plating solution to carry out plating of the surface to be plated of the substrate W.

The operation of the substrate processing apparatus incorporating the above-described plating apparatus will now be described.

First, a substrate W to be plated is taken out from one of the loading/unloading units 10 by the transfer robot 14, and transferred, with the surface to be plated facing upward, through the substrate carry-in and carry-out opening defined in the side panel of a frame, into one of the plating apparatuses 12. At this time, the substrate holder 36 is in lower substrate transfer position A. After the hand of the transfer robot 14 has reached a position directly above the substrate stage 68, the hand of the transfer robot 14 is lowered to place the substrate W on the support arms 70. The hand of the transfer robot 14 is then retracted through the substrate carry-in and carry-out opening.

After the hand of the transfer robot 14 is retracted, the splash prevention cup 40 is elevated. Then, the substrate holder 36 is lifted from substrate transfer position A to pretreatment/cleaning position C. As the substrate holder 36 ascends, the substrate W placed on the support arms 70 is positioned by the positioning plate 72 and the pressing finger 74, and then reliably gripped by the chucking fingers 76.

Meanwhile, the electrode head 28 of the electrode arm portion 30 is in a normal position over the plating solution tray 22 now, and the porous member 110 or the anode 98 is positioned in the plating solution tray 22. At the same time that the cup 40 ascends, the plating solution starts being supplied to the plating solution tray 22 and the electrode head 28. Until the step of plating the substrate W is initiated, the new plating solution is supplied, and the plating solution discharge pipe 106 is evacuated to replace the plating solution in the porous member 110 and remove air bubbles from the plating solution in the porous member 110. When the ascending movement of the splash prevention cup 40 is completed, the substrate carry-in and carry-out opening in the side panel is closed by the splash prevention cup 40, isolating the atmosphere in the side panel and the atmosphere outside of the side panel from each other.

When the splash prevention cup 40 is elevated, the pre-coating step is initiated. Specifically, the substrate holder 36 that has received the substrate W is rotated, and the pre-coating/recovering arm 32 is moved from the retracted position to a position confronting the substrate W. When the rotational speed of the substrate holder 36 reaches a preset value, the pre-coating nozzle 64 mounted on the tip end of the pre-coating/recovering arm 32 intermittently discharges a pre-coating liquid which comprises a surfactant, for example, toward the surface to be plated of the substrate W. At this time, since the substrate holder 36 is rotating, the pre-coating liquid spreads all over the surface to be plated of the substrate W. Then, the pre-coating/recovering arm 32 is returned to the retracted position, and the rotational speed of the substrate holder 36 is increased to spin the pre-coating liquid off and dry the surface to be plated of the substrate W.

After the completion of the pre-coating step, the plating step is initiated. First, the substrate holder 36 is stopped against rotation, or the rotational speed thereof is reduced to a preset rotational speed for plating. In this state, the substrate holder 36 is lifted to plating position B. Then, the peripheral portion of the substrate W is brought into contact with the cathodes 88, when it is possible to pass an electric current, and at the same time, the sealing member 90 is pressed against the upper surface of the peripheral portion of the substrate W, thus sealing the peripheral portion of the substrate W in a watertight manner.

Based on a signal indicating that the pre-coating step for the loaded substrate W is completed, the electrode arm portion 30 is swung in a horizontal direction to displace the electrode head 28 from a position over the plating solution tray 22 to a position over the plating processing position. After the electrode head 28 reaches this position, the electrode head 28 is lowered toward the cathode portion 38. At this time, the porous member 110 does not contact with the surface to be plated of the substrate W, but is held closely to the surface to be plated of the substrate W at a distance ranging from 0.1 mm to 3 mm. When the descent of the electrode head 28 is completed, the plating process is initiated.

In particular, the cathode of the plating power source 114 is connected to the cathodes 88 and the anode of the plating power source 114 is connected to the anode 98, and a constant voltage is applied between the cathodes 88 and the anode 98, i.e. constant voltage control is carried out, while a plating solution is supplied from the plating solution supply pipe 102 into the electrode head 28, so that the plating solution is supplied onto the upper surface (surface to be plated) of the substrate W, while the porous member 110 is impregnated with the plating solution and the plating solution chamber 100 is filled with the plating solution.

At this time, the substrate-facing surface 110b of the porous member 110, which faces the surface to be plated of the substrate W that is held by the substrate holder 36, is a hydrophilic surface, as described above. Therefore, unlike a hydrophobic substrate-facing surface, the substrate-facing surface 110b not only allows the plating solution to penetrate easily into the porous member 110, but also prevents air bubbles from being entrapped into the porous member 110 or, even if entrapped in the porous member 110, air bubbles can easily be removed from the porous member 110 when the plating solution is brought into contact with the porous member 110. Consequently, it is easy to handle the plating solution. Furthermore, the porous member 110 does not attract a large amount of additive in the plating solution, and it is easy to control the composition of the plating solution.

After completion of the filling of plating solution, a plated film is allowed to grow on the surface (seed layer 6) of the substrate while carrying out constant current control, i.e., applying a constant electric current between the cathodes 88 and the anode 98. During the plating, the substrate holder 36 is rotated at a low speed, according to necessity.

When the plating process is completed, the electrode arm portion 30 is raised and then swung to return the electrode head 28 to the position above the plating solution tray 22 and to lower to the ordinary position. Then, the pre-coating/recovering arm 32 is moved from the retreat position to the position confronting to the substrate W, and lowered to recover the remainder of the plating solution on the substrate W by a plating solution recovering nozzle 66. After recovering of the remainder of the plating solution is completed, the pre-coating/recovering arm 32 is returned to the retreat position, and pure water is supplied from the fixed nozzle 34 for supplying pure water toward the central portion of the substrate W for rinsing the plated surface of the substrate. At the same time, the substrate holder 36 is rotated at an increased speed to replace the plating solution on the surface of the substrate W with pure water. Rinsing the substrate W in this manner prevents the splashing plating solution from contaminating the cathodes 88 of the cathode portion 38 during descent of the substrate holder 36 from plating position B.

After completion of the rinsing, the washing with water step is initiated. That is, the substrate holder 36 is lowered from plating position B to pretreatment/cleaning position C. Then, while pure water is supplied from the fixed nozzle 34 for supplying pure water, the substrate holder 36 and the cathode portion 38 are rotated to perform washing with water. At this time, the sealing member 90 and the cathodes 88 can also be cleaned, simultaneously with the substrate W, by pure water directly supplied to the electrode potion 38, or pure water scattered from the surface of the substrate W.

After washing with water is completed, the drying step is initiated. That is, supply of pure water from the fixed nozzle 34 is stopped, and the rotational speed of the substrate holder 36 and the cathode portion 38 is further increased to remove pure water on the surface of the substrate W by centrifugal force and to dry the surface of the substrate W. The sealing member 90 and the cathodes 88 are also dried at the same time. Upon completion of the drying, the rotation of the substrate holder 36 and the cathode portion 38 is stopped, and the substrate holder 36 is lowered to substrate transfer position A. Thus, the gripping of the substrate W by the chucking fingers 76 is released, and the substrate W is just placed on the upper surfaces of the support arms 70. At the same time, the splash prevention cup 40 is also lowered.

All the steps including the plating step, the pretreatment step accompanying to the plating step, the cleaning step, and the drying step are now finished. The transfer robot 14 inserts its hand through the substrate carry-in and carry-out opening into the position beneath the substrate W, and raises the hand to receive the plated substrate W from the substrate holder 36. Then, the transfer robot 14 returns the plated substrate W received from the substrate holder 36 to one of the loading/unloading units 10.

While the plating process has been described above, the plating apparatus can be used to perform an electrolytic etching process by reversing the direction of the current, i.e., by reversing the polarity of the power source.

With this embodiment, the porous member can easily be wetted by the plating solution, the amount of air bubbles entrapped into the porous member when the plating solution is brought into contact with the porous member is reduced, and any bubbles that have been entrapped in the porous member can easily be removed. Therefore, it is easy to handle the plating solution. Furthermore, the additive contained in the plating solution is less liable to be attracted to the porous member, making it easy to control the composition of the plating solution.

FIG. 16 is a plan view of a substrate processing apparatus incorporating a plating apparatus according to another embodiment of the present invention. As shown in FIG. 16, the substrate processing apparatus comprises a rectangular apparatus frame 113 to which transfer boxes 111 such as SMIF (Standard Mechanical Interface) boxes which accommodate a number of substrates such as semiconductor wafers, are removably attached. Inside of the frame 113, there are disposed a loading/unloading station 115 and a movable transfer robot 116 for transferring a substrate to and from the loading/unloading station 115. A pair of plating apparatuses 118 is disposed on both sides of the transfer robot 116. A cleaning and drying apparatus 120, a bevel etching and backside cleaning apparatus 122, and a film thickness measuring instrument 125 are disposed in alignment with each other on one side of the transfer robot 116. On the other side of the transfer robot 116, a heat treatment (annealing) apparatus 126, a pretreatment apparatus 128, an electroless plating apparatus 130, and a polishing apparatus 133 are disposed in alignment with each other.

The apparatus frame 113 is shielded so as not to allow a light to transmit therethrough, thereby enabling subsequent processes to be performed under a light-shielded condition in the apparatus frame 113. Specifically, the subsequent processes can be performed without irradiating the interconnects with a light such as an illuminating light. By thus preventing the interconnects from being irradiated with a light, it is possible to prevent the interconnects of copper from being corroded due to a potential difference of light that is caused by application of light to the interconnects composed of copper, for example.

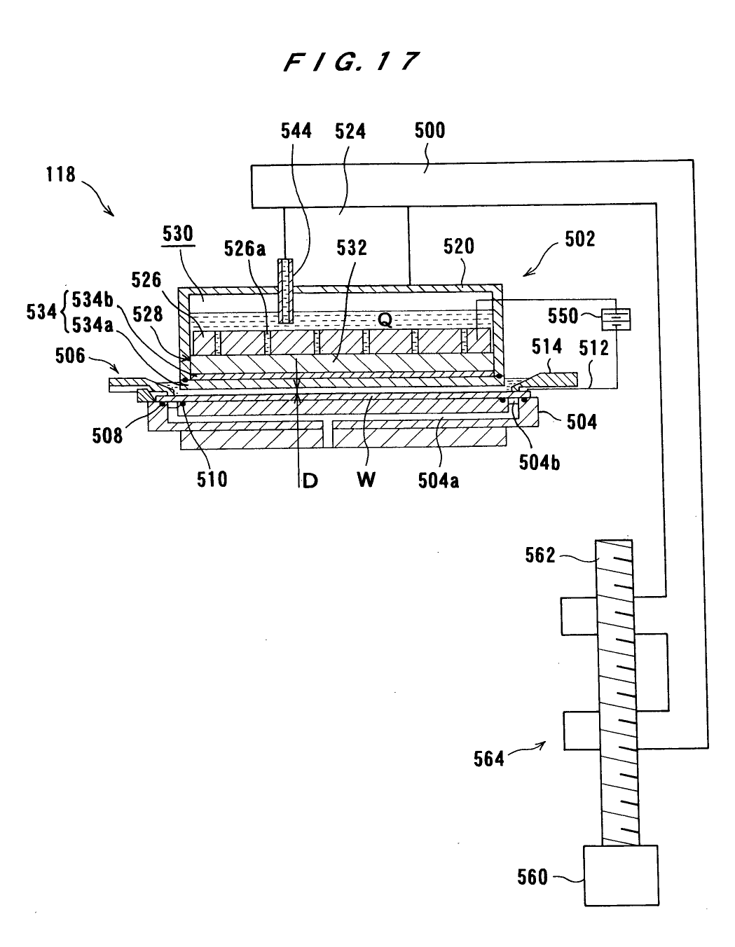

FIG. 17 schematically shows the plating apparatus 118. As shown in FIG. 17, the plating apparatus 118 comprises a swing arm 500 that is horizontally swingable. An electrode head 502 is rotatably supported by a tip end portion of the swing arm 500. A substrate holder 504 for holding a substrate W in such a state that a surface, to be plated, of the substrate W faces upwardly is vertically movably disposed below the electrode head 502. A cathode portion 506 is disposed above the substrate holder 504 so as to surround a peripheral portion of the substrate holder 504.

In this embodiment, the electrode head 502 whose diameter is slightly smaller than that of the substrate holder 504 is used so that plating can be performed over the substantially entire surface, to be plated, of the substrate W without changing a relative position between the electrode head 502 and the substrate holder 504. In this embodiment, the plating apparatus utilizes a face-up system in which the substrate is plated in such a state that the substrate is held with its surface facing upwardly. However, the present invention is also applicable to the plating apparatus utilizes the so-call face-down system in which a substrate is plated in such a state that the substrate is held with its surface facing downwardly, or to the so-call vertical type plating apparatus in which a substrate is plated in such a state that the substrate is disposed in vertical direction.

An annular vacuum attraction groove 504b communicating with a vacuum passage 504a provided in the substrate holder 504 is formed in a peripheral portion of an upper surface of the substrate holder 504. Seal rings 508 and 510 are provided on inward and outward sides of the vacuum attraction groove 504b, respectively. With the above structure, the substrate W is placed on the upper surface of the substrate holder 504, and the vacuum attraction groove 504b is evacuated through the vacuum passage 504a to attract the peripheral portion of the substrate W, thereby holding the substrate W.

The swing arm 500 moves vertically via an elevating/lowering mechanism (porous member positioning mechanism) 560 comprises a elevating/lowering motor 560, which is a servomotor, and a ball screw 562, as described below, and rotates (swings) via a swinging motor (not shown). Alternatively, a pneumatic actuator may be used instead of the motor.

In this embodiment, the cathode portion 506 has the cathodes 512 comprising six cathodes, and the annular sealing member 514 disposed above the cathodes 512 so as to cover upper surfaces of the cathodes 512. The sealing member 514 has an inner circumferential portion, which is inclined inwardly and downwardly, so that a thickness of the sealing member 514 is gradually reduced. The sealing member 514 has an inner circumferential edge portion extending downwardly.

With this structure, when the substrate holder 504 is moved upwardly, the peripheral portion of the substrate W held by the substrate holder 504 is pressed against the cathodes 512, thus flowing current to the substrate W. At the same time, the inner circumferential edge portion of the sealing member 514 is held in close contact with the upper surface of the peripheral portion of the substrate W to seal a contact portion in a watertight manner. Accordingly, a plating solution that has been supplied onto the upper surface (surface to be plated) of the substrate W is prevented from leaking from the end portion of the substrate W, and the cathodes 512 are thus prevented from being contaminated by the plating solution.

In this embodiment, the cathode portion 506 is not movable vertically, but is rotatable together with the substrate holder 504. However, the cathode portion 506 may be designed to be movable vertically so that the sealing member 514 is brought into close contact with the surface, to be plated, of the substrate W when the cathode portion 506 is moved downwardly.

The electrode head 502 includes a housing 520 which has a bottomed cylindrical shape with a downwardly open end. The housing 520 is fixed to a lower surface of a rotating member 524 attached to a free end of the swing arm 500 so that the housing 520 is rotated together with the rotating member 524. The housing 520 defines an anode chamber 530 by closing the lower open end with a porous member 528 so that a disk-shaped anode 526 is disposed in the anode chamber 530 and is dipped in a plating solution Q which is introduced to the anode chamber 530.

In this embodiment, the porous member 528 has a multi-layered structure comprising three-layer laminated porous materials. Specifically, the porous member 528 comprises a plating solution impregnated material 532 serving to hold a plating solution mainly, and a porous pad 534 attached to a lower surface of the plating solution impregnated material 532. This porous pad 534 comprises a lower pad 534a adapted to be brought into direct contact with the substrate W, and an upper pad 534b disposed between the lower pad 534a and the plating solution impregnated material 532. The plating solution impregnated material 532 and the upper pad 534b are positioned in the housing 520, and the lower open end of the housing 520 is closed by the lower pad 534a.

As described above, since the porous member 528 has a multi-layered structure, it is possible to use the porous pad 534 (the lower pad 534a) which contacts the surface to be plated of the substrate W, for example, and has flatness enough to flatten irregularities on the surface, to be plated, of the substrate W. The lower pad 534a is required to have the contact surface adapted to contact the surface (surface to be plated) of the substrate W and having a certain degree of flatness, and to have fine through-holes therein for allowing the plating solution to pass therethrough. It is also necessary that at least the contact surface of the lower pad 534a is made of an insulator or a material having high insulating properties.

It is desirable that the fine through-holes of the lower pad 534a have a circular cross section in order to maintain flatness of the contact surface. An optimum diameter of each of the fine through-holes and the optimum number of the fine through-holes per unit area vary depending on the kind of a plated film and an interconnect pattern. However, it is desirable that both the diameter and the number are as small as possible in view of improving selectivity of a plated film that is growing in recesses. Specifically, the diameter of each of the fine through-holes may be not more than 30 μm, preferably in the range of 5 to 20 μm. The number of the fine through-holes having such diameter per unit area may be represented by a porosity of not more than 50%.

Furthermore, it is desirable that the lower pad 534a is made of hydrophilic material. For example, the following hydrophobic materials may be used after being subjected to hydrophilization or being introduced with a hydrophilic group by polymerization. Examples of such materials include porous polyethylene (PE), porous polypropylene (PP), porous polyamide, porous polycarbonate, and porous polyimide. The porous polyethylene (PE), the porous polypropylene (PP), the porous polyamide, and the like are produced by using fine powder of ultrahigh-molecular polyethylene, polypropylene, and polyamide, or the like as a material, squeezing the fine powder, and sintering and forming the squeezed fine powder. These materials are commercially available. For example, “Furudasu S (trade name)” manufactured by Mitsubishi Plastics, Inc, “Sunfine UF (trade name)”, “Sunfine AQ (trade name)”, both of which are manufactured by Asahi Kasei Corporation, and “Spacy (trade name)” manufactured by Spacy Chemical Corporation are available on the market. The porous polycarbonate may be produced by passing a high-energy heavy metal such as copper, which has been accelerated by an accelerator, through a polycarbonate film to form straight tracks, and then selectively etching the tracks.

On the other hand, the plating solution impregnated material 532 is composed of, for example, porous ceramics such as alumina, SiC, mullite, zirconia, titania or cordierite, or a hard porous member such as a sintered compact of polypropylene or polyethylene, or a composite material comprising these materials. The plating solution impregnated material 532 may be composed of a woven fabric or a non-woven fabric. In case of the alumina-based ceramics, for example, the ceramics with a pore diameter of 30 to 200 μm is used. In case of the SiC, SiC with a pore diameter of not more than 30 μm, a porosity of 20 to 95%, and a thickness of about 1 to 20 mm, preferably 5 to 20 mm, more preferably 8 to 15 mm, is used. The plating solution impregnated material 532, in this embodiment, is composed of porous ceramics of alumina having a porosity of 30%, and an average pore diameter of 100 μm. The porous ceramic plate per se is an insulator, but is constructed so as to have a smaller conductivity than the plating solution by causing the plating solution to enter its interior complicatedly and follow a considerably long path in the thickness direction.

In this manner, the plating solution impregnated material 532 is disposed in the anode chamber 530, and generates high resistance. Hence, the influence of the resistance of the seed layer 6 (see FIG. 1A) becomes a negligible degree. Consequently, the difference in current density over the surface of the substrate due to electrical resistance on the surface of the substrate W becomes small, and the uniformity of the plated film over the surface of the substrate improves.

The swing arm 500 from which the electrode head 502 is suspended is vertically movable by an elevating/lowering mechanism 564 that comprises an elevating/lowering motor 560, which is a servomotor, and a ball screw 562. The elevating/lowering mechanism 564 serves as a porous member positioning mechanism for vertically positioning the porous member 528 held in the electrode head 502. The elevating/lowering mechanism (porous member positioning mechanism) 564 can lower the electrode head 502 and stop the electrode head 502 at a position where the lower surface of the lower pad 534a of the porous member 528 is closely spaced a certain distance D from the surface (upper surface) of the substrate W that is held by the substrate holder 504. The distance D should preferably be 1.5 mm or less and more preferably be about 1.0 mm.

A plating solution introduction pipe 544, which introduces the plating solution into the housing 520, and a pressurized fluid introduction pipe (not shown), which introduces a pressurized fluid into the housing 520, are attached to the housing 520. A number of pores 526a are formed within the anode 526. Thus, a plating solution Q is introduced from the plating solution introduction pipe 544 into the anode chamber 530, and the interior of the anode chamber 530 is pressurized, whereby the plating solution Q reaches the upper surface of the plating solution impregnated material 532 through the pores 526a of the anode 526, and reaches the upper surface of the substrate W held by the substrate holder 504 through the interior of the plating solution impregnated material 532 and interior of the porous pad 534 (the upper pad 534b and the lower pad 534a).

The anode chamber 530 includes gases generated by chemical reaction therein, and hence the pressure in the anode chamber 530 may be varied. Therefore, the pressure in the anode chamber 530 is controlled to a certain set value by a feedback control in the process.

For example, in the case of performing copper plating, in order to suppress slime formation, the anode 526 is made of copper (phosphorus-containing copper) containing 0.03 to 0.05% of phosphorus. The anode 526 may comprise an insoluble metal such as platinum or titanium or an insoluble electrode comprising metal on which platinum or the like is coated or plated. Since replacement or the like is unnecessary, the insoluble metal or the insoluble electrode is preferable. Further, the anode 526 may be a net-like anode which allows a plating solution to pass therethrough easily.

The cathodes 512 are electrically connected to a cathode of a plating power source 550, and the anode 526 is electrically connected to an anode of the plating power source 550.

Next, operation for conducting plating by the plating apparatus 118 will be described. First, in a state that the substrate W is attracted to and held by the upper surface of the substrate holder 504, the substrate holder 504 is raised to bring the peripheral portion of the surface to be plated of the substrate W, which has the seed layer 6 (conductive layer) shown in FIG. 1A, for example, into contact with the cathodes 512, thus making it possible to supply current to the substrate W. Then, the substrate holder 504 is further raised to press the sealing member 514 against the upper surface of the peripheral portion of the surface to be plated of the substrate W, thereby sealing the peripheral portion of the surface to be plated of the substrate W in a watertight manner by the sealing member 514.

On the other hand, the electrode head 502 is moved from a position (idling position) where replacement of the plating solution, removal of bubbles, and the like are conducted by idling to a predetermined position (process position) in such a state that the plating solution Q is held inside the electrode head 502. Specifically, the swing arm 500 is once raised and further swung, whereby the electrode head 502 is located right above the substrate holder 504. Thereafter, the electrode head 502 is lowered, and when the electrode head 502 reaches the predetermined position (process position) where the lower surface of the lower pad 534a of the porous member 528 is closely spaced a certain distance D, for example 1 mm (D=1 mm), from the surface (upper surface) of the substrate W that is held by the substrate holder 504, the electrode head 502 is stopped. Then, the anode chamber 530 is pressurized, and the plating solution Q held by the electrode head 502 is discharged from the lower surface of the porous pad 534.

After the plating solution Q is spread over the substrate W, while the lower pad 534a is positioned closely to the surface of the substrate W, the porous member 528 is rotated at a speed of one revolution/sec., for example, and the cathodes 512 are connected to the cathode of the plating power source 550 and the anode 526 is connected to the anode of the plating power source 550 to pass a current, whose current density is in the range from 1 to 50 mA/cm², for example, between the surface to be plated (seed layer 6) of the substrate W and the anode 526, thereby plating the surface to be plated (the surface of the seed layer 6) of the substrate W.

By thus positioning the porous member 528 at a position close to and spaced the distance D from the surface to be plated of the substrate W that is held by the substrate holder 504 and rotating the porous member 528, the state of the surface to be plated is changed, suppressing the plating rate on the surface of a field area of the surface to be plated (an upper portion of the interconnect pattern). The change in the state of the surface to be plated is selectively given to the surface of the field area of the surface to be plated, rather than to an inner portion of the interconnect pattern such as a trench or the like, by the positioning of the porous member 528 close to the surface to be plated. Consequently, there is developed a plating rate difference between the inner portion of the interconnect pattern such as a trench or the like and the surface of the field area (the upper portion of the interconnect pattern). The plating rate difference causes the height of the plated layer in the inner portion of the interconnect pattern such as a trench or the like to catch up the height of the plated layer on the surface of the field area, forming a flatter plated film on the surface of the substrate W. According to this plating process, since no special current conditions and no additives are required, and the surface to be plated of the substrate W is plated out of contact with the porous member 528, a plated film of good film quality can be formed on the substrate W without producing particles or the like.

After the copper layer 7 (see FIG. 1B) having a film thickness large enough to fill fine interconnect recesses is deposited on the surface (to be plated) of the substrate W, the current supplied between the cathodes 512 and the anode 526 is stopped, and the electrode head 502 is lifted back to its original position (idling position).

According to an alternative process, after the plating solution Q is spread over the substrate W, while the lower pad 534a is positioned closely to the surface of the substrate W, the porous member 528 may be rotated by two revolutions at a speed of one revolution/sec., for example, and then stopped from rotating. Thereafter, preferably within 2 seconds after the porous member 528 is kept still, the cathodes 512 are connected to the cathode of the plating power source 550 and the anode 526 is connected to the anode of the plating power source 550 to pass a current, whose current density is in the range from 1 to 50 mA/cm², for example, between the surface to be plated (seed layer 6) of the substrate W and the anode 526, thereby plating the surface to be plated (the surface of the seed layer 6) of the substrate W. Furthermore, if necessary, the above process may be repeated as many times as required to deposit a copper layer 7 (see FIG. 1B) having a film thickness large enough to fill fine interconnect recesses on the surface (to be plated) of the substrate W.

By thus passing the current within 2 seconds after the porous member 528 is kept still, the ratio of the plating rate in the inner portion of the interconnect pattern such as trench or the like and the plating rate on the surface of the field area (the upper portion of the interconnect pattern) can be 2 or greater, for example.

In this embodiment, the porous member 528 is rotated to provide relative motion between itself and the substrate W that is held by the substrate holder 504. However, the substrate holder 504 may be rotated.

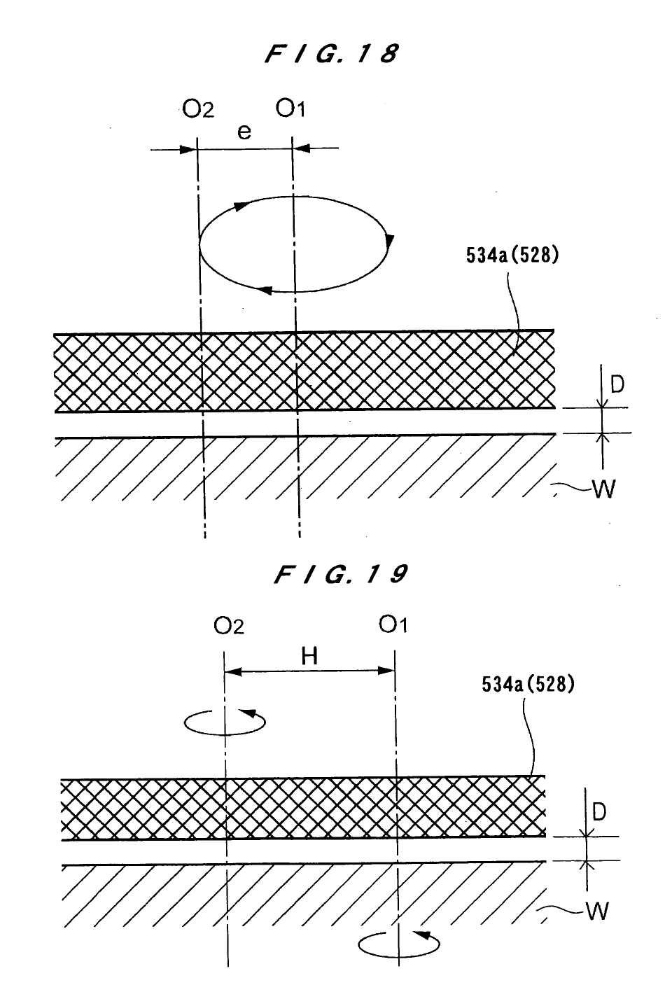

FIG. 18 is a schematic view showing another embodiment of a driving mechanism for making a relative motion between the lower pad 534a constituting the porous member 528 and the substrate W held by the substrate holder 504 (see FIG. 17). In this embodiment, the center O₁ of the lower pad 534a is off-centered by “e” from the center O₂ of the substrate W held by the substrate holder 504, whereby the lower pad 534a makes a scroll motion along a circle having a radius “e”, i.e. makes an orbital motion (translational rotary motion). Therefore, the lower pad 534a and the substrate W held by the substrate holder 504 make a relative motion by the scroll motion of the lower pad 534a.

FIG. 19 is a schematic view showing still another embodiment of a driving mechanism for making a relative motion between the lower pad 534a constituting the porous member 528 and the substrate W held by the substrate holder 504 (see FIG. 17). In this embodiment, the center O₁ of the lower pad 534a is displaced by a distance H from the center O₂ of the substrate W held by the substrate holder 504, whereby the lower pad 534a rotates about its center O₁ and the substrate W rotates about its center O₂. Thus, the lower pad 534a and the substrate W held by the substrate holder 504 make a relative motion by rotation of the lower pad 534a and the substrate W about their respective centers.

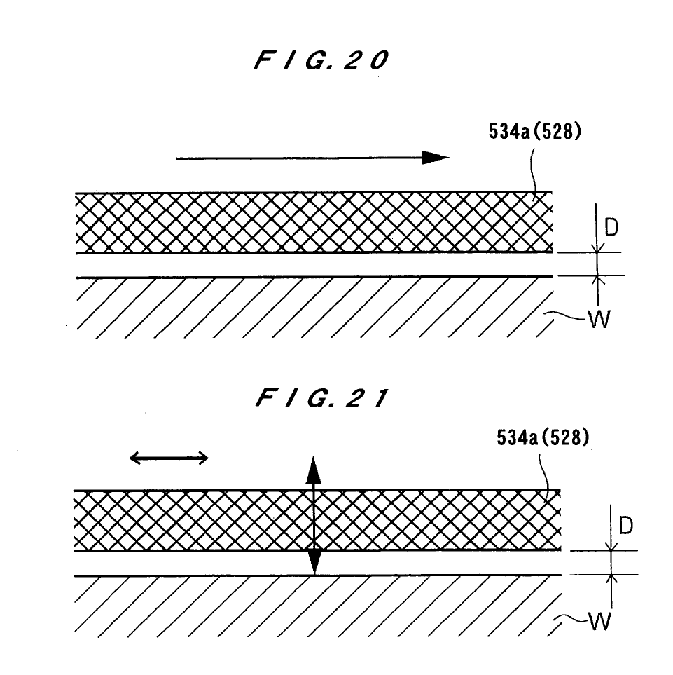

FIG. 20 is a schematic view showing still another embodiment of a driving mechanism for making a relative motion between the lower pad 534a constituting the porous member 528 and the substrate W held by the substrate holder 504 (see FIG. 17). In this embodiment, the lower pad 534a makes a linear motion in one direction along the surface of the substrate W held by the substrate holder 504, whereby the lower pad 534a and the substrate W make a relative motion. In this embodiment, although the substrate W is stationary, the substrate W may make a linear motion, or both of the lower pad 534a and the substrate W may make linear motions in opposite directions.

FIG. 21 is a schematic view showing still another embodiment of a driving mechanism for making a relative motion between the lower pad 534a constituting the porous member 528 and the substrate W held by the substrate holder 504 (see FIG. 17). In this embodiment, the lower pad 534a constituting the porous member 528 is oscillated vertically and/or horizontally, thereby the lower pad 534a and the substrate W make a relative motion. The substrate W may be oscillated vertically and/or horizontally.

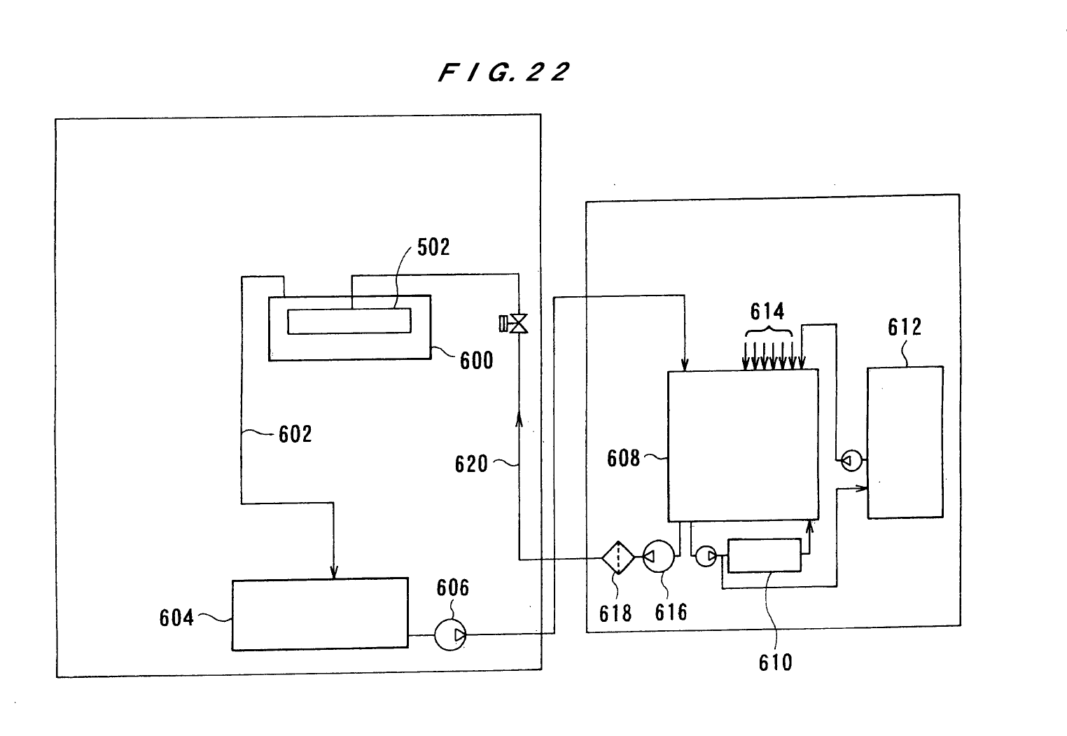

FIG. 22 shows a plating solution management and supply system for supplying a plating solution whose composition, temperature, and the like are controlled to the plating apparatus 118. As shown in FIG. 22, a plating solution tray 600 for allowing the electrode head 502 of the plating apparatus 118 to be immersed for idling is provided, and the plating solution tray 600 is connected to a reservoir 604 through a plating solution discharge pipe 602. The plating solution discharged through the plating solution discharge pipe 602 flows into the reservoir 604.

The plating solution, which has flowed into the reservoir 604, is introduced into the plating solution regulating tank 608 by operating a pump 606. This plating solution regulating tank 608 is provided with a temperature controller 610, and a plating solution analyzing unit 612 for sampling the plating solution and analyzing the sample solution. Further, component replenishing pipes 614 for replenishing the plating solution with components which are found to be insufficient by an analysis performed by the plating solution analyzing unit 612 are connected to the plating solution regulating tank 608. When a pump 616 is operated, the plating solution in the plating solution regulating tank 608 flows in the plating solution supply pipe 620, passes through the filter 618, and is then returned to the plating solution tray 600.

In this manner, the composition and temperature of the plating solution is adjusted to be constant in the plating solution regulating tank 608, and the adjusted plating solution is supplied to the electrode head 502 of the plating apparatus 118. Then, by holding the adjusted plating solution by the electrode head 502, the plating solution having constant composition and temperature at all times can be supplied to the electrode head 502 of the plating apparatus 118.

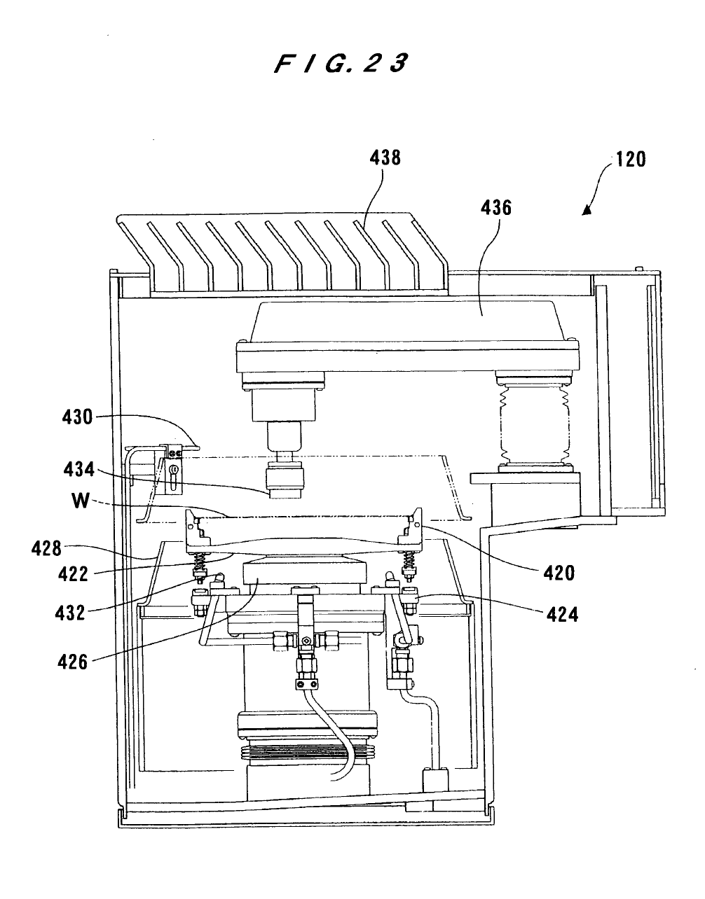

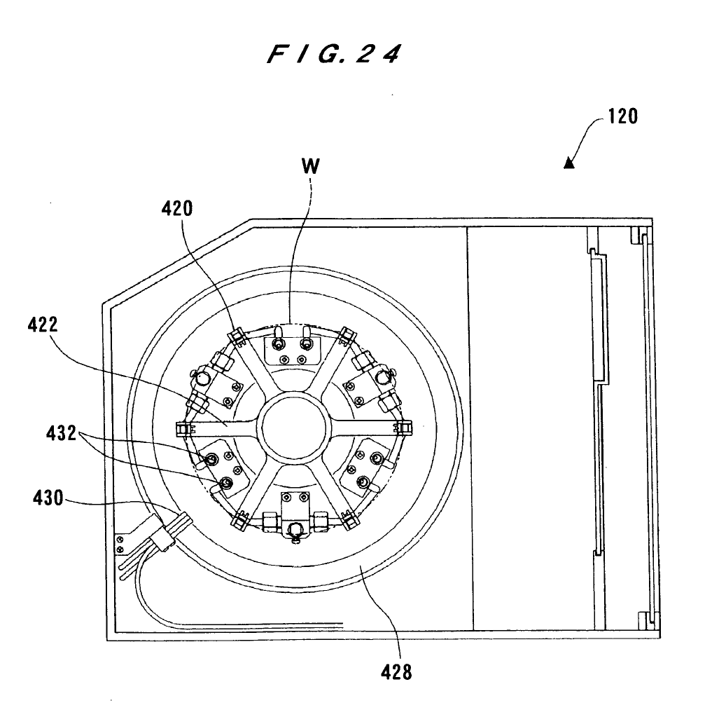

FIGS. 23 and 24 show an example of a cleaning and drying apparatus 120 for cleaning (rinsing) the substrate W and drying the substrate W. Specifically, the cleaning and drying apparatus 120 performs chemical cleaning and pure water cleaning (rinsing) first, and then completely drying the substrate W which has been cleaned by spindle rotation. The cleaning and drying apparatus 120 comprises a substrate holder 422 having a clamp mechanism 420 for clamping an edge portion of the substrate W, and a substrate mounting and removing lifting/lowering plate 424 for opening and closing the clamp mechanism 420.

The substrate holder 422 is coupled to an upper end of a spindle 426 which is rotated at a high speed by energization of a spindle rotating motor (not shown). Further, a cleaning cup 428 for preventing a treatment liquid from being scattered around is disposed around the substrate W held by the clamp mechanism 420, and the cleaning cup 428 is vertically moved by actuation of a cylinder (not shown).

Further, the cleaning and drying apparatus 120 comprises a chemical liquid nozzle 430 for supplying a treatment liquid to the surface of the substrate W held by the clamp mechanism 420, a plurality of pure water nozzles 432 for supplying pure water to the backside surface of the substrate W, and a pencil-type cleaning sponge 434 which is disposed above the substrate W held by the clamp mechanism 420 and is rotatable. The pencil-type cleaning sponge 434 is attached to a free end of a swing arm 436 which is swingable in a horizontal direction. Clean air introduction ports 438 for introducing clean air into the apparatus are provided at the upper part of the cleaning and drying apparatus 120.

With the cleaning and drying apparatus 120 having the above structure, the substrate W is held by the clamp mechanism 420 and is rotated by the clamp mechanism 420, and while the swing arm 436 is swung, a treatment liquid is supplied from the chemical liquid nozzle 430 to the cleaning sponge 434, and the surface of the substrate W is rubbed with the pencil-type cleaning sponge 434, thereby cleaning the surface of the substrate W. Further, pure water is supplied to the backside surface of the substrate W from the pure water nozzles 432, and the backside surface of the substrate W is simultaneously cleaned (rinsed) by the pure water ejected from the pure water nozzles 432. Thus cleaned substrate W is spin-dried by rotating the spindle 426 at a high speed.

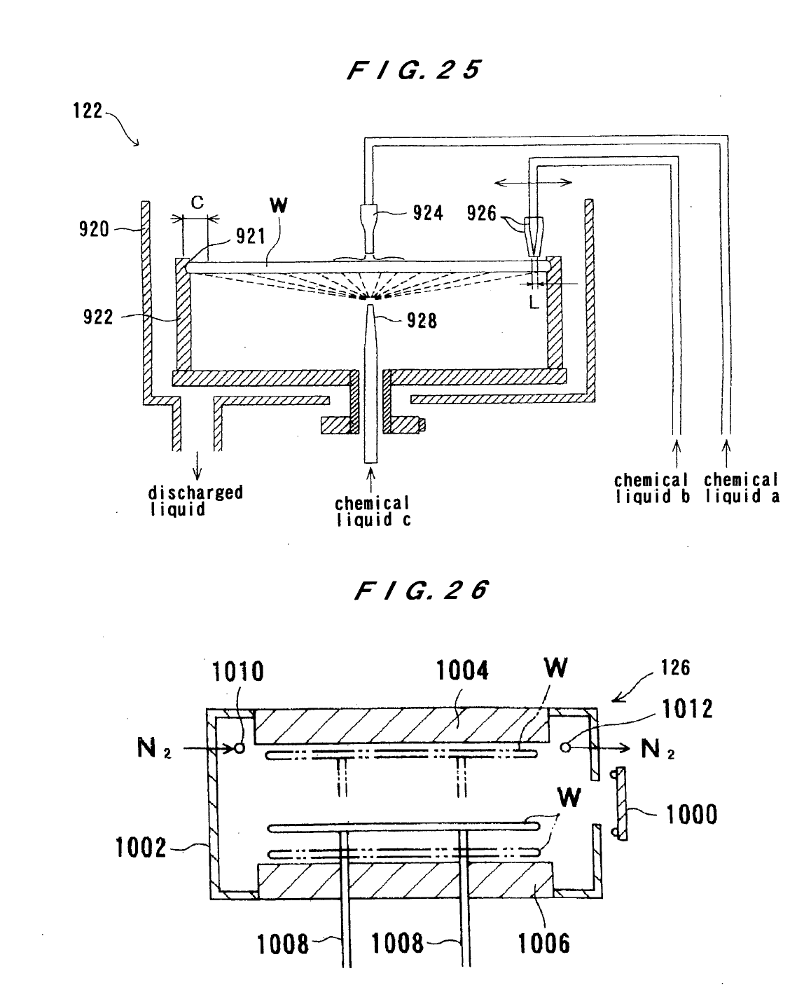

FIG. 25 shows an example of a bevel etching and backside cleaning apparatus 122. The bevel etching and backside cleaning apparatus 122 can perform etching of the copper layer 7 (see FIG. 1B) deposited on an edge (bevel) of the substrate and backside cleaning simultaneously, and can suppress growth of a natural oxide film of copper at the circuit formation portion on the surface of the substrate. The bevel etching and backside cleaning apparatus 122 has a substrate stage 922 positioned inside a bottomed cylindrical waterproof cover 920 and adapted to rotate the substrate W at a high speed, in such a state that the face of the substrate W faces upward, while holding the substrate W horizontally by spin chucks 921 at a plurality of locations along a circumferential direction of a peripheral edge portion of the substrate, a center nozzle 924 placed above a nearly central portion of the face of the substrate W held by the substrate stage 922, and an edge nozzle 926 placed above the peripheral edge portion of the substrate W. The center nozzle 924 and the edge nozzle 926 are directed downward. Aback nozzle 928 is positioned below a nearly central portion of the backside of the substrate W, and directed upward. The edge nozzle 926 is adapted to be movable in a diametrical direction and a height direction of the substrate W.

The width of movement L of the edge nozzle 926 is set such that the edge nozzle 926 can be arbitrarily positioned in a direction toward the center from the outer peripheral end surface of the substrate, and a set value for L is inputted, according to the size, usage, or the like of the substrate W. Normally, an edge cut width C is set in the range of 2 mm to 5 mm. In the case where a rotational speed of the substrate is a certain value or higher at which the amount of liquid migration from the backside to the face is not problematic, the copper layer, and the like within the edge cut width C can be removed.

Next, the method of cleaning with this bevel etching and backside cleaning apparatus 122 will be described. First, the substrate is horizontally rotated integrally with the substrate stage 922, with the substrate being held horizontally by the spin chucks 921 of the substrate stage 922. In this state, an acid solution is supplied from the center nozzle 924 to the central portion of the face of the substrate W. The acid solution may be a non-oxidizing acid, and hydrofluoric acid, hydrochloric acid, sulfuric acid, citric acid, oxalic acid, or the like is used. On the other hand, an oxidizing agent solution is supplied continuously or intermittently from the edge nozzle 926 to the peripheral edge portion of the substrate W. As the oxidizing agent solution, one of an aqueous solution of ozone, an aqueous solution of hydrogen peroxide, an aqueous solution of nitric acid, and an aqueous solution of sodium hypochlorite is used, or a combination of these is used.

In this manner, the copper layer, or the like formed on the upper surface and end surface in the region of the edge cut width C of the substrate W is rapidly oxidized with the oxidizing agent solution, and is simultaneously etched with the acid solution supplied from the center nozzle 924 and spread on the entire face of the substrate, whereby it is dissolved and removed. By mixing the acid solution and the oxidizing agent solution at the peripheral edge portion of the substrate, a steep etching profile can be obtained, in comparison with a mixture of them that is produced in advance being supplied. At this time, the copper etching rate is determined by their concentrations. If a natural oxide film of copper is formed in the circuit-formed portion on the face of the substrate, this natural oxide is immediately removed by the acid solution spreading on the entire face of the substrate according to rotation of the substrate, and does not grow anymore. After the supply of the acid solution from the center nozzle 924 is stopped, the supply of the oxidizing agent solution from the edge nozzle 926 is stopped. As a result, silicon exposed on the surface is oxidized, and deposition of copper can be suppressed.

On the other hand, an oxidizing agent solution and a silicon oxide film etching agent are supplied simultaneously or alternately from the back nozzle 928 to the central portion of the backside of the substrate. Therefore, copper or the like adhering in a metal form to the backside of the substrate W can be oxidized with the oxidizing agent solution, together with silicon of the substrate, and can be etched and removed with the silicon oxide film etching agent. This oxidizing agent solution is preferably the same as the oxidizing agent solution supplied to the face, because the types of chemicals are decreased in number. Hydrofluoric acid can be used as the silicon oxide film etching agent, and if hydrofluoric acid is used as the acid solution on the face of the substrate, the types of chemicals can be decreased in number. Thus, if the supply of the oxidizing agent is stopped first, a hydrophobic surface is obtained. If the etching agent solution is stopped first, a water-saturated surface (a hydrophilic surface) is obtained, and thus the backside surface can be adjusted to a condition that will satisfy the requirements of a subsequent process.

In this manner, the acid solution, i.e., etching solution is supplied to the substrate W to remove metal ions remaining on the surface of the substrate W. Then, pure water is supplied to replace the etching solution with pure water and remove the etching solution, and then the substrate is dried by spin-drying. In this way, removal of the copper layer in the edge cut width C at the peripheral edge portion on the face of the substrate, and removal of copper contaminants on the backside are performed simultaneously to thus allow this treatment to be completed, for example, within 80 seconds. The etching cut width of the edge can be set arbitrarily (from 2 to 5 mm), but the time required for etching does not depend on the cut width.

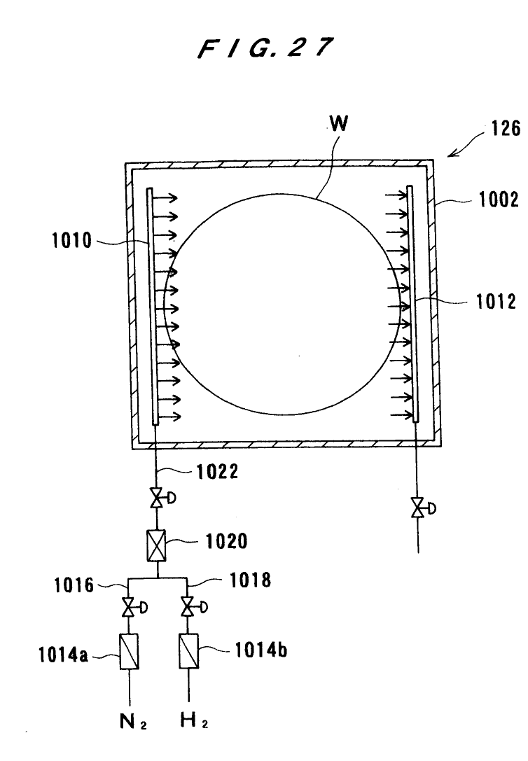

FIGS. 26 and 27 show a heat treatment (annealing) apparatus 126. The annealing apparatus 126 comprises a chamber 1002 having a gate 1000 for taking in and taking out the substrate W, a hot plate 1004 disposed at an upper position in the chamber 1002 for heating the substrate W to e.g. 400° C., and a cool plate 1006 disposed at a lower position in the chamber 1002 for cooling the substrate W by, for example, flowing cooling water inside the plate. The annealing apparatus 126 also has a plurality of vertically movable elevating pins 1008 penetrating the cool plate 1006 and extending upward and downward therethrough for placing and holding the semiconductor substrate W on them. The annealing apparatus further includes a gas introduction pipe 1010 for introducing an antioxidant gas between the substrate W and the hot plate 1004 during annealing, and a gas discharge pipe 1012 for discharging the gas which has been introduced from the gas introduction pipe 1010 and flowed between the substrate W and the hot plate 1004. The pipes 1010 and 1012 are disposed on the opposite sides of the hot plate 1004.

The gas introduction pipe 1010 is connected to a mixed gas introduction line 1022 which in turn is connected to a mixer 1020 where a N₂ gas introduced through a N₂ gas introduction line 1016 containing a filter 1014a, and a H₂ gas introduced through a H₂ gas introduction line 1018 containing a filter 1014b, are mixed to form a mixed gas which flows through the line 1022 into the gas introduction pipe 1010.

In operation, the substrate W, which has been carried in the chamber 1002 through the gate 1000, is held on the elevating pins 1008 and the elevating pins 1008 are raised up to a position at which the distance between the substrate W held on the lifting pins 1008 and the hot plate 1004 becomes about 0.1 to 1.0 mm, for example. In this state, the substrate W is then heated to e.g. 400° C. through the hot plate 1004 and, at the same time, the antioxidant gas is introduced from the gas introduction pipe 1010 and the gas is allowed to flow between the substrate W and the hot plate 1004 while the gas is discharged from the gas discharge pipe 1012, thereby annealing the substrate W while preventing its oxidation. The annealing treatment may be completed in about several tens of seconds to 60 seconds. The heating temperature of the substrate may be selected in the range of 100 to 600° C.

After the completion of the annealing, the elevating pins 1008 are lowered down to a position at which the distance between the substrate W held on the elevating pins 1008 and the cool plate 1006 becomes 0 to 0.5 mm, for example. In this state, by introducing cooling water into the cool plate 1006, the substrate W is cooled by the cool plate to a temperature of 100° C. or lower in about 10 to 60 seconds. The cooled substrate is transferred to the next step.

A mixed gas of N₂ gas with several percentages of H₂ gas is used as the above antioxidant gas. However, N₂ gas may be used singly.

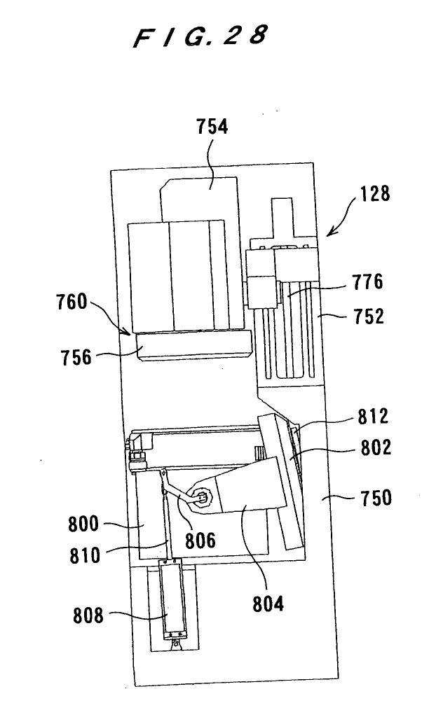

FIGS. 28 through 34 show a pretreatment apparatus 128 for performing a pretreatment of electroless plating of the substrate. The pretreatment apparatus 128 includes a fixed frame 752 that is mounted on the upper part of a frame 750, and a movable frame 754 that moves up and down relative to the fixed frame 752. A processing head 760, which includes a bottomed cylindrical housing portion 756, opening downwardly, and a substrate holder 758, is suspended from and supported by the movable frame 754. In particular, a servomotor 762 for rotating the head is mounted to the movable frame 754, and the housing portion 756 of the processing head 760 is coupled to the lower end of the downward-extending output shaft (hollow shaft) 764 of the servomotor 762.

As shown in FIG. 31, a vertical shaft 768, which rotates together with the output shaft 764 via a spline 766, is inserted in the output shaft 764, and the substrate holder 758 of the processing head 760 is coupled to the lower end of the vertical shaft 768 via a ball joint 770. The substrate holder 758 is positioned within the housing portion 756. The upper end of the vertical shaft 768 is coupled via a bearing 772 and a bracket to a fixed ring-elevating cylinder 774 secured to the movable frame 754. Thus, by the actuation of the cylinder 774, the vertical shaft 768 moves vertically independently of the output shaft 764.

Linear guides 776, which extend vertically and guide vertical movement of the movable frame 754, are mounted to the fixed frame 752, so that by the actuation of a head-elevating cylinder (not shown), the movable frame 754 moves vertically by the guide of the linear guides 776.

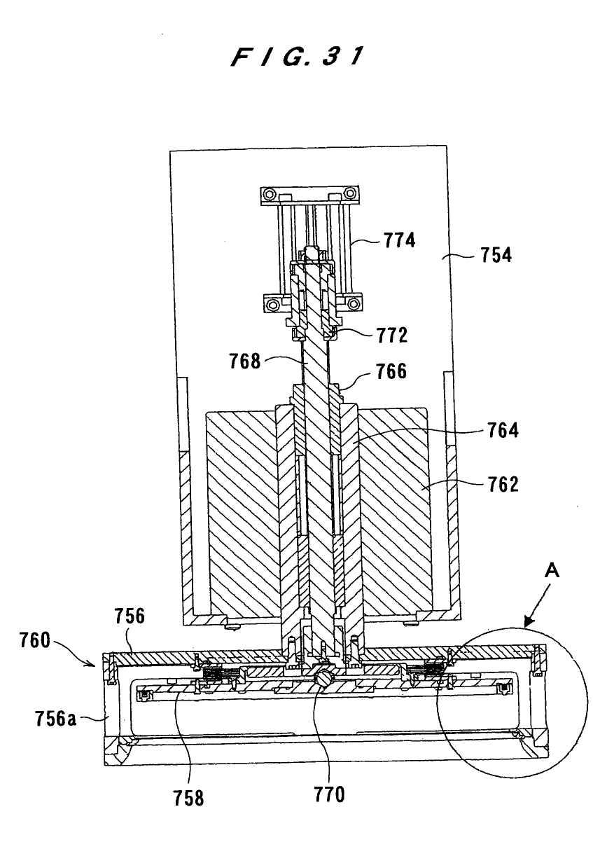

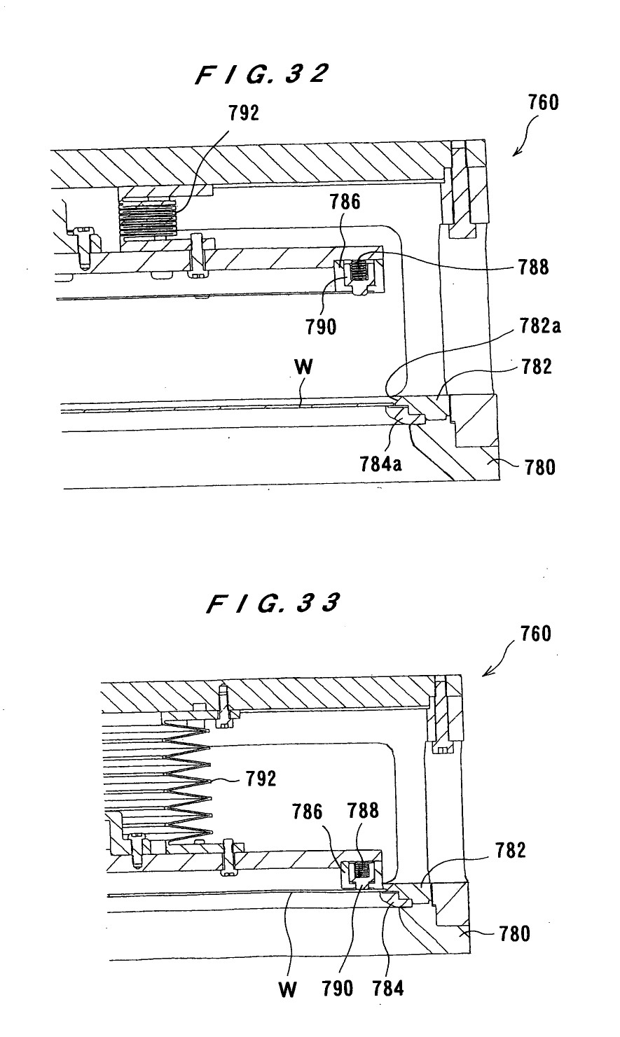

Substrate insertion windows 756a for inserting the substrate W into the housing portion 756 are formed in the circumferential wall of the housing portion 756 of the processing head 760. Further, as shown in FIGS. 32 and 33, a seal ring 784 is provided in the lower portion of the housing portion 756 of the processing head 760, an outer peripheral portion of the seal ring 784a being sandwiched between a main frame 780 made of e.g. PEEK and a guide frame 782 made of e.g. polyethylene. The seal ring 784a is provided to make contact with a peripheral portion of the lower surface of the substrate W to seal the peripheral portion.

On the other hand, a substrate fixing ring 786 is fixed to a peripheral portion of the lower surface of the substrate holder 758. A columnar pusher 790 protrudes downwardly from the lower surface of the substrate fixing ring 786 by the elastic force of a spring 788 disposed within the substrate fixing ring 86 of the substrate holder 758. Further, a flexible cylindrical bellows-like plate 792 made of e.g. Teflon (registered trademark) is disposed between the upper surface of the substrate holder 58 and the upper wall of the housing portion 756 to hermetically seal therein.

When the substrate holder 758 is in a raised position, a substrate W is inserted from the substrate insertion window 56a into the housing portion 756. The substrate W is then guided by a tapered surface 782a provided in the inner circumferential surface of the guide frame 782, and positioned and placed at a predetermined position on the upper surface of the seal ring 784a. In this state, the substrate holder 758 is lowered so as to bring the pushers 790 of the substrate fixing ring 786 into contact with the upper surface of the substrate W. The substrate holder 58 is further lowered so as to press the substrate W downwardly by the elastic forces of the springs 88, thereby forcing the seal ring 84a to make pressure contact with a peripheral portion of the front surface (lower surface) of the substrate W to seal the peripheral portion while nipping the substrate W between the housing portion 756 and the substrate holder 758 to hold the substrate W.

When the head-rotating servomotor 762 is driven while the substrate W is thus held by the substrate holder 758, the output shaft 764 and the vertical shaft 768 inserted in the output shaft 764 rotate together via the spline 766, whereby the substrate holder 758 rotates together with the housing portion 756.

At a position below the processing head 760, there is provided an upward-open treatment tank 800 comprising an outer tank 800a and an inner tank 800b which have a slightly larger inner diameter than the outer diameter of the processing head 760. A pair of leg portions 804, which is mounted to a lid 802, is rotatably supported on the outer circumferential portion of the treatment tank 800. Further, a crank 806 is integrally coupled to each leg portion 806, and the free end of the crank 806 is rotatably coupled to the rod 810 of a lid-moving cylinder 808. Thus, by the actuation of the lid-moving cylinder 808, the lid 802 moves between a treatment position at which the lid 802 covers the top opening of the inner tank 800b of the treatment tank 800 and a retreat position beside the treatment tank 800. In the surface (upper surface) of the lid 802, there is provided a nozzle plate 812 having a large number of jet nozzles 812a for jetting outwardly (upwardly), electrolytic ionic water having reducing power, for example.

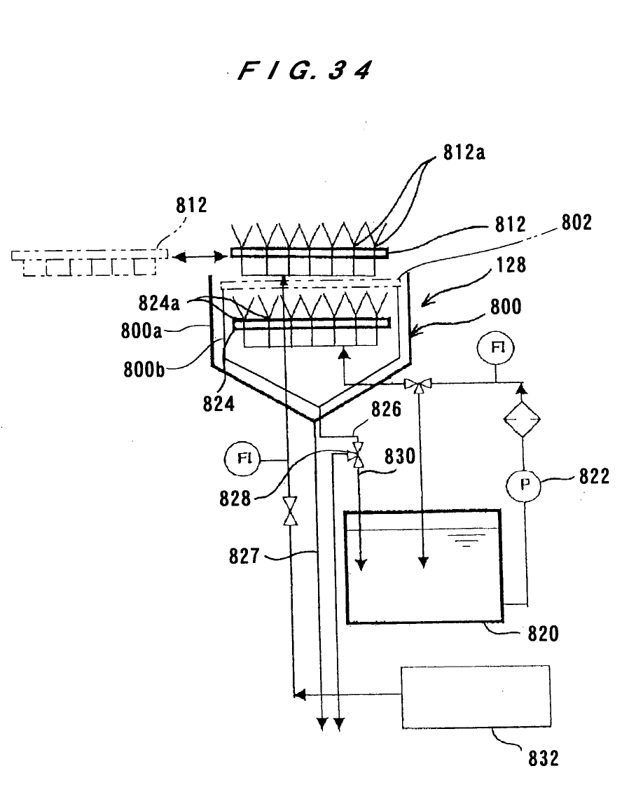

Further, as shown in FIG. 34, a nozzle plate 824 having a plurality of jet nozzles 824a for jetting upwardly a chemical liquid supplied from a chemical liquid tank 820 by driving the chemical liquid pump 822 is provided in the inner tank 800b of the treatment tank 800 in such a manner that the jet nozzles 824a are equally distributed over the entire surface of the cross section of the inner tank 800b. A drainpipe 826 for draining a chemical liquid (waste liquid) to the outside is connected to the bottom of the inner tank 800b. A three-way valve 828 is provided in the drainpipe 826, and the chemical liquid (waste liquid) is returned to the chemical liquid tank 820 through a return pipe 830 connected to one of ports of the three-way valve 828 to recycle the chemical liquid, as needed. Further, in this embodiment, the nozzle plate 812 provided on the surface (upper surface) of the lid 802 is connected to a rinsing liquid supply source 8132 for supplying a rinsing liquid such as pure water. Further, a drainpipe 827 is connected to the bottom of the outer tank 800a.

By lowering the processing head 760 holding the substrate so as to cover or close the top opening of the inner tank 800b of the treatment tank 800 with the processing head 760 and then jetting a chemical liquid from the jet nozzles 824a of the nozzle plate 824 disposed in the treatment tank 800 toward the substrate W, the chemical liquid can be jetted uniformly onto the entire lower surface (processing surface) of the substrate W and the chemical liquid can be discharged out from the discharge pipe 826 while preventing scattering of the chemical liquid to the outside. Further, by raising the processing head 760 and closing the top opening of the inner tank 800b of the treatment tank 800 with the lid 802, and then jetting a rinsing liquid from the jet nozzles 812a of the nozzle plate 812 disposed in the upper surface of the lid 802 toward the substrate W held in the processing head 760, the rinsing treatment (cleaning treatment) is carried out to remove the chemical liquid from the surface of the substrate. Because the rinsing liquid passes through the clearance between the outer tank 800a and the inner tank 800b and is discharged through the drainpipe 827, the rinsing liquid is prevented from flowing into the inner tank 800b and from being mixed with the chemical liquid.

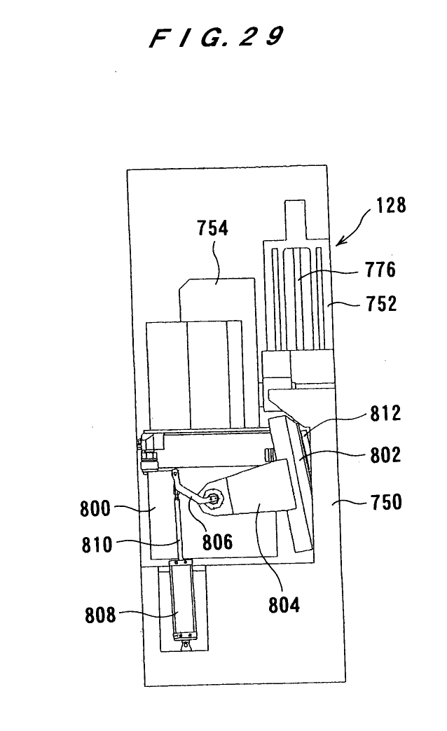

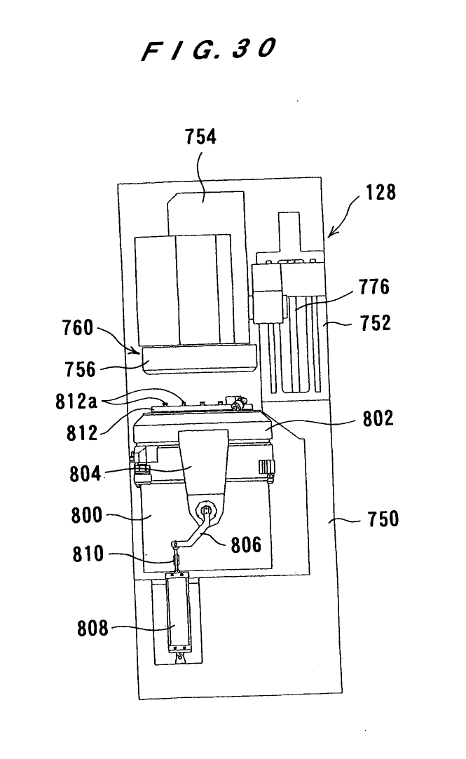

According to the pretreatment apparatus 128, the substrate W is inserted into the processing head 760 and held therein when the processing head 760 is in the raised position, as shown in FIG. 28. Thereafter, as shown in FIG. 29, the processing head 760 is lowered to the position at which it covers the top opening of the inner tank 800b of the treatment tank 800. While rotating the processing head 760 and thereby rotating the substrate W held in the processing head 760, a chemical liquid is jetted from the jet nozzles 824a of the nozzle plate 824 disposed in the inner tank 800b of the treatment tank 800 toward the substrate W, thereby jetting the chemical liquid uniformly onto the entire surface of the substrate W. The processing head 760 is raised and stopped at a predetermined position and, as shown in FIG. 30, the lid 802 in the retreat position is moved to the position at which it covers the top opening of the inner tank 800b of the treatment tank 800. A rinsing liquid is then jetted from the jet nozzles 812a of the nozzle plate 812 disposed in the upper surface of the lid 802 toward the rotating substrate W held in the processing head 760. The chemical treatment by the chemical liquid and the rinsing treatment by the rinsing liquid of the substrate W can thus be carried out successively while avoiding mixing of the two liquids.

The lowermost position of the processing head 760 may be adjusted to adjust the distance between the substrate W held in the processing head 760 and the nozzle plate 824, whereby the region of the substrate W onto which the chemical liquid is jetted from the jet nozzles 824a of the nozzle plate 824 and the jetting pressure can be adjusted as desired. Here, when the pretreatment liquid such as a chemical liquid is circulated and reused, active components are reduced by progress of the treatment, and the pretreatment liquid (chemical liquid) is taken out due to attachment of the treatment liquid to the substrate. Therefore, it is desirable to provide a pretreatment liquid management unit (not shown) for analyzing composition of the pretreatment liquid and adding insufficient components. Specifically, a chemical liquid used for cleaning is mainly composed of acid or alkali. Therefore, for example, a pH of the chemical liquid is measured, a decreased content is replenished from the difference between a preset value and the measured pH, and a decreased amount is replenished using a liquid level meter provided in the chemical storage tank. Further, with respect to a catalytic liquid, for example, in the case of acid palladium solution, the amount of acid is measured by its pH, and the amount of palladium is measured by a titration method or nephelometry, and a decreased amount can be replenished in the same manner as the above.

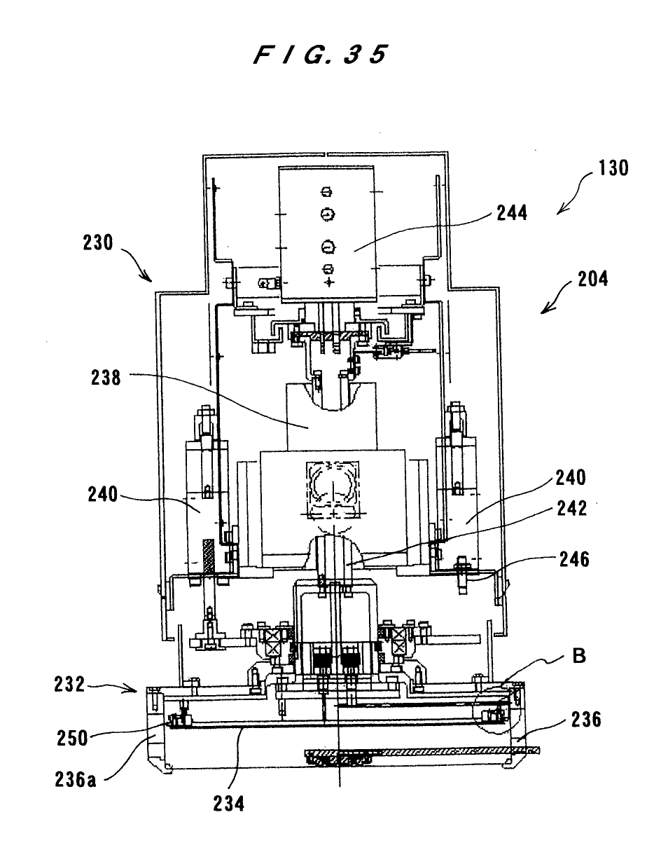

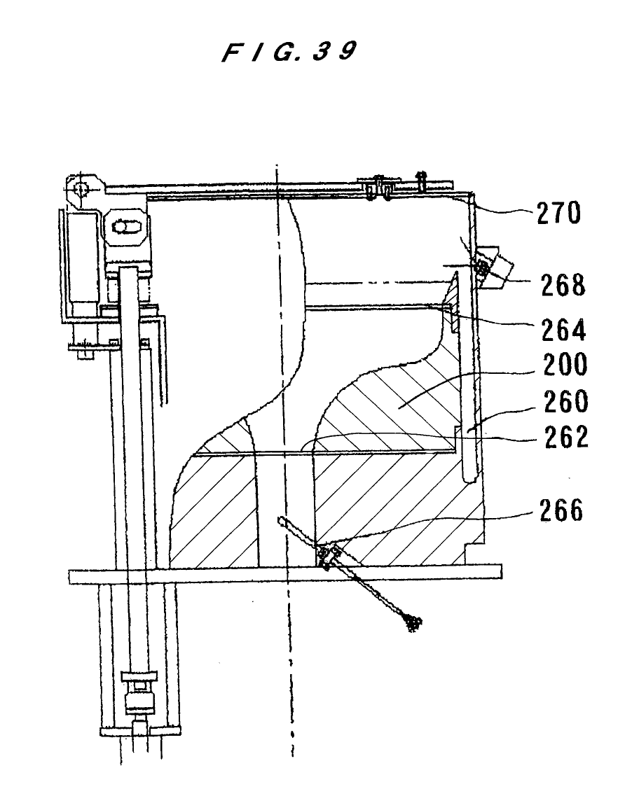

FIGS. 35 through 41 show an electroless plating apparatus 130. This electroless plating apparatus 130 which is provided to form the protective film 9 shown in FIG. 1D, for example, includes a plating tank 200 (see FIGS. 39 and 41) and a substrate head 204, disposed above the plating tank 200, for detachably holding a substrate W.

As shown in detail in FIG. 35, the processing head 204 has a housing portion 230 and a head portion 232. The head portion 232 mainly comprises a suction head 234 and a substrate receiver 236 for surrounding the suction head 234. The housing portion 230 accommodates therein a substrate rotating motor 238 and substrate receiver drive cylinders 240. The substrate rotating motor 238 has an output shaft (hollow shaft) 242 having an upper end coupled to a rotary joint 244 and a lower end coupled to the suction head 234 of the head portion 232. The substrate receiver drive cylinders 240 have respective rods coupled to the substrate receiver 236 of the head portion 232. Stoppers 246 are provided in the housing portion 230 for mechanically limiting upward movement of the substrate receiver 236.

The suction head 234 and the substrate receiver 236 are operatively connected to each other by a splined structure such that when the substrate receiver drive cylinders 240 are actuated, the substrate receiver 236 vertically moves relative to the suction head 234, and when the substrate rotating motor 238 is energized, the output shaft 242 thereof is rotated to rotate the suction head 234 and the substrate receiver 236 in unison with each other.

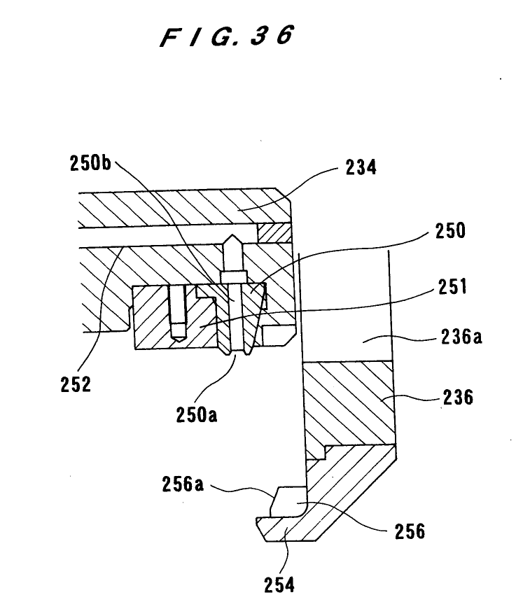

As shown in detail in FIGS. 36 through 38, a suction ring 250 for attracting and holding a substrate W against its lower surface to be sealed is mounted on a lower circumferential edge of the suction head 234 by a presser ring 251. The suction ring 250 has a recess 250a continuously defined in a lower surface thereof in a circumferential direction and in communication with a vacuum line 252 extending through the suction head 234 by a communication hole 250b that is defined in the suction ring 250. When the recess 250a is evacuated, the substrate W is attracted to and held by the suction ring 250. Because the substrate W is attracted under vacuum to the suction ring 250 along a radially narrow circumferential area provided by the recess 250a, any adverse effects such as flexing caused by the vacuum on the substrate W are minimized. When the suction ring 250 is dipped in the plating solution (treatment liquid), not only the surface (lower surface) of the substrate W, but also its circumferential edge, can be dipped in the plating solution. The substrate W is released from the suction ring 250 by introducing N₂ into the vacuum line 252.

The substrate receiver 236 is in the form of a downwardly open, hollow bottomed cylinder having substrate insertion windows 236a defined in a circumferential wall thereof for inserting therethrough the substrate W into the substrate receiver 236. The substrate receiver 236 also has an annular ledge 254 projecting inwardly from its lower end, and an annular protrusion 256 disposed on an upper surface of the annular ledge 254 and having a tapered inner circumferential surface 256a for guiding the substrate W.

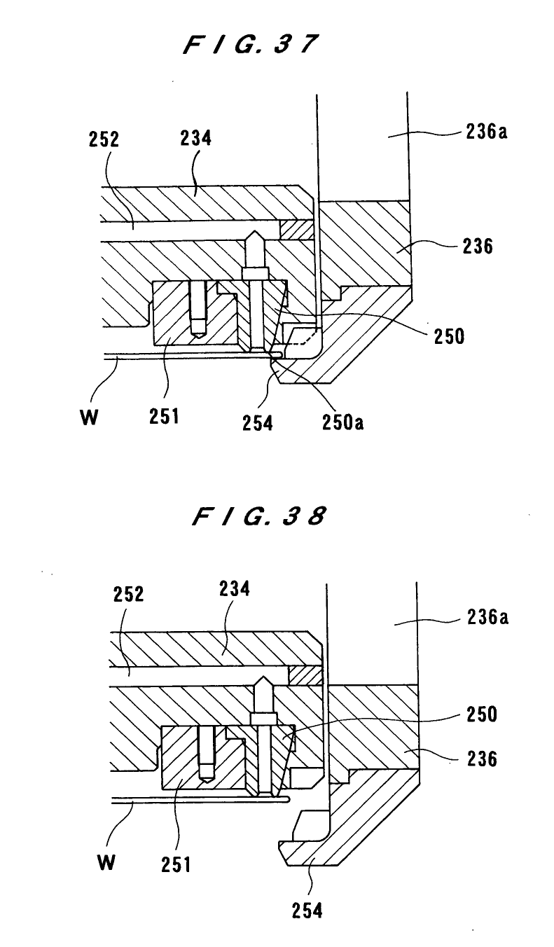

As shown in FIG. 36, when the substrate receiver 236 is lowered, the substrate W is inserted through the substrate insertion window 236a into the substrate receiver 236. The substrate W thus inserted is guided by the tapered surface 256a of the protrusion 256 and positioned thereby onto the upper surface of the ledge 254 in a predetermined position thereon. The substrate receiver 236 is then elevated until it brings the upper surface of the substrate W placed on the ledge 254 into abutment against the suction ring 250 of the suction head 234, as shown in FIG. 37. Then, the recess 250a in the vacuum ring 250 is evacuated through the vacuum line 252 to attract the substrate W while sealing the upper peripheral edge surface of the substrate W against the lower surface of the suction ring 250. In order to plate the substrate W, as shown in FIG. 38, the substrate receiver 236 is lowered several mm to space the substrate W from the ledge 254, keeping the substrate W attracted only by the suction ring 250. The substrate W now has its lower peripheral edge surface prevented from not being plated because it is held out of contact with the ledge 254.

FIG. 39 shows the details of the plating tank 200. The plating tank 200 is connected at the bottom to a plating solution supply pipe 308 (see FIG. 41), and is provided in the peripheral wall with a plating solution recovery groove 260. In the plating tank 200, there are disposed two current plates 262, 264 for stabilizing the flow of a plating solution flowing upward. A thermometer 266 for measuring the temperature of the plating solution introduced into the plating tank 200 is disposed at the bottom of the plating tank 200. Further, on the outer surface of the peripheral wall of the plating tank 200 and at a position slightly higher than the liquid level of the plating solution held in the plating tank 200, there is provided a jet nozzle 268 for jetting a stop liquid which is a neutral liquid having a pH of 6 to 7.5, for example, pure water, inwardly and slightly upwardly in the normal direction. After plating, the substrate W held in the head portion 232 is raised and stopped at a position slightly above the surface of the plating solution. In this state, pure water (stop liquid) is immediately jetted from the jet nozzle 268 toward the substrate W to cool the substrate W, thereby preventing progress of plating by the plating solution remaining on the substrate W.

Further, at the top opening of the plating tank 200, there is provided a plating tank cover 270 which closes the top opening of the plating tank 200 in a non-plating time, such as idling time, so as to prevent unnecessary evaporation of the plating solution from the plating tank 200.

As shown in FIG. 41, a plating solution supply pipe 308 extending from a plating solution storage tank 302 and having a plating solution supply pump 304 and a three-way valve 306 is connected to the plating tank 200 at the bottom of the plating tank 200. With this arrangement, during a plating process, a plating solution is supplied into the plating tank 200 from the bottom of the plating tank 200, and the overflowing plating solution is recovered by the plating solution storage tank 302 through the plating solution recovery groove 260. Thus, the plating solution can be circulated. A plating solution return pipe 312 for returning the plating solution to the plating solution storage tank 302 is connected to one of the ports of the three-way valve 306. Thus, the plating solution can be circulated even in a standby condition of plating, and a plating solution circulating system is constructed. As described above, the plating solution in the plating solution storage tank 302 is always circulated through the plating solution circulating system, and hence a lowering rate of the concentration of the plating solution can be reduced and the number of the substrates W which can be processed can be increased, compared with the case in which the plating solution is simply stored.

Particularly, in this embodiment, by controlling the plating solution supply pump 304, the flow rate of the plating solution which is circulated at a standby of plating or at a plating process can be set individually. Specifically, the amount of circulating plating solution at the standby of plating is in the range of 2 to 20 litter/minute, for example, and the amount of circulating plating solution at the plating process is in the range of 0 to 10 litter/minute, for example. With this arrangement, a large amount of circulating plating solution at the standby of plating can be ensured to keep a temperature of the plating bath in the cell constant, and the flow rate of the circulating plating solution is made smaller at the plating process to form a protective film (plated film) having a more uniform thickness.

The thermometer 266 provided in the vicinity of the bottom of the plating tank 200 measures a temperature of the plating solution introduced into the plating tank 200, and controls a heater 316 and a flow meter 318 described below.

Specifically, in this embodiment, there are provided a heating device 322 for heating the plating solution indirectly by a heat exchanger 320 which is provided in the plating solution in the plating solution storage tank 302 and uses water as a heating medium which has been heated by a separate heater 316 and has passed through the flow meter 318, and a stirring pump 324 for mixing the plating solution by circulating the plating solution in the plating solution storage tank 302. This is because in the plating, in some cases, the plating solution is used at a high temperature (about 80° C.), and the structure should cope with such cases. This method can prevent very delicate plating solution from being mixed with foreign matter or the like unlike an in-line heating method.

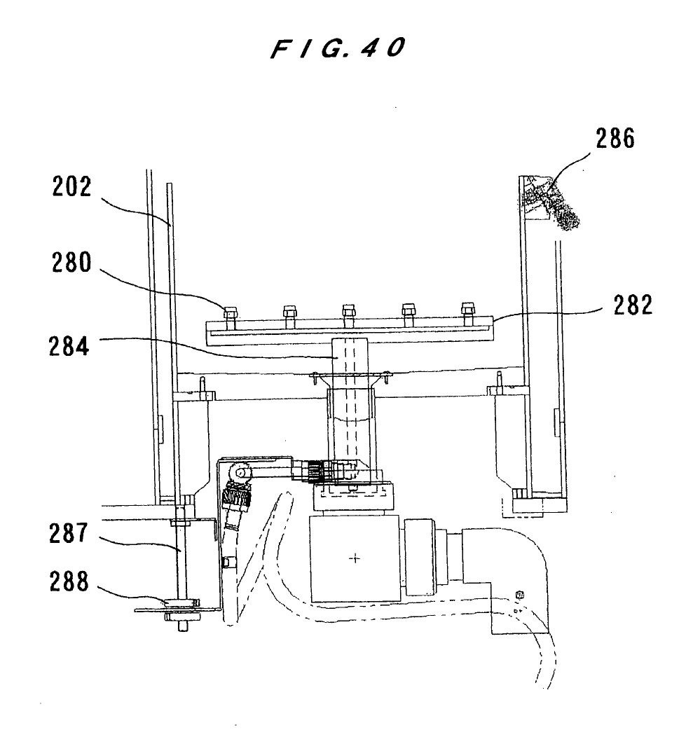

FIG. 40 shows the details of a cleaning tank 202 provided beside the plating tank 200. At the bottom of the cleaning tank 202, there is provided a nozzle plate 282 having a plurality of jet nozzles 280, attached thereto, for upwardly jetting a rinsing liquid such as pure water. The nozzle plate 282 is coupled to an upper end of a nozzle lifting shaft 284. The nozzle lifting shaft 284 can be moved vertically by changing the position of engagement between a nozzle position adjustment screw 287 and a nut 288 engaging the screw 287 so as to optimize the distance between the jet nozzles 280 and a substrate W located above the jet nozzles 280.

Further, on the outer surface of the peripheral wall of the cleaning tank 202 and at a position above the jet nozzles 280, there is provided a head cleaning nozzle 286 for jetting a cleaning liquid, such as pure water, inwardly and slightly downwardly onto at least a portion, which was in contact with the plating solution, of the head portion 232 of the substrate head 204.

In operating the cleaning tank 202, the substrate W held in the head portion 232 of the substrate head 204 is located at a predetermined position in the cleaning tank 202. A cleaning liquid (rinsing liquid), such as pure water, is jetted from the jet nozzles 280 to clean (rinse) the substrate W, and at the same time, a cleaning liquid such as pure water is jetted from the head cleaning nozzle 286 to clean at least a portion, which was in contact with the plating solution, of the head portion 232 of the substrate head 204, thereby preventing a deposit from accumulating on that portion which was immersed in the plating solution.

According to this electroless plating apparatus 130, when the substrate head 204 is in a raised position, the substrate W is held by vacuum attraction in the head portion 232 of the substrate head 204 as described above, while the plating solution in the plating tank 200 is allowed to circulate.

When plating is performed, the plating tank cover 270 is opened, and the substrate head 204 is lowered, while the substrate head 204 is rotating, so that the substrate W held in the head portion 232 is immersed in the plating solution in the plating tank 200.

After immersing the substrate W in the plating solution for a predetermined time, the substrate head 204 is raised to lift the substrate W from the plating solution in the plating tank 200 and, as needed, pure water (stop liquid) is immediately jetted from the jet nozzle 268 toward the substrate W to cool the substrate W, as described above. The substrate head 204 is further raised to lift the substrate W to a position above the plating tank 200, and the rotation of the substrate head 204 is stopped.

Next, while the substrate W is held by vacuum attraction in the head portion 232 of the substrate head 204, the substrate head 204 is moved to a position right above the cleaning tank 202. While rotating the substrate head 204, the substrate head 204 is lowered to a predetermined position in the cleaning tank 202. A cleaning liquid (rinsing liquid), such as pure water, is jetted from the jet nozzles 280 to clean (rinse) the substrate W, and at the same time, a cleaning liquid such as pure water is jetted from the head cleaning nozzle 286 to clean at least a portion, which was in contact with the plating solution, of the head portion 232 of the substrate head 204.

After completion of cleaning of the substrate W, the rotation of the substrate head 204 is stopped, and the substrate head 204 is raised to lift the substrate W to a position above the cleaning tank 202. Further, the substrate head 204 is moved to the transfer position between the transfer robot 116 (see FIG. 6) and the substrate head 204, and the substrate W is transferred to the transfer robot 116, and is transported to a next process by the transfer robot 116.

As shown in FIG. 41, the electroless plating apparatus 130 is provided with a plating solution management unit 330 for measuring an amount of the plating solution held by the electroless plating apparatus 130 and for analyzing composition of the plating solution by an absorptiometric method, a titration method, an electrochemical measurement, or the like, and replenishing components which are insufficient in the plating solution. In the plating solution management unit 330, signals indicative of the analysis results are processed to replenish insufficient components from a replenishment tank (not shown) to the plating solution storage tank 302 using a metering pump, thereby controlling the amount of the plating solution and composition of the plating solution. Thus, thin film plating can be realized in a good reproducibility.

The plating solution management unit 330 has a dissolved oxygen densitometer 332 for measuring dissolved oxygen in the plating solution held by the electroless plating apparatus 130 by an electrochemical method, for example. According to the plating solution management unit 330, dissolved oxygen concentration in the plating solution can be controlled at a constant value on the basis of indication of the dissolved oxygen densitometer 332 by deaeration, nitrogen blowing, or other methods. In this manner, the dissolved oxygen concentration in the plating solution can be controlled at a constant value, and the plating reaction can be achieved in a good reproducibility.

When the plating solution is used repeatedly, certain components are accumulated by being carried in from the outside or decomposition of the plating solution, resulting in lowering of reproducibility of plating and deteriorating of film quality. By adding a mechanism for removing such specific components selectively, the life of the plating solution can be prolonged and the reproducibility can be improved.

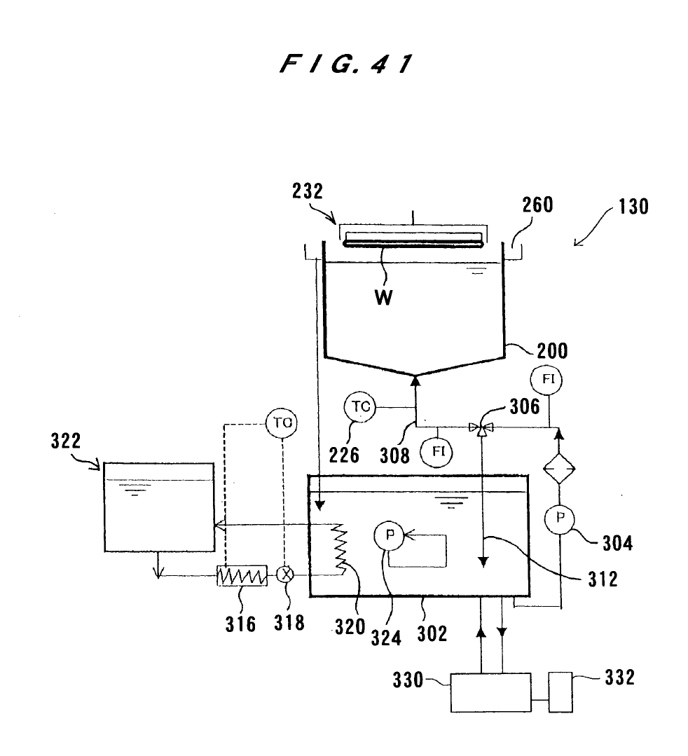

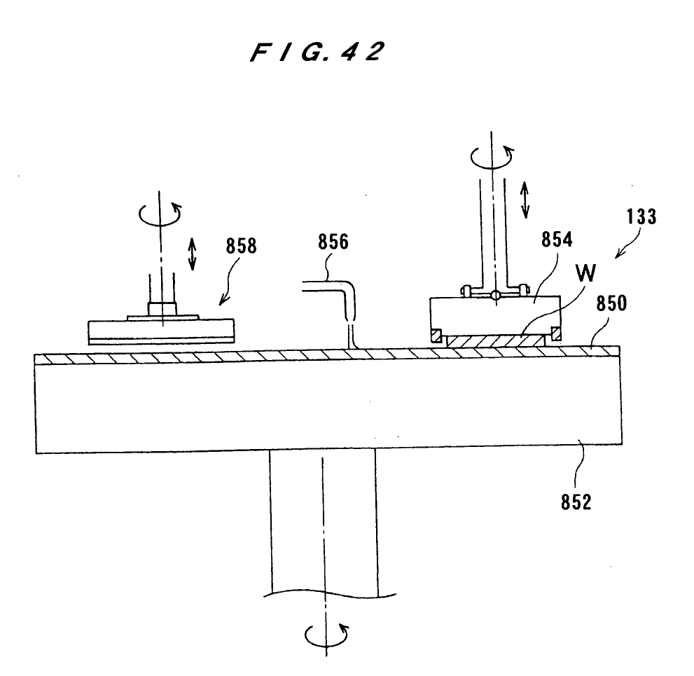

FIG. 42 shows an example of a polishing apparatus (CMP apparatus) 133. The polishing apparatus 133 comprises a polishing table 852 having a polishing surface composed of a polishing cloth (polishing pad) 850 which is attached to the upper surface of the polishing table 852, and a top ring 854 for holding a substrate W with its to-be-polished surface facing the polishing table 852. In the polishing apparatus 133, the surface of the substrate W is polished by rotating the polishing table 852 and the top ring 854 about their own axes, respectively, and supplying a polishing liquid from a polishing liquid nozzle 856 provided above the polishing table 852 while pressing the substrate W against the polishing cloth 850 of the polishing table 852 at a given pressure by the top ring 854. It is possible to use a fixed abrasive type of pad containing fixed abrasive particles as the polishing pad.

The polishing power of the polishing surface of the polishing cloth 850 decreases with a continuation of a polishing operation of the CMP apparatus 133. In order to restore the polishing power, a dresser 858 is provided to conduct dressing of the polishing cloth 850, for example, at the time of replacing the substrate W. In the dressing, while rotating the dresser 858 and the polishing table 852 respectively, the dressing surface (dressing member) of the dresser 858 is pressed against the polishing cloth 850 of the polishing table 852, thereby removing the polishing liquid and chips adhering to the polishing surface and, at the same time, flattening and dressing the polishing surface, whereby the polishing surface is regenerated. The polishing table 852 may be provided with a monitor for monitoring the surface state of the substrate to detect in situ the end point of polishing, or with a monitor for inspecting in situ the finish state of the substrate.

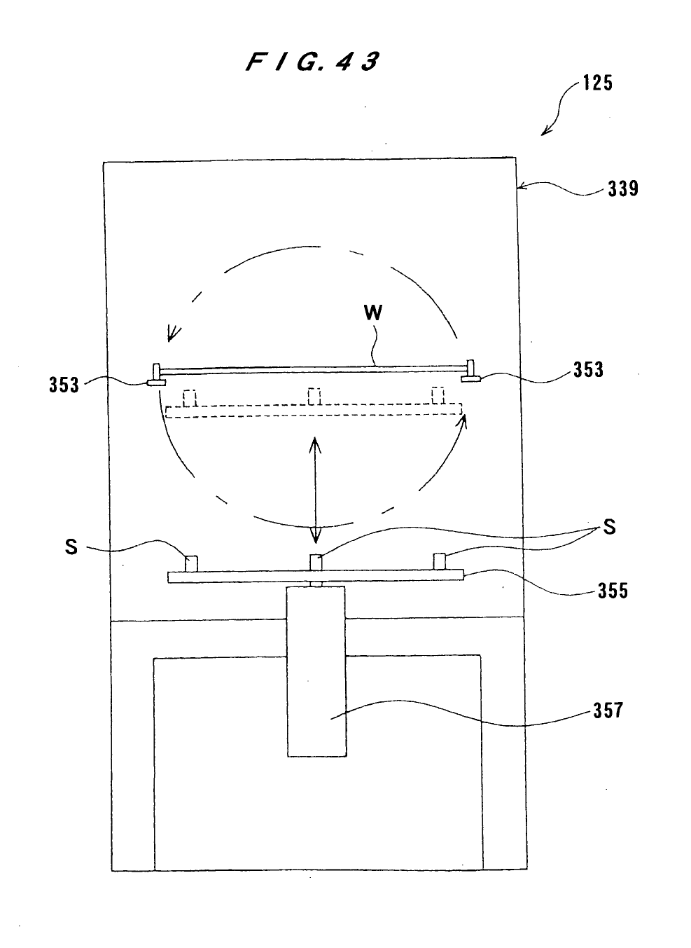

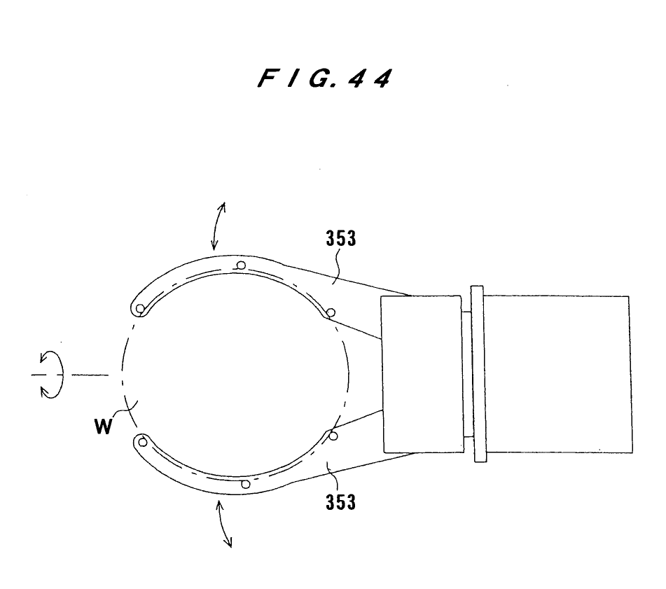

FIGS. 43 and 44 show the film thickness measuring instrument 125 provided with a reversing machine. As shown in the FIGS. 43 and 44, the film thickness measuring instrument 125 is provided with a reversing machine 339. The reversing machine 339 includes reversing arms 353, 353. The reversing arms 353, 353 put a substrate W therebetween and hold its outer periphery from right and left sides, and rotate the substrate W through 1800, thereby turning the substrate over. A circular mounting base 355 is disposed immediately below the reversing arms 353, 353 (reversing stage), and a plurality of film thickness sensors S are provided on the mounting base 355. The mounting base 355 is adapted to be movable upward and downward by a drive mechanism 357.

During reversing of the substrate W, the mounting base 355 waits at a position, indicated by solid lines, below the substrate W. Before or after reversing, the mounting base 355 is raised to a position indicated by dotted lines to bring the film thickness sensors S close to the substrate W gripped by the reversing arms 353, 353, thereby measuring the film thickness.

According to this embodiment, since there is no restriction such as the arms of the transfer robot, the film thickness sensors S can be installed at arbitrary positions on the mounting base 355. Further, the mounting base 355 is adapted to be movable upward and downward, so that the distance between the substrate W and the sensors S can be adjusted at the time of measurement. It is also possible to mount plural types of sensors suitable for the purpose of detection, and change the distance between the substrate W and the sensors each time measurements are made by the respective sensors. However, the mounting base 355 moves upward and downward, thus requiring certain measuring time.

An eddy current sensor, for example, may be used as the film thickness sensor S. The eddy current sensor measures a film thickness by generating an eddy current and detecting the frequency or loss of the current that has returned through the substrate W, and is used in a non-contact manner. An optical sensor may also be suitable for the film thickness sensor S. The optical sensor irradiates a light onto a sample, and measures a film thickness directly based on information of the reflected light. The optical sensor can measure a film thickness not only for a metal film but also for an insulating film such as an oxide film. Places for setting the film thickness sensor S are not limited to those shown in the drawings, but the sensor may be set at any desired places for measurement in any desired numbers.

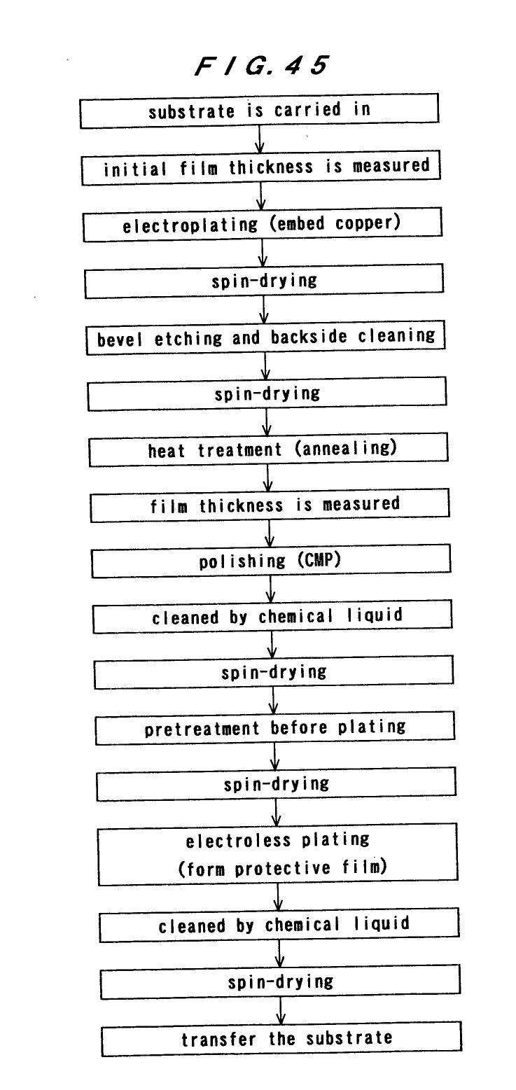

Next, a sequence of processing for forming copper interconnects on the substrate having the seed layer 6 shown in FIG. 1A, which is carried out by the substrate processing apparatus having the above structure, will be described with reference to FIG. 45.

First, the substrate W having the seed layer 6 formed in its surface is taken out one by one from a transfer box 111, and is carried in the loading/unloading station 115. The substrate W, which has carried in the loading/unloading station 115, is transferred to the thickness measuring instrument 125 by the transfer robot 116, and an initial film thickness (film thickness of the seed layer 6) is measured by the thickness measuring instrument 125. Thereafter, if necessary, the substrate is inverted and transferred to the plating apparatus 118. In the plating apparatus 118, as shown in FIG. 1B, the copper layer 7 is deposited on the surface of the substrate W to embed copper.

Then, the substrate W having the copper layer 7 formed thereon is transferred to the cleaning and drying apparatus 120 by the transfer robot 116, and the substrate W is cleaned by pure water and spin-dried. Alternatively, in a case where a spin-drying function is provided in the plating apparatus 118, the substrate W is spin-dried (removal of liquid) in the plating apparatus 118, and then the dried substrate is transferred to the bevel etching and backside cleaning apparatus 122.

In the bevel etching and backside cleaning apparatus 122, unnecessary copper attached to the bevel (edge) of the substrate W is removed by etching, and at the same time, the backside surface of the substrate is cleaned by pure water or the like. Thereafter, as described above, the substrate W is transferred to the cleaning and drying apparatus 120 by the transfer robot 116, and the substrate W is cleaned by pure water and spin-dried. Alternatively, in a case where a spin-drying function is provided in the bevel etching and backside cleaning apparatus 122, the substrate W is spin-dried in the bevel etching and backside cleaning apparatus 122, and then the dried substrate is transferred to the heat treatment apparatus 126 by the transfer robot 116.

In the heat treatment apparatus 126, heat treatment (annealing) of the substrate W is carried out. Then, the substrate W after the heat treatment is transferred to the film thickness measuring instrument 125 by the transfer robot 116, and the film thickness of copper is measured by the film thickness measuring instrument 125. The film thickness of the copper layer 7 (see FIG. 1B) is obtained from the difference between this measured result and the measured result of the above initial film thickness. Then, for example, plating time of a subsequent substrate is adjusted according to the measured film thickness. If the film thickness of the copper layer 7 is insufficient, then additional formation of copper layer is performed by plating again. Then, the substrate W after the film thickness measurement is transferred to the polishing apparatus 133 by the transfer robot 116.

As shown in FIG. 1C, unnecessary copper layer 7, the seed layer 6 and the barrier layer 5 deposited on the surface of the substrate W are polished and removed by the polishing apparatus 133 to flatten the surface of the substrate W. At this time, for example, the film thickness and the finishing state of the substrate are inspected by a monitor, and when an end point is detected by the monitor, polishing is finished. Then, the substrate W, which has been polished, is transferred to the cleaning and drying apparatus 120 by the transfer robot 116, and the surface of the substrate is cleaned by a chemical liquid and then cleaned (rinsed) with pure water, and then spin-dried by rotating the substrate at a high speed in the cleaning and drying apparatus 120. After this spin-drying, the substrate W is transferred to the pretreatment apparatus 128 by the transfer robot 116.

In the pretreatment apparatus 128, a pretreatment before plating comprising at least one of attachment of Pd catalyst to the surface of the substrate and removal of oxide film attached to the exposed surface of the substrate, for example, is carried out. Then, the substrate after this pretreatment, as described above, is transferred to the cleaning and drying apparatus 120 by the transfer robot 116, and the substrate W is cleaned by pure water and spin-dried. Alternatively, in a case where a spin-drying function is provided in the pretreatment apparatus 128, the substrate W is spin-dried (removal of liquid) in the pretreatment apparatus 128, and then the dried substrate is transferred to the electroless plating apparatus 130 by the transfer robot 116.

In the electroless plating apparatus 130, as shown in FIG. 1D, for example, electroless CoWP plating is applied to the surfaces of the exposed interconnects 8 to form a protective film (plated film) 9 composed of CoWP alloy selectively on the exposed surfaces of the interconnects 8, thereby protecting the interconnects 8. The thickness of the protective film 9 is in the range of 0.1 to 500 nm, preferably in the range of 1 to 200 nm, more preferably in the range of 10 to 100 nm. At this time, for example, the thickness of the protective film 9 is monitored, and when the film thickness reaches a predetermined value, i.e., an end point is detected, the electroless plating is finished.

After the electroless plating, the substrate W is transferred to the cleaning and drying apparatus 120 by the transfer robot 116, and the surface of the substrate is cleaned by a chemical liquid, and cleaned (rinsed) with pure water, and then spin-dried by rotating the substrate at a high speed in the cleaning and drying apparatus 120. After the spin-drying, the substrate W is returned into the transfer box 111 via the loading/unloading station 115 by the transfer robot 116.

In this embodiment, copper is used as an interconnect material. However, besides copper, a copper alloy, silver, a silver alloy, and the like may be used.

According to this embodiment, it is possible to form a plated film having a flatter surface without being affected by variations of interconnect pattern shapes. Consequently, excessive plating is prevented to reduce the cost of raw materials, and the cost and technical burdens posed on a polishing process after the plating process can be reduced. Moreover, since the surface to be plated of the substrate can be plated out of contact with the porous member at all times, there is no danger of producing particles in the plating process, a plated film of good film quality can be formed without the introduction of impurities therein.

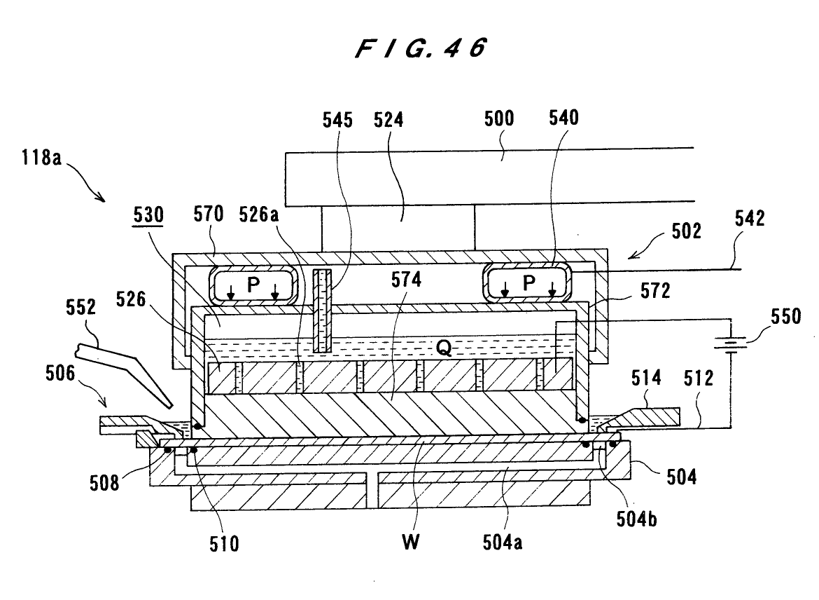

FIG. 46 schematically shows a plating apparatus 118a according to still another embodiment of the present invention. Those parts of the plating apparatus 118a which are identical or corresponding to those of the plating apparatus 118 shown in FIG. 17 are denoted by identical reference characters, and will not be described in detail below.

The plating apparatus 118a has a horizontally swingable swing arm 500 and an electrode head 502 rotatably supported on the distal end of the swing arm 500. The electrode head 502 comprises a rotatable housing 570 and a vertically movable housing 572 which are both in the form of a downwardly open bottomed cylindrical shape and disposed concentrically with each other. The rotatable housing 570 is fixed to the lower surface of a rotating member 524 mounted on the free end of the swing arm 500 for rotation together with the rotating member 524. The vertically movable housing 572 has an upper portion positioned in the rotatable housing 570 for rotation in unison with the rotatable housing 570 and moves vertically with respect to the rotatable housing 570. The vertically movable housing 572 defines an anode chamber 530 by closing a lower open end with an ion-exchange membrane 574 so that a disk-shaped anode 526 is disposed in the anode chamber 530 and is dipped in a plating solution Q which is introduced to the anode chamber 530.

In this embodiment, the ion-exchange membrane 574 is made of a material which is water-permeable, water-absorbent, and water-retentive for holding the plating solution therein. The water-permeable capability means a macroscopic permeability such that even if the material itself is not water-permeable, it may be provided with holes and grooves to allow water to pass therethrough and hence made water-permeable. The water-retentive capability means that the material allows water to penetrate therein.

When the ion-exchange membrane 574 contains the plating solution therein, though the material of the ion-exchange membrane 574 is insulator, the plating solution is introduced through a complex pattern in the ion-exchange membrane 574 and follows a considerably long path in the traverse direction of the ion-exchange membrane 574, allowing the ion-exchange membrane 574 that contains the plating solution therein to have an electric conductivity smaller than the electric conductivity of the plating solution.

The ion-exchange membrane 574 closes the lower open end of the vertically movable housing 572, defining the anode chamber 530 in the vertically movable housing 572, and the anode 526 immersed in the plating solution Q is disposed in the anode chamber 530, the ion-exchange membrane 574 developing a large resistance between the anode 526 and the substrate W. Therefore, the effect of the resistance of the seed layer 6 (see FIG. 1A) is made negligibly small, and in-plane differences between current densities due to the electric resistance of the surface of the substrate W are reduced for increasing the in-plane uniformity of the plated film.

Furthermore, the ion-exchange membrane 574 is effective to separate a deteriorated plating solution on the anode 526 side and a fresh plating solution supplied on the substrate W side from each other and hence to prevent the deteriorated plating solution from being mixed with the fresh plating solution that is supplied to the substrate W and used in contact with the substrate W for plating the substrate W. Therefore, the plating solution can easily be managed. The ion-exchange membrane 574 may comprise a hydrogen ion selective exchange (permeation) membrane which does not pass important substances, such as metal ions (copper ions) and additives, for example, in the composition of the plating solution, and passes only hydrogen ions (H⁺) that are present on the anode 526 side and the substrate W side, or a one-valence anion selective exchange (permeation) membrane which passes only one-valance anions such as hydroxide ions (OH⁻), for example. The ion-exchange membrane 574 thus arranged can pass electricity therethrough while separating the deteriorated plating solution and the fresh plating solution from each other.

If the ion-exchange membrane 574 is a membrane, described below, which not only prevents a plated film from being deposited in a region where the ion-exchange membrane 574 is brought into contact with the surface to be plated of the substrate W, but also does not pass metal ions (copper ions) therethrough, then the supply of metal ions to the upper portion of the interconnect pattern is fully stopped for depositing a flatter plated film.

The ion-exchange membrane 574 may comprise one or any combination of a cation-exchange membrane for passing only cations, an anion-exchange membrane for passing only anions, or an amphoteric exchange membrane for passing both anions and cations depending on the kind of metal to be deposited or a composition of the plating solution used for plating.

The ion-exchange membrane 574 may be N-450 or N-350 (tradenames, manufactured by DuPont), CMS, C66-10F, CMB or HMA (tradenames, manufactured by Tokuyama Corp.), HSF, CMT, CMV, CMO, AMT, AMV, HSV, or EMD (tradenames, manufactured by Asahi Glass Co., Ltd.).

The electrode head 502 has a pressing mechanism, which comprises an air bag 540 in this embodiment, for pressing the ion-exchange membrane 574 against the surface (to be plated) of the substrate W held by the substrate holder 504 under a desired pressure. The air bag (pressing mechanism) 540, which is of a ring shape in this embodiment, is disposed between the lower surface of the ceiling wall of the rotatable housing 570 and the upper surface of the ceiling wall of the vertically movable housing 572. The air bag 540 is connected to a pressurized fluid supply source (not shown) via a pressurized fluid introduction pipe 542. With the swing arm 500 vertically immovably fixed in a predetermined position (process position), the interior of the air bag 540 is pressurized under a pressure P to press the ion-exchange membrane 574 uniformly against the surface (to be plated) of the substrate W held by the substrate holder 504 under a desired pressure. When the pressure P is returned to the atmospheric pressure, the ion-exchange membrane 574 is released from the substrate W.

The pressing mechanism may be replaced with a holding mechanism for holding the ion-exchange membrane 574 in a position close to the surface (to be plated) of the substrate W held by the substrate holder 504 under a desired pressure.

A plating solution introduction pipe 552 is positioned laterally of the vertically movable housing 572 for introducing the plating solution Q into a space surrounded by a sealing member 514 between the substrate W which is held and lifted by the substrate holder 504 and has its outer circumference sealed by the sealing member 514 and the ion-exchange membrane 574 that is positioned when the electrode head 502 is lowered. The space positioned between the substrate W and the ion-exchange membrane 574 and circumferential sealed by the sealing member 514 is filled with the fresh plating solution that is introduced from the plating solution introduction pipe 552.

To the vertically movable housing 572, there are connected a plating solution drawing pipe 545 for drawing the plating solution Q in the anode chamber 530 and a pressurized fluid introduction pipe (not shown) for introducing a pressurized fluid into the anode chamber 530. A number of pores 526a are formed within the anode 526. When the ion-exchange membrane 574 is immersed in the plating solution Q, hermetically sealing the anode chamber 530, the plating solution Q in the anode chamber 530 is drawn through the plating solution drawing pipe 545. Therefore, the plating solution Q is drawn from the ion-exchange membrane 574 into the anode chamber 530, and retained in the ion-exchange membrane 574 and the anode chamber 530.

Operation of the plating apparatus 118a for plating the substrate W will be described below. First, the substrate W is attracted to and held on the upper surface of the substrate holder 504, and then the substrate holder 504 is lifted to bring the peripheral portion of the substrate W into contact with the cathodes 514, so that a current can be supplied to the substrate W. Then, the sealing member 514 is pressed against the upper surface of the peripheral portion of the substrate W, sealing the peripheral portion of the substrate W in a watertight manner. With the plating solution Q retained in the ion-exchange membrane 574 and the anode chamber 530, as described above, the electrode head 502 is placed in a predetermined position (process position). Specifically, the swing arm 500 is lifted and swung to position the electrode head 502 right above the substrate holder 504. Then, the swing arm 500 is lowered and stopped when the electrode head 502 reaches the predetermined position (process position).

Then, the plating solution is introduced from the plating solution introduction pipe 552 into the space between the substrate W and the ion-exchange membrane 574 until the space is filled up with the fresh plating solution. The fresh plating solution that fills the space between the substrate W and the ion-exchange membrane 574 is now held in contact with the plating solution Q that is retained in the ion-exchange membrane 574 and the anode chamber 530. At this time, the ion-exchange membrane 574 separates the deteriorated plating solution on the anode 526 side and the fresh plating solution supplied on the substrate W side from each other, and hence prevents the fresh plating solution that is supplied to the substrate W from being mixed with the deteriorated plating solution.

Then, pressurized air is introduced into the air bag 540 to press the ion-exchange membrane 574 downwardly against the upper surface (surface to be plated) of the substrate W held by the substrate holder 504 under a desired pressure.

With the ion-exchange membrane 574 held in contact with the surface of the substrate W, the ion-exchange membrane 574 is rotated by two revolutions at a speed of one revolutions/sec. so as to be rubbed against the surface of the substrate W, and then stopped from rotating. Alternatively, the ion-exchange membrane 574 may be fixed, and the substrate W may be rotated. After the rotation of the ion-exchange membrane 574 is stopped, preferably within 2 seconds from the stoppage of the rotation of the ion-exchange membrane 574, the cathodes 512 are connected to the cathode of the plating power source 550 and the anode 526 is connected to the anode of the plating power source 550 respectively, thereby starting to plate the substrate W.

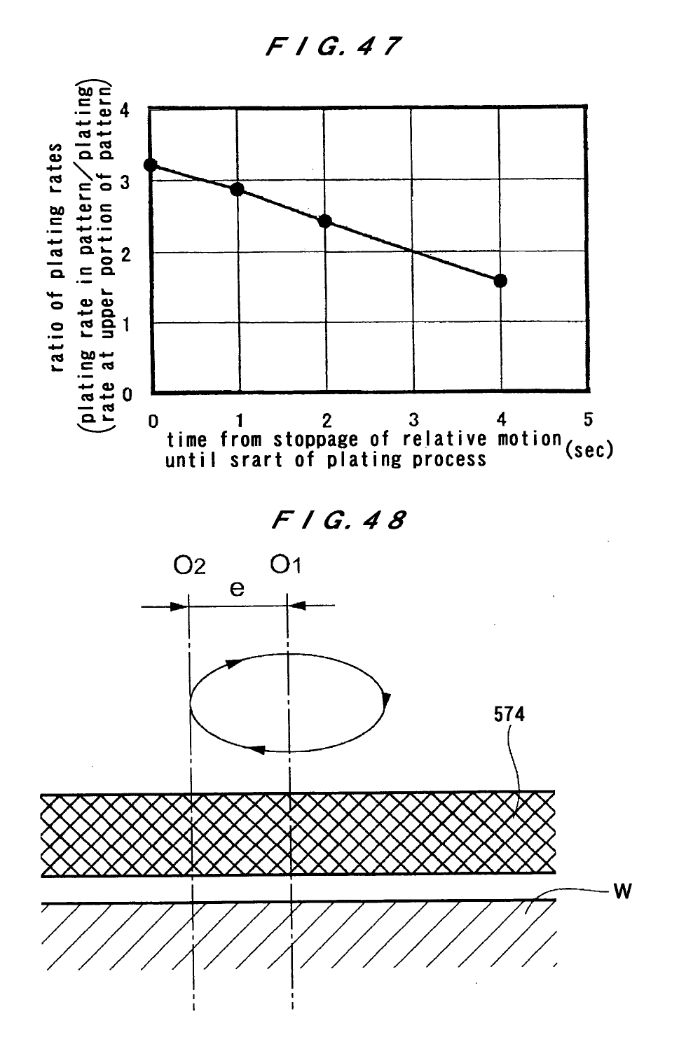

It is confirmed that, when the ion-exchange membrane 574 and the substrate W are relatively moved while the ion-exchange membrane 574 and the surface to be plated of the substrate W held by the substrate holder 504 are being kept in contact with each other, and thereafter the substrate W is plated, the growth of the plated film on the upper portion of the interconnect pattern (surface of the field area) is suppressed to lower the plating rate. FIG. 47 shows the relationship between the time from the stoppage of the relative motion of the ion-exchange membrane 574 and the substrate W until the start of the plating process, and the ratio of the plating rate in the interconnect pattern to the plating rate at the upper portion of the interconnect pattern (plating rate in the interconnect pattern/plating rate at the upper portion of the interconnect pattern). It can be seen from FIG. 47 that if plating is started immediately after the stoppage of the relative motion of the ion-exchange membrane 574 and the substrate W, then the ratio of the plating rate in the interconnect pattern to the plating rate at the upper portion of the interconnect pattern is 3 or more, and the ratio gradually decreases with time, and the ratio remains to be 2 or more within 2 seconds. That is, if plating is started within 2 seconds after the stoppage of the relative motion of the ion-exchange membrane 574 and the substrate W, then the plating rate in the interconnect pattern is twice the plating rate at the upper portion of the interconnect pattern or more.

By thus relatively moving the ion-exchange membrane 574 and the substrate W, and thereafter, preferably within 2 seconds thereafter, starting to plate the substrate W such that the plating rate at the upper portion of the interconnect pattern is lower than the plating rate in the interconnect pattern, it is possible to cause the height of the plated layer in the interconnect pattern to catch up the height of the plated layer in the upper portion of the interconnect pattern regardless of variations of the shape of the interconnect pattern, forming a flatter plated film on the surface of the substrate W. According to this plating process, since no special current conditions and no additives are required, and the surface of the plated film is not scraped off, a plated film of good film quality can be formed on the substrate W.

The ion-exchange membrane 574 disposed between the anode 526 and the substrate W is effective to separate the deteriorated plating solution on the anode 526 side and the fresh plating solution supplied on the substrate W side from each other, and hence prevent the fresh plating solution that is supplied to the substrate W and used to plate the substrate W while in contact with the substrate W from being mixed with the deteriorated plating solution.

Since the ion-exchange membrane 574 comprises a membrane which does not pass important substances, such as metal ions and additives in the composition of the plating solution, and passes only hydrogen ions and hydroxide ions, for example, that are present in both the deteriorated plating solution and the fresh plating solution, the ion-exchange membrane 574 can pass electricity therethrough while separating the deteriorated plating solution and the fresh plating solution from each other. Furthermore, since the ion-exchange membrane 574 comprises a membrane which not only prevents a plated film from being precipitated in a region where the ion-exchange membrane 574 is brought into contact with the surface to be plated of the substrate W, but also does not pass metal ions therethrough, the supply of metal ions to the upper portion of the interconnect pattern is fully stopped for depositing a flatter plated film.

After the plating has been continued for a predetermined period of time, the cathodes 512 and the anode 526 are disconnected from the plating power source 550, and the atmospheric pressure is restored in the anode chamber 530. The atmospheric pressure is also restored in the air bag 540, and the ion-exchange membrane 574 is released from the substrate W. The electrode head 502 is then elevated.

The above process is repeated as many times as required to deposit the copper layer 7 (see FIG. 1B) which is thick enough to fill the fine interconnect recesses on the surface (to be plated) of the substrate W. Thereafter, the electrode head 502 is turned back to the original position (idling position).

FIG. 48 is a schematic view showing another embodiment of a driving mechanism for making a relative motion between the ion-exchange membrane 574 and the substrate W held by the substrate holder 504 (see FIG. 46). In this embodiment, the center O₁ of the ion-exchange membrane 574 is off-centered by “e” from the center O₂ of the substrate W held by the substrate holder 504, whereby the ion-exchange membrane 574 makes a scroll motion along a circle having a radius “e”, i.e. makes an orbital motion (translational rotary motion). Therefore, the ion-exchange membrane 574 and the substrate W held by the substrate holder 504 make a relative motion by the scroll motion of the ion-exchange membrane 574.

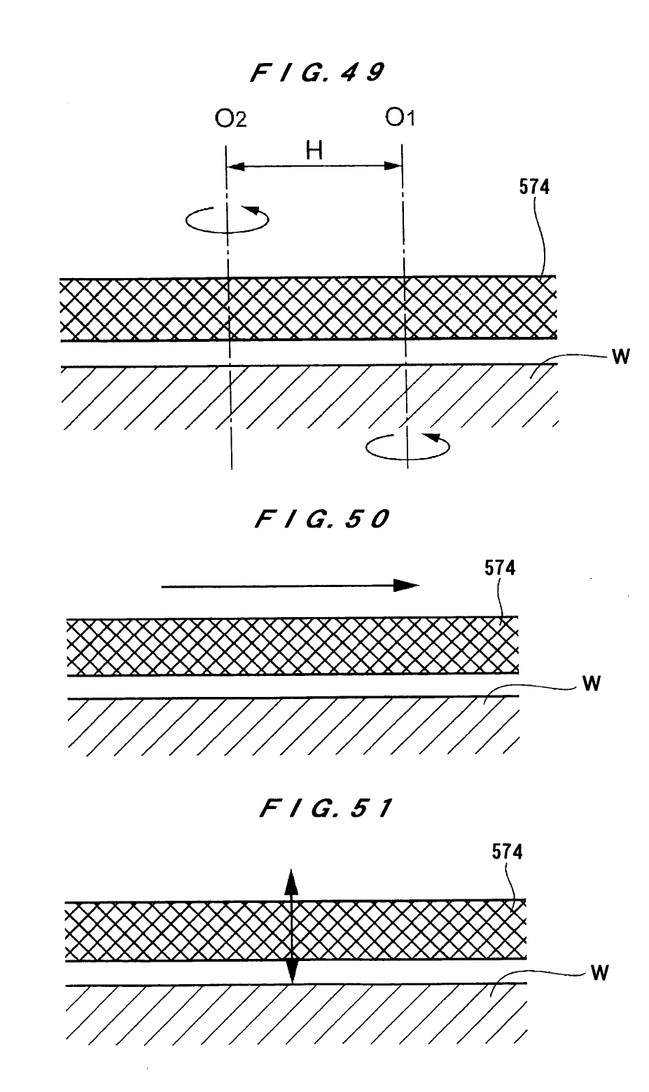

FIG. 49 is a schematic view showing still another embodiment of a driving mechanism for making a relative motion between the ion-exchange membrane 574 and the substrate W held by the substrate holder 504 (see FIG. 46). In this embodiment, the center O₁ of the ion-exchange membrane 574 is displaced by a distance H from the center O₂ of the substrate W held by the substrate holder 504, whereby the ion-exchange membrane 574 rotates about its center O₁ and the substrate W rotates about its center O₂. Thus, the ion-exchange membrane 574 and the substrate W held by the substrate holder 504 make a relative motion by rotation of the ion-exchange membrane 574 and the substrate W about their respective centers.

FIG. 50 is a schematic view showing still another embodiment of a driving mechanism for making a relative motion between the ion-exchange membrane 574 and the substrate W held by the substrate holder 504 (see FIG. 46). In this embodiment, the ion-exchange membrane 574 makes a linear motion in one direction along the surface of the substrate W held by the substrate holder 504, whereby the ion-exchange membrane 574 and the substrate W make a relative motion. In this embodiment, although the substrate W is stationary, the substrate W may make a linear motion, or both of the ion-exchange membrane 574 and the substrate W may make linear motions in opposite directions.

In the above embodiments, while the ion-exchange membrane 574 and the substrate W held by the substrate holder 504 (see FIG. 46) are brought into contact with each other, the ion-exchange membrane 574 and the substrate W make a relative motion. After the stoppage of this relative motion, preferably within two second, plating is started.

FIG. 51 is a schematic view showing an essential part of a plating apparatus according to still another embodiment of the present invention. The plating apparatus according to the embodiment shown in FIG. 51 is different from the plating apparatus shown in FIG. 46 in that a driving mechanism for making a relative motion between the ion-exchange membrane 574 and the substrate W held by the substrate holder 504 is provided so that contact and non-contact between the ion-exchange membrane 574 and the surface, to be plated, of the substrate W held by the substrate holder 504 (see FIG. 46) are repeated. Other structure is the same as that of the apparatus shown in FIG. 46.

According to this embodiment, the ion-exchange membrane 574 and the substrate W held by the substrate holder 504 make a relative motion so that contact and non-contact between the ion-exchange membrane 574 and the surface, to be plated, of the substrate W are repeated, and then plating is performed. In this embodiment also, plating can be suppressed in the upper part of the interconnect pattern for thereby lowering a plating rate, and the plating rate in the upper part of the interconnect pattern is smaller than that in the inner part of the interconnect pattern, and hence a plated film whose surface is flat can be formed.

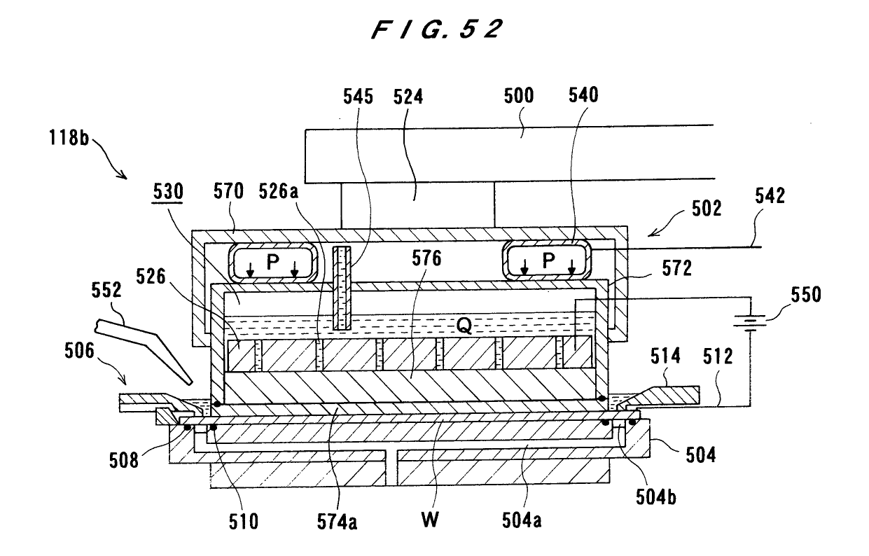

FIG. 52 is a schematic view showing a plating apparatus according to still another embodiment of the present invention. The plating apparatus 118b according to the embodiment shown in FIG. 52 is different from the plating apparatus 118a shown in FIG. 46 in that the vertically movable housing 572 has a lower open end closed with an ion-exchange membrane 574a and a porous member (plating solution impregnated material) 576 with water retentivity is disposed in the anode chamber 530 and between the ion-exchange membrane 574a and the anode 526.

According to this embodiment, the ion-exchange membrane 574a serves to separate the deteriorated plating solution on the anode 526 side and the fresh plating solution supplied on the substrate W side from each other, and hence prevent the fresh plating solution that is supplied to the substrate W and used to plate the substrate W while in contact with the substrate W from being mixed with the deteriorated plating solution. The porous member 576 disposed between the ion-exchange membrane 574a and the anode 526 serves to hold the plating solution, so that the high resistance is generated between the ion-exchange membrane 574a and the anode 526 by the porous member 576. Hence, the influence of the resistance of the seed layer 6 (see FIG. 1A) becomes a negligible degree. Consequently, the difference in current density over the surface of the substrate due to electrical resistance on the surface of the substrate W becomes small, and the uniformity of the plated film over the surface of the substrate improves.

In this embodiment, the plating rate at the upper portion of the interconnect pattern is made lower than the plating rate in the interconnect pattern to form a flatter plated film on the surface of the substrate W regardless of variations of the shape of the interconnect pattern. Consequently, excessive plating is prevented to reduce the cost of raw materials, and the cost and technical burdens posed on a polishing process after the plating process can be reduced. Moreover, since no special current conditions and no additives are required, and the surface of the plated film is not scraped off, a plated film of good film quality can be formed on the substrate. Furthermore, the ion-exchange membrane is effective to separate a deteriorated plating solution on the anode side and a fresh plating solution supplied on the substrate side and used to plate the substrate while in contact with the substrate from each other. Therefore, the plating solution can easily be managed, and a flatter plated film can be formed on the substrate.

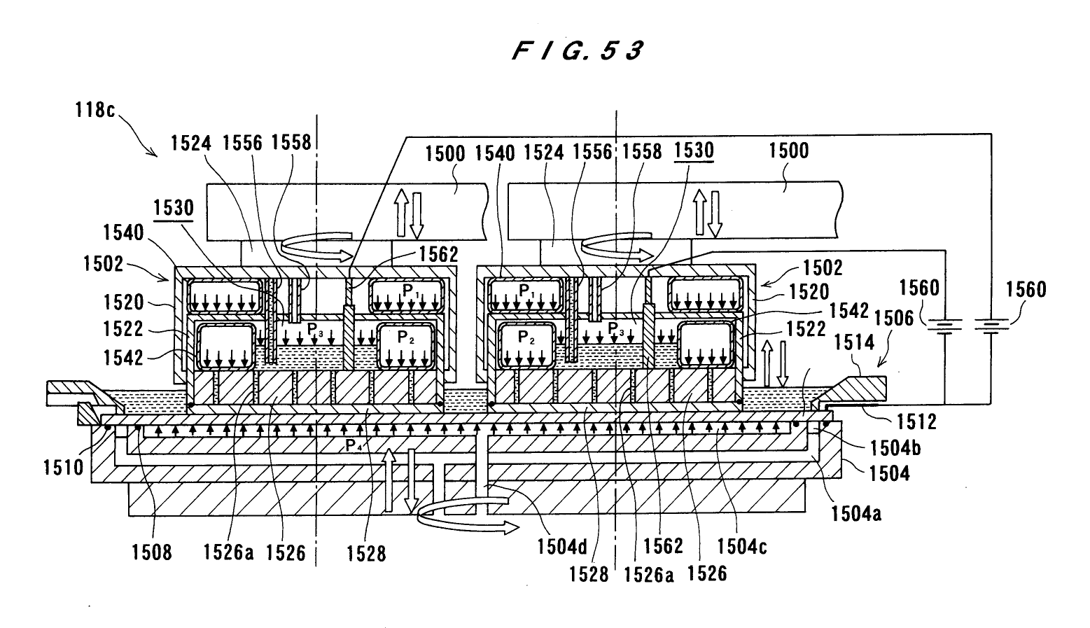

FIG. 53 schematically shows a plating apparatus according to still another embodiment of the present invention. As shown in FIG. 53, the plating apparatus 118c has a plurality of horizontally swingable swing arms 1500 and electrode heads 502 rotatably supported on the respective distal ends of the swing arms 1500. The plating apparatus 118c also has a substrate holder 1504 vertically movably positioned below the electrode heads 502 for holding a substrate W with its surface (to be plated) facing upwardly. A cathode portion 1506 is disposed above the substrate holder 1504 in surrounding relation to the peripheral edge of the substrate holder 1504.

An annular vacuum attraction groove 1504b communicating with a vacuum passage 1504a provided in the substrate holder 1504 is formed in a peripheral portion of an upper surface of the substrate holder 1504. Seal rings 1508 and 1510 are provided on inward and outward sides of the vacuum attraction groove 1504b, respectively. The substrate holder 1504 has a pressurizing cavity 1504c defined in its upper surface radially inwardly of the inner seal ring 1508. The pressurizing cavity 1504c communicates with a pressurized fluid passage 1504d extending vertically through the substrate holder 1504.

The substrate W is placed on the upper surface of the substrate holder 1504, and the vacuum attraction groove 1504b is evacuated through the vacuum passage 1504a to attract the peripheral portion of the substrate W, thereby holding the substrate W. Furthermore, a pressurized fluid such as pressurized air or the like is supplied through the pressurized fluid passage 1504d into the pressurizing cavity 1504c to pressurize the reverse side of the substrate W under a pressure P₄, thereby keeping the substrate W in a more horizontal state and hence holding the substrate W in closer contact with the lower surface of a porous member 1528, as described later.

The substrate holder 1504 has a built-in heater (not shown) for controlling the temperature of the substrate holder 1504 at a constant level. The substrate holder 1504 is vertically movable by an air cylinder (not shown) and also rotatable in unison with the cathode portion 1506 at an arbitrary acceleration and an arbitrary velocity by a rotating motor and belt (not shown). The torque applied to the substrate holder 1504 is detected by a torque sensor (not shown). When the substrate holder 1504 is lifted, a sealing member 1514 and cathodes 1512 of the cathode portion 1506 come into contact with the peripheral portion of the substrate W which is held by the substrate holder 1504.

Each of the swing arms 1500 can individually be vertically moved by a elevating/lowering motor and a ball screw (not shown), and can also individually be turned (swung) by a swing motor (not shown). Each of the swing arms 1500 may be at least vertically moved or swung by a pneumatic actuator.

In this embodiment, the cathode portion 1506 has the cathodes 1512 comprising six cathodes, and the annular sealing member 1514 disposed above the cathodes 1512 so as to cover upper surfaces of the cathodes 1512. The sealing member 514 has an inner circumferential portion, which is inclined inwardly and downwardly, so that a thickness of the sealing member 514 is gradually reduced. The sealing member 514 has an inner circumferential edge portion extending downwardly.

With this structure, when the substrate holder 1504 is lifted, the cathodes 1512 are pressed against the peripheral portion of the substrate W that is held by the substrate holder 1504 to pass a current to the substrate W. At the same time, the inner peripheral portion of the sealing member 1514 is pressed against the upper surface of the peripheral portion of the substrate W to seal the peripheral portion of the substrate W in a watertight manner, thereby preventing the plating solution supplied to the upper surface (surface to be plated) of the substrate W from seeping out from the end of the substrate W and also from contaminating the cathodes 1512.

Structural details of each of the electrode heads 1502 will be described below. The electrode heads 1502 that are individually controlled together with the swing arms 1500 are identical in structure to each other, and serve to individually plate corresponding regions of the substrate W that is held and lifted by the substrate holder 1504. One of the electrode heads 1502 will be described below, and components of the other electrode heads 1502 are denoted by identical reference characters and will not be described below.

The electrode head 1502 comprises a rotatable housing 1520 and a vertically movable housing 1522 which are both in the form of a downwardly open bottomed cylindrical shape and disposed concentrically with each other. The vertically movable housing 1522 has an outside diameter which is the same as the diameter of a porous member 1528 to be described later. The rotatable housing 1520 is of such a size that the vertically movable housing 1522 can slide in the rotatable housing 1520. Porous members 1528 of the respective electrode heads 1502 are brought into simultaneous contact with the surface (to be plated) of the substrate W that is held by the substrate holder 1504, and the electrode heads 1502 are individually controlled to simultaneously plate the substrate W.

The rotatable housing 1520 is fixed to the lower surface of a rotating member 1524 mounted on the free end of the swing arm 1500 for rotation with the rotating member 1524. The vertically movable housing 1522 has an upper portion positioned in the rotatable housing 1520 for rotation in unison with the rotatable housing 1520 and moves vertically with respect to the rotatable housing 1520. The vertically movable housing 1522 defines an anode head chamber 1530 by closing a lower open end with an disk-shaped porous member 1528 so that a disk-shaped anode 1526, which is of a shape corresponding to the porous member 1528, is disposed in the anode chamber 530 and is dipped in a plating solution which is introduced to the anode head chamber 1530.

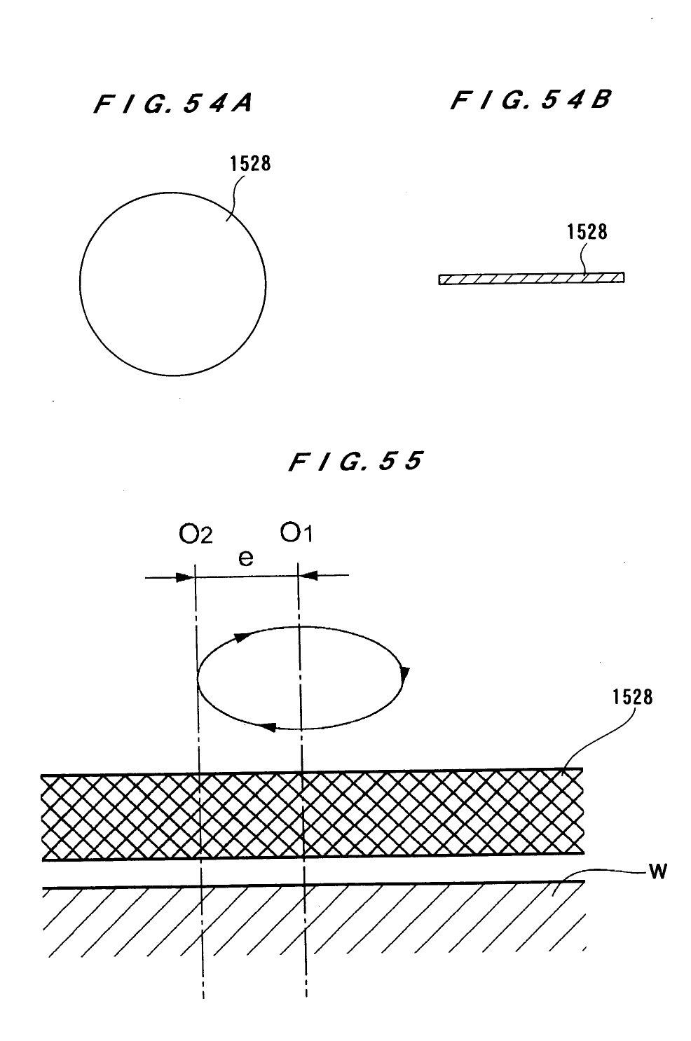

In this embodiment, as shown in FIGS. 54A and 54B, the porous member 1528 is in the form of a disk having a diameter of 100 mm, and is used in plating the surface (to be plated) of the substrate W which may be a semiconductor wafer of a diameter of 300 mm, for example. The lower pad 1528 is required to have the contact surface adapted to contact the surface (surface to be plated) of the substrate W and having a certain degree of flatness, and to have fine through-holes therein for allowing the plating solution to pass therethrough. It is also necessary that at least the contact surface of the lower pad 1528 is made of an insulator or a material having high insulating properties. The flatness required of the porous member 1528 is expressed in terms of maximum roughness (RMS) of several tens μm, for example.

It is desirable that the fine through-holes of the lower pad 1528 have a circular cross-section in order to maintain flatness of the contact surface. An optimum diameter of each of the fine through-holes and the optimum number of the fine through-holes per unit area vary depending on the kind of a plated film and an interconnect pattern. However, it is desirable that both the diameter and the number are as small as possible in view of improving selectivity of a plated film that is growing in recesses. Specifically, the diameter of each of the fine through-holes may be not more than 30 μm, preferably in the range of 5 to 20 μm. The number of the fine through-holes having such diameter per unit area may be represented by a porosity of not more than 50%.

The porous member 1528 should preferably have a certain level of rigidity, and may have a tensile strength ranging from 5 to 100 kg/cm² and a flexural elasticity strength ranging from 200 to 10000 kg/cm².

As with the lower pad (porous pad) 534a of the plating apparatus 118 shown in FIG. 17, the porous member 1528 is made of, for example, a hydrophobic material such as porous polyethylene or the like which is either processed by a hydrophilic treatment or polymerized with hydrophilic groups.

The surface of the porous member 1528 which will come into contact with the surface of the substrate W may be flattened by a compression process or a machining process for higher preferential precipitation in fine grooves.

The porous member 1528 may be made of porous ceramics such as alumina, SiC, mullite, zirconia, titania, cordierite, or the like, or a hard porous material such as sintered polypropylene, sintered polyethylene, or the like, or a composite material thereof, or a woven fabric or a non-woven fabric.

The porous member 1528 thus arranged develops a large resistance to make the effect of the resistance of the seed layer 6 (see FIG. 1A) negligibly small, and in-plane differences between current densities due to the electric resistance of the surface of the substrate W are reduced for increasing the in-plane uniformity of the plated film.

The electrode head 1502 has a pressing/separating mechanism, which comprises two air bags in the present embodiment, for pressing the porous member 1528 against the surface (to be plated) of the substrate W held by the substrate holder 504 under a desired pressure. Specifically, a first ring-shaped air bag 1540 is disposed between the lower surface of the ceiling wall of the rotatable housing 1520 and the upper surface of the ceiling wall of the vertically movable housing 1522. A second ring-shaped air bag 1542 is disposed in the vertically movable housing 1522 and between the lower surface of the ceiling wall of the vertically movable housing 1522 and the upper surface of the anode 1526. The air bags 1540, 1542 are connected to a pressurized fluid supply source (not shown) by pressurized fluid introduction pipes (not shown). The air bags 1540, 1542 make up the pressing/separating mechanism.

With the swing arm 1500 vertically immovably fixed in a predetermined position (process position), as shown in FIG. 53, the interior of the first air bag 1540 is pressurized under a pressure P₁ and the interior of the second air bag 1542 is pressurized under a pressure P₂ to press the porous member 1528 against the surface (to be plated) of the substrate W held by the substrate holder 1504 under a desired pressure. When the pressures P₁, P₂ are returned to the atmospheric pressure, the porous member 1528 is spaced from the surface substrate W. Therefore, the first air bag 1540 presses the vertically movable housing 1522 uniformly over its entire horizontal surface, and the second air bag 1542 presses the anode 1526 in the anode head chamber 1530 uniformly over its entire horizontal surface, thus bringing the entire surface of the porous member 1528 uniformly into close contact with the entire surface of the substrate W that is held by the substrate holder 1504.

To the vertically movable housing 1522, there are connected a plating solution introduction pipe 1556 for introducing the plating solution into the vertically movable housing 1522 and a pressurized fluid introducing pipe 1558 for introducing a pressurized fluid into the vertically movable housing 1522. The anode 1526 has a number of pores 1526a defined therein. The plating solution is introduced from the plating solution introduction pipe 1556 into the anode head chamber 1530. When the interior of the anode head chamber 1530 is pressurized under a pressure P₃, the plating solution passes through the pores 1526a in the anode 1526 to the upper surface of the porous member 1528, and then passes through the porous member 1528 to the upper surface of the substrate W that is held by the substrate holder 1504.

The anode head chamber 1530 contains gases produced by chemical reactions, and hence the pressure in the anode head chamber 1530 may vary. Therefore, the pressure P₃ in the anode head chamber 1530 is controlled at a preset value by a feedback control process while the plating process is being performed.

The cathodes 1512 are electrically connected to a cathode of a plating power source 1560 and the anode 1526 is electrically connected to an anode of the plating power source 1560, respectively. The vertically movable housing 1522 has a feeding port 1562 connected to the plating power source 1560 for supplying a current to the anode 1526. When the plating power source 1560 applies the voltage individually between the cathodes 1512 which give a negative potential to the substrate W held by the substrate holder 1504 and the anodes 1526 of the respective electrode heads 1502 to plate the substrate W, the entire surface of the substrate W is not plated altogether, but the regions of the substrate W which face the respective electrode heads 1502 are individually plated to minimize the effect of the sheet resistance of the surface of the substrate for producing a plated film of good in-plane uniformity. The plated film is also of good quality because no special current conditions and no additives are required.

Operation of the plating apparatus 118c for plating the substrate W will be described below. First, the substrate W is attracted to and held on the upper surface of the substrate holder 1504, and then the substrate holder 1504 is lifted to bring the peripheral portion of the substrate W into contact with the cathodes 1512, so that a current can be supplied to the substrate W. Then, the substrate holder 1504 is further lifted to press the sealing member 1514 is pressed against the upper surface of the peripheral portion of the substrate W, sealing the peripheral portion of the substrate W in a watertight manner.

On the other hand, each electrode head 1502 is moved from a position (idling position) where replacement of the plating solution, removal of bubbles, and the like are conducted by idling to a predetermined position (process position) in such a state that the plating solution is held inside the electrode head 1502. Specifically, the swing arm 1500 is once raised and further swung, whereby the electrode head 1502 is located right above the substrate holder 1504. Thereafter, the electrode head 1502 is lowered, and when the electrode head 502 reaches the predetermined position (process position), the electrode head 1502 is stopped. The interior of the anode head chamber 1530 is pressurized under the pressure P₃ to discharge the plating solution from the lower surface of the porous member 1528.

Then, pressurized air is introduced into the air bags 1540, 1542, and at the same time pressurized air is introduced into the pressurizing cavity 1504c in the substrate holder 1504, lowering the vertically movable housing 1522 to press the porous member 1528 further downwardly and simultaneously pressurizing the reverse side of the substrate W held by the substrate holder 1504 to press the porous member 1528 against the surface (to be plated) of the substrate W under a predetermined pressure. The substrate W is thus kept a more horizontal state and hence the substrate W is pressed against the porous member 1528 under a more uniform pressure.

While the porous member 1528 is being held in contact with the surface of the substrate W, the porous member 1528 may be rotated by two revolutions at a speed of one revolution/sec., for example, so as to be rubbed against the surface of the substrate W, and then stopped from rotating. The porous member 1528 may be fixed, and the substrate W may be rotated. Thereafter, preferably within 2 seconds after the porous member 1528 is stopped, the cathodes 1512 are connected to the cathode of the plating power source 1560 and the anode 1526 is connected to the anode of the plating power source 1560, thereby starting to plate the surface to be plated of the substrate W.

The portions (regions) of the substrate W, which are confronted by the respective porous members 1528 of the electrode heads 1502, are plated by the respective electrode heads 1502. Since the planar shape of each of the porous members 1528 is smaller than the surface to be plated of the substrate W and the region of the substrate W which is confronted by the porous member 1528 is plated, the different regions of the substrate W can be plated in detail under different conditions. The entire surface of the substrate W is not plated altogether, but the regions of the substrate W which face the respective electrode heads 1502 are individually plated to minimize the effect of the sheet resistance of the surface of the substrate W for producing a plated film of good in-plane uniformity. The plated film is also of good quality because no special current conditions and no additives are required.

As described above, the porous member 1528 and the substrate W are relatively moved while the porous member 1528 and the surface to be plated of the substrate W held by the substrate holder 504 are being kept in contact with each other, and thereafter the substrate W is plated. Consequently, the growth of the plated film on the upper portion of the interconnect pattern is suppressed to lower the plating rate. Specifically, the porous member 1528 and the substrate W are relatively moved, and after their relative motion is stopped, or preferably within 2 seconds thereafter, plating is started. The plating rate at the upper portion of the interconnect pattern is made lower than the plating rate in the interconnect pattern to cause the height of the plated layer in the inner portion of the interconnect pattern to catch up the height of the plated layer on the upper portion of the interconnect pattern regardless of variations of the shape of the interconnect pattern, forming a flatter plated film on the surface of the substrate W.

After the plating has been continued for a predetermined period of time, the cathodes 1512 and the anode 1526 are disconnected from the plating power source 1560, and the pressure in the anode head chamber 1530 is restored to the atmospheric pressure. The atmospheric pressures in the air bags 1540, 1542 are also restored to the atmospheric pressures, thereby releasing the porous member 1528 from the substrate W. The electrode head 1502 is then elevated.

The above process is repeated as many times as required to deposit the copper layer 7 (see FIG. 1B) which is thick enough to fill the fine interconnect recesses on the surface (to be plated) of the substrate W. Thereafter, the electrode head 1502 is swung back to the original position (idling position).

FIG. 55 is a schematic view showing another embodiment of a driving mechanism for making a relative motion between the porous member 1528 and the substrate W held by the substrate holder 1504 (see FIG. 53). In this embodiment, the center O₁ of the porous member 1528 is off-centered by “e” from the center O₂ of the substrate W held by the substrate holder 1504, whereby the porous member 1528 makes a scroll motion along a circle having a radius “e”, i.e. makes an orbital motion (translational rotary motion). Therefore, the porous member 1528 and the substrate W held by the substrate holder 1504 make a relative motion by the scroll motion of the porous member 1528.

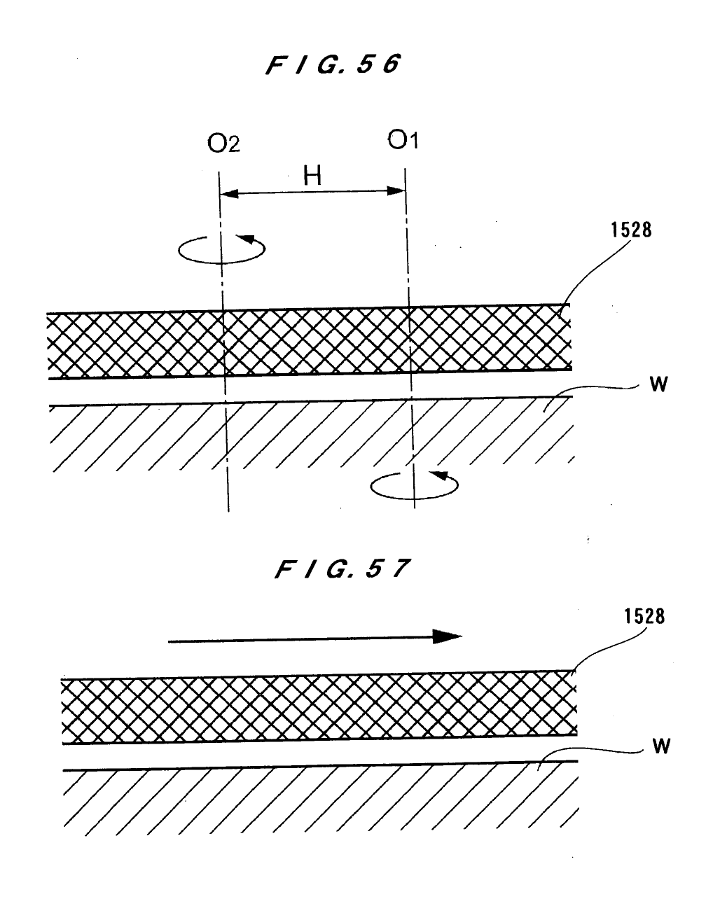

FIG. 56 is a schematic view showing still another embodiment of a driving mechanism for making a relative motion between the porous member 1528 and the substrate W held by the substrate holder 1504 (see FIG. 53). In this embodiment, the center O₁ of the porous member 1528 is displaced by a distance H from the center O₂ of the substrate W held by the substrate holder 1504, whereby the porous member 1528 rotates about its center O₁ and the substrate W rotates about its center O₂. Thus, the porous member 1528 and the substrate W held by the substrate holder 1504 make a relative motion by rotation of the porous member 1528 and the substrate W about their respective centers.

FIG. 57 is a schematic view showing still another embodiment of a driving mechanism for making a relative motion between the porous member 1528 and the substrate W held by the substrate holder 1504 (see FIG. 53). In this embodiment, the porous member 1528 makes a linear motion in one direction along the surface of the substrate W held by the substrate holder 1504, whereby the porous member 1528 and the substrate W make a relative motion. In this embodiment, although the substrate W is stationary, the substrate W may make a linear motion, or both of the porous member 1528 and the substrate W may make linear motions in opposite directions.

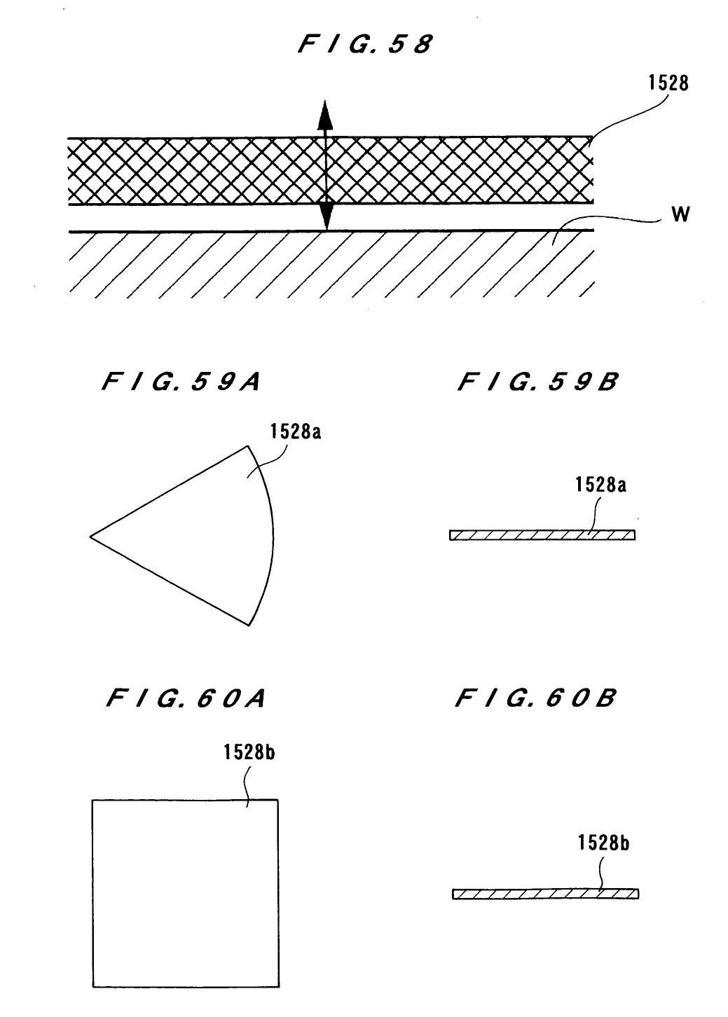

FIG. 58 is a schematic view showing still another embodiment of a driving mechanism for making a relative motion between the porous member 1528 and the substrate W held by the substrate holder 1504 (see FIG. 53). In this embodiment, the porous member 1528 is vertically moved (oscillated) with respect to the substrate W so that contact and non-contact between the porous member 1528 and the surface, to be plated, of the substrate W held by the substrate stage 1504 (see FIG. 53) are repeated. In this embodiment, although the substrate W is stationary and the porous member 1528 is vertically moved (oscillated), the porous member 1528 may be stationary and the substrate W may be vertically moved (oscillated).

In this embodiment, the porous member 1528 is vertically moved (oscillated) with respect to the substrate W held by the substrate holder 1504 so that contact and non-contact between the porous member 1528 and the surface, to be plated, of the substrate W held by the substrate stage 1504 are repeated, after which the substrate W is plated. In this manner, the growth of the plated film on the upper portion of the interconnect pattern is also suppressed to lower the plating rate, and the plating rate at the upper portion of the interconnect pattern is made lower than the plating rate in the interconnect pattern to form a flatter plated film on the surface of the substrate W.

FIGS. 59A and 59B show another porous member 1528a. The porous member 1528a is of a sectorial planar shape which is smaller than the planar shape of the surface to be plated of the substrate. A portion (region) of the substrate which corresponds to the sectorial porous member 1528a is individually plated by the electrode head 1502 (see FIG. 53) having the porous member 1528a.

According to the embodiment shown in FIGS. 59A and 59B, as with the preceding embodiment, the anode 1526 (see FIG. 53) is of a sectorial shape corresponding to the planar shape of the porous member 1528a. When the anode and the porous member, which are of the corresponding shapes, are vertically aligned with each other without sticking out during plating, the substrate can be plated only in the region thereof which is confronted by the porous member 1528a. Furthermore, the electrode head 1502 (see FIG. 53) may be of a sectorial shape corresponding to the planar shape of the porous member 1528a to make it possible to reduce the size of, i.e., make compact, the electrode head which has the anode and the porous member in its upper and lower positions. This holds for an embodiment to be described below.

FIGS. 60A and 60B show still another porous member 1528b. The porous member 1528b is of a rectangular planar shape which is smaller than the planar shape of the surface to be plated of the substrate. A rectangular portion (region) of the substrate which corresponds to the rectangular porous member 1528b is individually plated by the electrode head 1502 (see FIG. 53) having the porous member 1528b. In this case, the porous member 1528b may have a planar shape which is identical to the planar shape of one die (semiconductor chip) formed in a division on a substrate, and such a die may individually be plated to produce a plated film of good in-plane uniformity and film quality on the die.

According to this embodiment, local regions of the substrate can be plated under different conditions. As the regions of the substrate are individually plated, a plated film of good in-plane uniformity can be formed while minimizing the effect of the sheet resistance of the surface of the substrate. The plated film is also of good quality because no special current conditions and no additives are required.

Although certain preferred embodiments of the present invention have been shown and described in detail, it should be understood that various changes and modifications may be made therein without departing from the scope of the appended claims.

1. A plating apparatus comprising:
a substrate holder for holding a substrate;
a cathode portion including a sealing member for contacting a peripheral portion of a surface, to be plated, of the substrate held by said substrate holder to seal said peripheral portion water-tightly, and a cathode for contacting the substrate to supply current to the substrate;
an anode vertically movably disposed so as to face the surface, to be plated, of the substrate; and
a porous member disposed between said anode and the surface, to be plated, of the substrate, said porous member being made of a water-retentive material;
wherein said porous member has at least a hydrophilic substrate-facing surface which faces the surface, to be plated, of the substrate.

2. A plating apparatus according to claim 1, wherein said porous member is made of a hydrophilic material.

3. A plating apparatus according to claim 1, wherein said substrate-facing surface of said porous member is modified by a plasma process.

4. A plating apparatus according to claim 3, wherein said substrate-facing surface of said porous member is modified by a glow discharge process.

5. A plating apparatus according to claim 3, wherein said substrate-facing surface of said porous member is modified by a corona discharge process.

6. A plating apparatus according to claim 1, wherein said substrate-facing surface of said porous member is modified by an ultraviolet ray application process.

7. A plating apparatus according to claim 1, wherein said substrate-facing surface of said porous member is modified by an ozone process.

8. A plating apparatus according to claim 1, wherein said substrate-facing surface of said porous member is given hydrophilic functional groups.

9. A plating apparatus according to claim 8, wherein said hydrophilic functional groups comprise functional groups which will be turned into a material contained in the composition of a plating solution when dissolved.

10. A plating apparatus according to claim 1, wherein said substrate-facing surface of said porous member is cross-linked or coated with a hydrophilic material.

11. A plating apparatus according to claim 10, wherein said hydrophilic material comprises a material contained in the composition of a plating solution.

12. A plating apparatus according to claim 1, wherein said substrate-facing surface of said porous member is cross-linked or coated with a surfactant.

13. A plating apparatus according to claim 12, wherein said surfactant comprises a surfactant contained in the composition of a plating solution.

14. A plating apparatus comprising:
a substrate holder for holding a substrate;
a cathode portion including a sealing member for contacting a peripheral portion of a surface, to be plated, of the substrate held by said substrate holder to seal said peripheral portion water-tightly, and a cathode for contacting the substrate to supply current to the substrate;
an anode vertically movably disposed so as to face the surface, to be plated, of the substrate;
a porous member disposed between said anode and the surface, to be plated, of the substrate, said porous member being made of a water-retentive material;
a porous member positioning mechanism for positioning said porous member in a predetermined position which is closely spaced a predetermined distance from the surface, to be plated, of the substrate held by said substrate holder; and
a driving mechanism for making a relative motion between said porous member and the substrate.

15. A plating apparatus according to claim 14, wherein when said porous member is positioned in said predetermined position, said porous member and the surface, to be plated, of the substrate held by said substrate holder are spaced from each other by a distance of up to 1.5 mm.

16. A plating apparatus according to claim 14, wherein said relative motion is vibration.

17. A plating apparatus according to claim 14, wherein said relative motion is a rotary motion.

18. A plating apparatus according to claim 14, wherein said relative motion is a scroll motion.

19. A plating apparatus according to claim 14, wherein said relative motion is a rotary motion of said porous member and the substrate about their respective axes that are spaced from each other.

20. A plating apparatus according to claim 14, wherein said relative motion is a linear motion.

21. A plating method comprising:
interposing a porous member made of a water-retentive material between a substrate and an anode;
filling a space between a surface, to be plated, of the substrate and said anode with a plating solution;
positioning said porous member in a predetermined position which is closely spaced a predetermined distance from the surface, to be plated, of the substrate; and
supplying a current between the surface, to be plated, of the substrate and said anode to plate the surface, to be plated of, the substrate while making a relative motion between said porous member and the substrate.

22. A plating method according to claim 21, wherein when said porous member is positioned in said predetermined position, said porous member and the surface, to be plated, of the substrate are spaced from each other by a distance of up to 1.5 mm.

23. A plating method according to claim 21, wherein said relative motion is vibration.

24. A plating method according to claim 21, wherein said relative motion is a rotary motion.

25. A plating method according to claim 21, wherein said relative motion is a scroll motion.

26. A plating method according to claim 21, wherein said relative motion is a rotary motion of said porous member and the substrate about their respective axes that are spaced from each other.

27. A plating method according to claim 21, wherein said relative motion is a linear motion.

28. A plating method comprising:
interposing a porous member made of a water-retentive material between a substrate and an anode;
filling a space between a surface, to be plated, of the substrate and said anode with a plating solution;
positioning said porous member in a predetermined position which is closely spaced a predetermined distance from the surface, to be plated, of the substrate;
making a relative motion between said porous member and the substrate and then keeping said porous member and the substrate still; and
supplying a current between the surface, to be plated, of the substrate and said anode to plate the surface, to be plated, of the substrate while keeping said porous member and the substrate still.

29. A plating method according to claim 28, wherein the current is supplied between the surface, to be plated, of the substrate and said anode within 2 seconds after said porous member and the substrate are made the relative motion with respect to each other and then kept still.

30. A plating method according to claim 28, wherein when said porous member is positioned in said predetermined position, said porous member and the surface, to be plated, of the substrate are spaced from each other by a distance of up to 1.5 mm.

31. A plating method according to claim 28, wherein said relative motion is vibration.

32. A plating method according to claim 28, wherein said relative motion is a rotary motion.

33. A plating method according to claim 28, wherein said relative motion is a scroll motion.

34. A plating method according to claim 28, wherein said relative motion is a rotary motion of said porous member and the substrate about their respective axes that are spaced from each other.

35. A plating method according to claim 28, wherein said relative motion is a linear motion.

36. A plating apparatus comprising:
a substrate holder for holding a substrate;
a cathode portion including a sealing member for contacting a peripheral portion of a surface, to be plated, of the substrate held by said substrate holder to seal said peripheral portion water-tightly, and a cathode for contacting the substrate to supply current to the substrate;
an anode disposed so as to face the surface, to be plated, of the substrate;
a water-retentive ion-exchange membrane disposed between said anode and the surface, to be plated, of the substrate;
a pressing/holding mechanism for either pressing said ion-exchange membrane against the surface, to be plated, of the substrate held by said substrate holder under a given force or holding said ion-exchange membrane in a position close to the surface, to be plated, of the substrate held by said substrate holder; and
a driving mechanism for making a relative motion between said ion-exchange membrane and the substrate.

37. A plating apparatus according to claim 36, wherein said ion-exchange membrane comprises one or a combination of a cation-exchange membrane, an anion-exchange membrane, and an amphoteric exchange membrane.

38. A plating apparatus according to claim 36, wherein said ion-exchange membrane comprises a hydrogen ion selective exchange membrane or a one-valence anion selective exchange membrane.

39. A plating apparatus according to claim 36, wherein said ion-exchange membrane comprises a hydrogen-ion-incapable exchange membrane.

40. A plating apparatus according to claim 36, wherein said driving mechanism is adapted to make a relative motion between said ion-exchange membrane and the substrate while said ion-exchange membrane and the surface, to be plated, of the substrate are brought into contact with each other.

41. A plating apparatus according to claim 40, wherein said relative motion is vibration, a rotary motion, a scroll motion, a rotary motion of said porous member and the substrate about their respective axes that are spaced from each other, or a linear motion.

42. A plating apparatus according to claim 36, wherein said relative motion is vibration so that contact and non-contact between the ion-exchange membrane and the surface, to be plated, of the substrate are repeated.

43. A plating method comprising:
interposing a water-retentive ion-exchange membrane between a substrate and an anode;
filling a space between the substrate and said anode with a plating solution;
making a relative motion between said ion-exchange membrane and the substrate while keeping said ion-exchange membrane and the substrate in contact with each other or close to each other; and
supplying a current between the substrate and said anode to plate the substrate.

44. A plating method according to claim 43, wherein said ion-exchange membrane comprises one or a combination of a cation-exchange membrane, an anion-exchange membrane, and an amphoteric exchange membrane.

45. A plating method according to claim 43, wherein said ion-exchange membrane comprises a hydrogen ion selective exchange membrane or a one-valence anion selective exchange membrane.

46. A plating method according to claim 43, wherein said ion-exchange membrane comprises a hydrogen-ion-incapable exchange membrane.

47. A plating method according to claim 43, wherein the current starts to be supplied between the substrate and said anode to plate the substrate within two seconds after the relative motion.

48. A plating method according to claim 43, wherein said ion-exchange membrane and the substrate are caused to make relative motion with respect to each other while said ion-exchange membrane and the surface, to be plated, of the substrate are brought into contact with each other.

49. A plating method according to claim 48, wherein said relative motion is vibration, a rotary motion, a scroll motion, a rotary motion of said porous member and the substrate about their respective centers that are spaced from each other, or a linear motion.

50. A plating method according to claim 43, wherein said relative motion is vibration so that contact and non-contact between the ion-exchange membrane and the surface, to be plated, of the substrate are repeated.

51. A plating apparatus comprising:
a substrate holder for holding a substrate;
a cathode portion including a sealing member for contacting a peripheral portion of a surface, to be plated, of the substrate held by said substrate holder to seal said peripheral portion water-tightly, and a cathode for contacting the substrate to supply current to the substrate;
an anode disposed so as to face the surface, to be plated, of the substrate;
a porous member disposed between said anode and the surface, to be plated, of the substrate and having a planar shape smaller than the surface, to be plated, of the substrate, said porous member being made of a water-retentive material;
an electrode head having said anode and said porous member respectively in upper and lower portions thereof; and
a driving mechanism for making a relative motion between said porous member and the substrate.

52. A plating apparatus according to claim 51, further comprising:
a pressing mechanism for pressing said porous member against the surface, to be plated, of the substrate held by said substrate holder under a given pressure.

53. A plating apparatus according to claim 51, wherein said porous member has a circular planar shape.

54. A plating apparatus according to claim 51, wherein said porous member has a sectorial planar shape.

55. A plating apparatus according to claim 51, wherein said porous member has a rectangular planar shape.

56. A plating apparatus according to claim 55, wherein said porous member has a planar shape which is identical to the planar shape of a die formed in a division on the substrate.

57. A plating apparatus according to claim 51, wherein said porous member has a rod shape.

58. A plating apparatus according to claim 51, wherein said anode has a planar shape corresponding to the planar shape of said porous member.

59. A plating apparatus according to claim 51, wherein said electrode head has a shape corresponding to the planar shape of said porous member.

60. A plating apparatus according to claim 51, comprising a plurality of said electrode heads.

61. A plating apparatus according to claim 51, wherein said relative motion is vibration.

62. A plating apparatus according to claim 51, wherein said relative motion is a rotary motion.

63. A plating apparatus according to claim 51, wherein said relative motion is a scroll motion.

64. A plating apparatus according to claim 51, wherein said relative motion is a rotary motion of said porous member and the substrate about their respective axes that are spaced from each other.

65. A plating apparatus according to claim 51, wherein said relative motion is a linear motion.

66. A plating method comprising:
interposing a porous member made of a water-retentive material between a surface, to be plated, of a substrate and an anode, said porous member having a planar shape smaller than the planar shape of the surface to be plated;
filling a space between the substrate and said anode with a plating solution;
allowing said porous member and the surface, to be plated, of the substrate to be in contact with each other or close to each other; and
supplying a current between the substrate and said anode to plate the substrate.

67. A plating method according to claim 66, wherein said anode has a planar shape corresponding to the planar shape of said porous member.

68. A plating method according to claim 66, wherein said porous member and said anode are provided in respective upper and lower portions of an electrode head, said electrode head having a shape corresponding to the planar shape of said porous member.

69. A plating method according to claim 68, wherein a plurality of said electrode heads are used to plate the surface, to be plated, of the substrate.

70. A plating method according to claim 66, wherein said porous member has a planar shape which is identical to the planar shape of a die formed in a division on the substrate, and each of dies formed in respective divisions on the substrate is plated.
